(19) United States
(12) Patent Application Publication
(10) Pub. No.: US 2023/0174225 A1
(43) Pub. Date: Jun. 8, 2023

(54) MULTI-ROTOR AIRCRAFTS WITH PASSIVELY TILTABLE ROTOR GROUPS AND METHODS OF MAKING AND USING THE SAME

(71) Applicant: this is engineering Inc., Seongnam-si (KR)

(72) Inventor: Yoojung HONG, Seongnam-si (KR)

(73) Assignee: this is engineering Inc., Seongnam-si (KR)

(21) Appl. No.: 17/860,837

(22) Filed: Jul. 8, 2022

(30) Foreign Application Priority Data
Dec. 3, 2021 (KR) 10-2021-0172453
Feb. 10, 2022 (KR) 10-2022-0017759

(51) Int. Cl. B64C 27/43; B64C 27/32; B64C 27/57

(52) U.S. Cl. CPC B64C 27/43; B64C 27/322; B64C 27/57

(57) ABSTRACT

This disclosure relates to various multi-rotor aircrafts including at least one passively tiltable rotor group which may be tilted, typically in a direction of their movement. More importantly, the passively tiltable rotor group can tilt on its own, without having to include any additional electric motor or other power generating devices. This disclosure relates to various multi-rotor aircrafts including various load sharing units capable of taking up at least a portion of a weight load of the aircraft to itself, thereby diverting that portion of the weight load from a tilting unit. Therefore, the tilting units may be tilted more easily under the reduced weight load and friction. This disclosure further relates to various methods of fabricating or operating such passively tiltable rotor groups, tilting units, or load sharing units, and various methods of incorporating such into the multi-rotor aircraft.

### CROSS-REFERENCE TO RELATED PATENT APPLICATIONS

This disclosure claims priority from the Korean patent application which is entitled “Air vehicle,” which was filed on Dec. 3, 2021, and which bears the filing number, KR 10-2021-0172453. This disclosure also claims priority from another Korean patent application which is entitled “Air vehicle,” which was filed on Feb. 10, 2022, and which bears the filing number, KR 10-2022-0017759. It is noted that both of the above Korean patent applications are to be incorporated herein by reference in their entirety. In case of any discrepancy between this disclosure and the above Korean patent applications, it is noted that this disclosure prevails over the above Korean patent applications.

### FIELD OF DISCLOSED MULTI-ROTOR AIRCRAFTS AND THEIR METHODS

This disclosure relates to various multi-rotor aircrafts including at least one passively tiltable rotor group which may be tilted, typically in a direction of their movement. Thus, contrary to prior art multi-rotor air vehicles, the multi-rotor aircrafts of this disclosure may move in a tilted or forward direction without having to tilt their bodies or cabins.

More importantly, the passively tiltable rotor group of such multi-rotor aircrafts can tilt on its own, without having to include any additional electric motor or other power generating devices. In addition, the multi-rotor aircrafts including the tiltable rotor groups of this disclosure can cruise at a relatively higher speed and, therefore, can provide a relatively longer flight distance, compared with prior art air vehicles, while providing excellent stability as well as easy controllability.

This disclosure also relates to various multi-rotor aircrafts which include various load sharing units each of which may take up at least a portion of a weight load of the aircrafts to itself, thereby diverting that portion of the weight load from a tilting unit and a rotor group coupled to the tilting unit. Therefore, the tilting units may be tilted more easily under the reduced weight load and friction.

This disclosure further relates to various methods of fabricating or operating such passively tiltable rotor groups, tilting units, or load sharing units of the multi-rotor aircraft. In addition, this disclosure relates to various methods of incorporating the passively tiltable rotor groups, the tilting units or the load sharing units into the multi-rotor aircrafts, and various methods of operating the multi-rotor aircraft while manipulating or controlling such passively tiltable rotor groups, tilting units or load sharing units.

### BACKGROUND

Various types of passenger air vehicles have been in use in transporting humans or cargo. Such vehicles may be roughly classified into, e.g., a lift-and-cruise air vehicle (or drone), a tiltrotor air vehicle (or drone), a multi-rotor air vehicle (or drone), and the like.

The lift-and-cruise air vehicle is one type of an electric vertical take-off and landing vehicle which uses electric power to hover, take off, and land vertically. A typical lift-and-cruise air vehicle includes a set of motors for vertical flight, and another set of motors for cruising such as, e.g., moving forward.

The lift-and-cruise air vehicle has the advantage of cruising at a relatively higher speed. However, the lift-and-cruise air vehicle suffers from an unnecessary drag caused by the set of motors for vertical flight which is not used in cruising. In addition, the lift-and-cruise air vehicle has another disadvantage of relatively low energy efficiency and stability.

The tiltrotor air vehicle is another type of the electric vertical take-off and landing vehicle into which a faster speed and a longer range of conventional fixed-wing aircraft are incorporated. In particular, the tiltrotor air vehicle generates lifts and propulsion using one or more rotors which are mounted on one or more rotating shafts, usually at the ends of one or more fixed wings. Depending on the types of maneuvering such as, e.g., taking off, cruising, hovering or landing, the tiltrotor air vehicle may tilt such rotors in different angles.

As a result, the tiltrotor air vehicle excels in its cruising speed and in its flight distance over other prior art vehicles. However, the tiltrotor air vehicle tends to suffer from its low hovering efficiency. More importantly, the tiltrotor air vehicle is more susceptible to wind disturbances than other types of vehicles. As a result, the tiltrotor air vehicle suffers from low stability to external disturbances.

In addition, the tiltrotor air vehicle typically requires a complicated control algorithm and may also require a pilot to perform more complex maneuvering when turning the vehicle around along a path of a relatively greater turning radius. Accordingly, the tiltrotor air vehicle may not be a suitable vehicle in transporting passengers in an urban area.

The multi-rotor air vehicle is yet another type of the electric vertical take-off and landing vehicle. The multi-rotor air vehicle typically includes one or more sets of quadcopters each of which includes four or more rotors which are fixedly attached to a frame, a wing or a body of the vehicle.

The multi-rotor air vehicle can be relatively easily designed and manufactured. The multi-rotor air vehicle may also provide relatively high stability and hovering efficiency and, as a result, even a novice pilot can easily maneuver the multi-rotor air vehicle.

But the multi-rotor air vehicle has its own drawback, particularly due to its mechanism of cruising. FIGS. 1 to 4 illustrates a typical hovering and cruising mechanism of the multi-rotor air vehicle.

FIG. 1 is a top view of a prior art multi-rotor air vehicle (90) which includes a body (10), a pair of wings (20), a pair of first horizontal frames (32), and another pair of second horizontal frames (34).

The vehicle (90) also includes four quadcopters such as, e.g., a front-left rotor group (40FL), a rear-left rotor group (40RL), a front-right rotor group (40FR), and a rear-right rotor group (40RR), which are respectively positioned in a front-left corner, in a rear-left corner, in a front-right corner, and in a rear-right corner of the vehicle (90).

Each rotor group (40) also includes four rotors (42) which may be numbered as a first rotor (designated as “1”), a second rotor (designated as “2”), a third rotor (designated as “3”), and a fourth rotor (designated as “4”). The propellers of each of such rotors (40) are driven or rotated by an electric motor (44).

FIG. 2 is a cross-sectional view of the prior art multi-rotor air vehicle (90) of FIG. 1, where all rotors are rotating at the same speed. Because all four rotor groups (40FL), (40RL), (40FR), (40LR) generate the lifts of the same magnitude, the vehicle (90) can fly in an upward direction or in a downward direction. In addition, when a magnitude of the sum of such lifts is equal to a weight load of the entire vehicle (90), the vehicle (90) can hover.

It is noted that only two rotor groups (40FL), (40RL) are included in the figure, and that two other rotor groups (40FR), (40RR) are not included in the figure for ease of illustration. It is also noted that only two rotors such as, e.g., a first rotor (42 (1)) and a fourth rotor (42 (4)) of each rotor group (40FL), (40RL) are shown in the figure, and that two other rotors such as, e.g., a second rotor (42 (2)) and a third rotor (42 (3)) are not shown in the figure for ease of illustration.

When the multi-rotor air vehicle (90) or its pilot increases the rpms of the rotors of the rear rotor groups (such as, e.g., (40RL), (40RR)), the rear rotor groups begin to generate the greater lifts than the front rotor groups (such as, e.g., (40FL), (40FR)). As a result, the differences in the lifts generated by the rear rotor groups and the front rotor groups tend to tilt the vehicle (90) in the forward direction. FIG. 3 is a cross-sectional view of the multi-rotor air vehicle (90) of FIG. 1 which is about to tilt in the forward direction.

When the multi-rotor air vehicle (90) is tilted in the forward direction, a sum of such lifts created by all four rotor groups (40) begins to have a non-zero horizontal component, and the horizontal component begins to pull the vehicle (90) in the tilted (or forward) direction. Therefore, the vehicle (90) starts cruising, i.e., moving in the forward direction. FIG. 4 is a cross-sectional view of the multi-rotor air vehicle (90) of FIG. 2 which is tilted at a certain angle and which begins to cruise.

In general, the prior art multi-rotor air vehicle (90) cannot be tilted at greater angles due to reasons to be explained below. The limited tilting of the prior art vehicle (90) also limits the magnitudes of the horizontal component of the sum of the lifts generated by the rotor groups (40). As a result, the prior art vehicle (90) typically cruises at a relatively low cruising speed, which in turn leads to a smaller flight distance. Therefore, the multi-rotor air vehicle (90) is at best suited for a short distance travel such as, e.g., an intracity transportation.

The prior art multi-rotor air vehicle (90) has further reasons which critically limit its cruising speed, where such reasons will be illustrated hereinafter. In addition, the prior art lift-and-cruise air vehicles as well as the prior art tiltrotor air vehicles have their own drawbacks.

Accordingly, there is an impending need for a multi-rotor aircraft with improved cruising speed, enhanced cruising efficiency, increased flight distance, enhanced hovering efficiency, improved turn-around velocity, decreased turning radius, enhanced yaw rotation or maneuvering, and the like.

In addition, there is an impending need for a multi-rotor aircraft which can provide enhanced agility in maneuvering and fine controlling, which can improve stability against various external disturbances (e.g., winds and rain) and, thus, which can provide improved comfort to the passengers.

### SUMMARY

### 1. Definitions

A “multi-rotor aircraft” of this disclosure generally refers to a vertical takeoff and landing aircraft (e.g., a VTOL aircraft) which can vertically takeoff or land. In addition, a “multi-rotor aircraft” of this disclosure also refers to an aircraft which can takeoff or land without requiring an airstrip or a runway which extends longer than, e.g., at least 100 m.

As used herein, a “coordinate” refers to a spherical coordinate (r, θ, φ), unless otherwise specified. Thus, a rotation with a turning radius R_{T} refers to the rotation in a direction of θ or φ, where R_{T} ranges from 0 cm to a certain value as specified in this disclosure. It is appreciated that the directions of θ and φ depend on the selection of the origin of the spherical coordinate and that the directions of θ and φ may become different when different points are selected as the origin of the coordinate.

As used herein, directions may refer to one or more of various directions and planes. For example, a “vertical direction” refers to a direction parallel to the direction of gravity, whereas a “horizontal direction” refers to another direction which is normal (or perpendicular) to the direction of gravity. In addition, a “rotation” means a rotation along a direction of θ or φ, or another rotation around an axis of θ or φ. Furthermore, a “radial direction” or an “angular direction” means a rotation along a direction of θ or φ, or around an axis of θ or φ.

As used herein, planes may refer to one or more of various planes and planes. For example, a “vertical plane” refers to a plane which includes thereon at least two lines all of which extend in the above vertical direction, whereas a “horizontal plane” refers to another plane which includes thereon at least two lines all of which extend in the above horizontal direction.

As used herein, a “rotor plane” refers to an inner-most plane or an outer-most plane of a disk-shaped 3-dimensional object which is formed by rotating propellers of a certain rotor of a certain rotor group. It is appreciated that most propellers have curved surfaces and, accordingly, the rotating propellers form not a 2-dimensional plane but a 3-dimensional object which typically has a shape of a disk. Thus, the “rotor plane” as used herein may refer to one of a first plane which is a top surface of the disk, a second plane which is a bottom surface of the disk, and a third plane which is spaced between the first and second planes and which is parallel to at least one of the first and second planes.

As used herein, an “active tilting” refers to a mechanism in which an electric motor (to be referred to as a “tilting motor”) tilts a rotor or a rotor group about an axis of active tilting in a direction of active tilting. It is noted that the propellers of a rotor of a rotor group are rotated by an electric motor, where this motor is to be referred to as a “rotor motor.”

In this context, the active tilting mechanism requires not only the rotor motors which turn the propellers of the rotors but also at least one tilting motor which does not actuate the propellers of the rotor but which tilts the rotor or rotor group.

As will be explained below, at least one rotor motor may be used to tilt at least one rotor group, e.g., by using at least a portion of the mechanical energy generated by the rotor motor in tilting that rotor group or a different rotor group about the axis of active tilting in a direction of the active tilting.

As used herein, a “passive tilting” refers to another mechanism in which a rotor group is tilted without utilizing the tilting motor explained above. Rather, the passive tilting refers to tilting of a tiltable rotor group, where such a passive tilting is actuated by (1) varying rpms of the rotors of the rotor group, (2) generating lifts not only in a horizontal direction but also in a horizontal direction, and (3) rendering the rotor group of the tiltable rotor group to be tilted in a tilted direction.

As used herein, a “lift” means a force which is generated by propellers of a rotating rotor and which is generally perpendicular to the rotor plane. Accordingly, when the rotor faces upward, the lift which is generated by the rotor acts either in the direction of gravity (i.e., a gravity direction) or in a direction which is opposite to the gravity direction. However, when the rotor is tilted (i.e., forming a non-zero angle with respect to the gravity direction), the lift acts in a slanted direction or in a tilted direction.

In other words, when an aircraft is hovering (i.e., floating in the sky while maintaining a certain altitude), the “lift” acts in the vertical direction or in the gravity direction. However, when the rotor is tilted in the forward direction and the aircraft is cruising (i.e., moving in a forward direction while maintaining or changing its altitude), the “lift” includes not only a vertical component but also a horizontal component, where the vertical component determines the altitude of the aircraft, whereas the horizontal component moves the aircraft in a forward direction, in a backward direction, in a lateral direction, in an angular direction, or the like.

Unless otherwise specified, the above “lift” means a scalar value. Accordingly, when a lift generated by the rotor 1 is greater than a lift generated by the rotor 2, it is deemed that the lift generated by the rotor 1 has a magnitude (or amplitude) which is greater than that of the lift generated by the rotor 2. In addition, when each of multiple rotors of a certain rotor group generates the “lift,” it is said that the rotors or such a certain rotor group generate the “lifts.”

Unless otherwise specified, a “sum of the lifts” means a vector sum of multiple lifts. Accordingly, the sum of the lifts may include a horizontal component and a vertical component, where the horizontal component is zero when the sum of the lifts is parallel with (or points to) the vertical direction or the gravity direction, while the vertical component is zero when the sum of the lifts is parallel with (or points to) the horizontal direction.

As used herein, a “weight load (w)” refers to a force determined by an equation, w=m×g, where m is a mass of an object, and g is an acceleration of gravity. Accordingly, a “weight load of an aircraft” is a vector which points downward (or acting in the gravity direction) and of which the magnitude is a product of a mass of the aircraft and the acceleration of gravity.

As used herein, a “rotor group” refers to a group which includes therein at least two rotors, while a “passively tiltable rotor group” or simply “tiltable rotor group” means an assembly of at least one rotor group and at least one tilting unit which is directly or indirectly coupled to the rotor group, where the direct coupling refers to a coupling in which the tilting unit contacts and couples with the rotor group, while the indirect coupling refers to another coupling in which the tilting unit is not in contact with the rotor group but which is coupled to the rotor group via, e.g., one or more frames.

### 2. Objectives

Objectives to be achieved by various multi-rotor aircrafts of this disclosure which include at least one (passively) tiltable rotor group are summarized below. It is appreciated that following objectives are exemplary only and, therefore, they are intended to limit the scope of the multi-rotor aircrafts of this disclosure.

The first objective of this disclosure is to include, in a multi-rotor aircraft, at least one tiltable rotor group which can be passively tilted by varying the lifts generated by each rotor of such a rotor group. To this end, the multi-rotor aircraft of this disclosure includes at least one tilting unit which can be tilted as a control unit of the aircraft manipulates the rpms of the rotors of the rotor group and manipulates the lifts generated by each rotor of that rotor group.

The second objective of this disclosure is to significantly improve a cruising speed (i.e., a speed in a tilted direction or a forward direction) of a multi-rotor aircraft of this disclosure, particularly beyond the cruising speeds obtainable by other prior art air vehicles such as the prior art [1] lift-and-cruise air vehicle, [2] tiltrotor air vehicle, [3] multi-rotor air vehicle, or the like.

By tilting at least one rotor group of the aircraft of this disclosure without having to tilt other parts of the aircraft such as, e.g., a body, wings or the like, the multi-rotor aircraft of this disclosure can maintain (or change) its altitude, while generating the lifts of which the horizontal component can be maximized.

By maximizing the cruising speed, the third objective of this disclosure is to accomplish an enhanced hovering efficiency as well as a cruising efficiency. Therefore, a flight distance of the aircraft can also be increased. As a result, the multi-rotor aircraft of this disclosure can be utilized as an important modality for an inner-city travel as well as for an intercity travel or transportation.

It is noted that the prior art multi-rotor air vehicle generally has a better hovering efficiency than a prior art tiltrotor air vehicle and lift-and-cruise air vehicle. Because the multi-rotor aircraft of this disclosure which includes at least one tiltable rotor group has an improved hovering efficiency than the prior art multi-rotor air vehicle, the multi-rotor aircraft of this disclosure has the hovering efficiency which is far higher than that of the prior art tiltrotor air vehicle, that of the prior art lift-and-cruise air vehicles, or the like.

The fourth objective of this disclosure is to provide the maximum comfort to a pilot and a passenger of the multi-rotor aircraft of this disclosure. For example, because the aircraft does not have to tilt its body or cabin during cruising, the aircraft can provide the pilot or passenger with comfortable ride.

The fifth objective of this disclosure is to provide the multi-rotor aircraft capable of performing a perfect yaw rotation. Because the control unit of the aircraft can manipulate each tiltable rotor group to be tilted at the same or different tilting angles in the same or different tilted directions, the aircraft can perform the yaw rotation.

The sixth objective of this disclosure is to minimize a turning radius of the multi-rotor aircraft and, therefore, to improve its turning speed. As described above, the control unit of the aircraft can control each tiltable rotor group to be tilted individually, the aircraft can perform the yaw operation when the control unit manipulates rpms of the rotors while the aircraft is hovering. Similarly, when the control unit manipulates rpms of the rotors while the aircraft is cruising, an inertia of the cruising movement and the yaw operation result in the turning operation, with the maximum turning speed, at the minimum turning radius.

The seventh objective of this disclosure is to improve the maneuvering ability as well as the controlling ability of the multi-rotor aircraft of this disclosure. By including multiple tiltable rotor groups, the multi-rotor aircrafts can manipulate each of such rotor groups. In addition, by including such tiltable rotor groups in various strategic locations thereon or therearound, the aircraft can have the improved stability against various external disturbances (e.g., winds and rain).

The eighth objective of this disclosure is to facilitate the tilting of the tiltable rotor groups by including various load sharing units which are capable of bearing at least a portion of the weight load of the multi-rotor aircraft. By relieving such a portion of the weight load from the tilting units of the multi-rotor aircraft, a friction force acting on the tilting unit against such tilting may be decreased, and the tilting unit can be tilted more easily.

In addition, various moving elements of the tilting units can be spared from enormous friction caused by the severe weight load of the aircrafts, thereby minimizing wear and tear of such moving elements, prolonging the use life of the tilting units, that of the tiltable rotor groups, and that of the multi-rotor aircraft.

### 3. Exemplary Features

This disclosure relates to various multi-rotor aircrafts and various methods of fabricating or using such, where each multi-rotor aircraft includes at least one tiltable rotor group which can be tilted in at least one tilted direction. More particularly, the multi-rotor aircraft of this disclosure does not need any additional electric motor (other than the rotor motors which rotate propellers of the rotors) to rotate the tiltable rotor group in that tilted direction. In this context, the multi-rotor aircraft of this disclosure may be deemed to include at least one “passively tiltable rotor group” or, simply, “tiltable rotor group.”

The first feature of this disclosure relates to a multi-rotor aircraft which includes a body, at least one rotor group, and at least one tilting unit. The body may include a front and a rear, where the body may define a longitudinal axis extending between the front and the rear, and where the body may also define a lateral axis which is parallel with a horizontal plane and which is perpendicular to the longitudinal axis.

The rotor group may include at least two rotors each of which includes a plurality of propellers and each of which is capable of generating a lift when the propellers rotate. The tilting unit may include an upper arm and a lower arm.

The upper arm may be directly or indirectly coupled to the rotor group, while the lower arm may be directly and indirectly coupled to the body. The tilting unit may allow rotation of the upper arm about the lower arm so that a distance between the upper and lower arms may vary due to the rotation.

When a first vector sum of the lifts generated by the rotors may act in a tilted direction which forms a non-zero angle with a vertical direction, the first vector sum has a non-zero horizontal component which tilts the tilting unit in the tilted direction, and the rotor group coupled to the upper arm of the tilting unit may also be tilted in the tilted direction. The aircraft may perform moving in a moving direction which is defined by a second vector sum of the first vector sum and a vector of a weight load of the aircraft.

The first feature of this disclosure may include the following examples.

In the first example, the moving and the moving direction may be [1] moving in a forward direction while maintaining the aircraft at a preset altitude, [2] moving in the forward direction while increasing the altitude, [3] moving in the forward direction while decreasing the altitude, [4] making a turning operation of a preset turning radius while maintaining the aircraft at the altitude, [5] making the turning operation of the turning radius while increasing the altitude, [6] making the turning operation of the turning radius while decreasing the altitude, [7] performing a yaw rotation while maintaining the aircraft at the altitude, [8] performing the yaw rotation while increasing the altitude, [9] performing the yaw rotation while decreasing the altitude, [10] moving in a backward direction while maintaining the aircraft at the altitude, [11] moving in the backward direction while increasing the altitude, [12] moving in the backward direction while decreasing the altitude, or the like.

In the second example, the first vector sum may include a horizontal component and a vertical component, where the aircraft may manipulate the lifts of the rotors in such a way that the horizontal component of the first vector sum may move the aircraft at a preset speed in a forward direction.

In the third example, the second vector sum may include a horizontal component and a vertical component, where the aircraft may manipulate the lifts of the rotors in such a way that the vertical component of the second vector sum may manipulate an altitude of the aircraft.

In the fourth example, the body may be at least not substantially tilted in the tilted direction while the aircraft moves in the moving direction.

In the fifth example, the tilting unit may include at least one mechanical joint capable of providing the rotation, where examples of such a mechanical joint may include [1] a ball-socket joint, [2] a bolted joint, [3] a condyloid joint, [4] a cotter-pin, [5] an ellipsoidal joint, [6] a ginglymus joint, [7] a gliding joint, [8] a hinge joint, [9] a knuckle joint, [10] a pin joint, [11] a pivot joint, [12] a plane joint, [13] a prismatic joint, [14] a revolute joint, [15] a saddle joint, [16] a screw joint, [17] a slider joint, [18] a spherical joint, [19] a turnbuckle, [20] a universal joint, or the like.

In the sixth example, the tilting unit may be a path-dependent tilting unit or a bearing-type tilting unit.

In the seventh example, the tilting unit may have a tilting range which may be about 15°, 30°, 45°, 60°, 75°, 90°, 105°, 120°, 135°, 150°, 165°, or 180°. The tilting range may also be about 195°, 210°, 225°, 240°, 255°, 270°, 285°, 300°, 315°, 330°, 345°, or 360°.

In the eighth example, the upper arm may have a tilting range which may define an upper bound and a lower bound.

In the ninth example, the aircraft may include at least one stopper, where the stopper may be configured to obstruct a first movement or a second movement of the upper arm. The first movement may be a movement of the upper arm beyond the upper bound, while the second movement may be another movement of the upper arm below the lower bound.

In the tenth example, the aircraft may include at least one bumper, were the bumper may include an elastic element or a viscous element. The bumper may be disposed in at least one end of a path of a movement of the upper arm of the tilting unit, whereby, when the tilting unit reaches the upper or lower bound, the bumper may abut the upper arm and absorb at least a portion of mechanical energy associated with the movement of upper arm.

In the eleventh example, the aircraft may include a first tilting unit and a second tilting unit both of which may be arranged in a series mode, The first tilting unit may provide a first rotation of the upper arm about the lower arm in a first angular direction and within a first tilting range, while the second tilting unit may provide a second rotation of the upper arm about the lower arm within a second tilting range and in a second angular direction which is different from the first angular direction.

In the twelfth example, the first tilting range may be one of about 15°, 30°, 45°, 60°, 75°, and 90°, and the second tilting range may have a low end and a high end, where the low end may be greater than 0° and where the high end may be less than 360°.

In the thirteenth example, the first tilting range and the second tilting range may be identical to each other or different from each other.

In the fourteenth example, each of the tilting ranges has its upper bound and its lower bound, and the stopper may be configured to obstruct a first movement of the first upper arm or a second movement of the second upper arm. The first movement may be a movement of the first upper arm beyond the first upper bound or below the first lower bound. The second movement may be a movement of the second upper arm beyond the second upper bound or below the second lower bound.

In the fifteenth example, the aircraft may include at least one stopper which may be configured to obstruct a first movement or a second movement of the first moving element. The first movement may be a movement of the first moving element beyond the first upper bound, while the second movement may be another movement of the first moving element below the first lower bound.

In the sixteenth example, the aircraft may include at least one bumper which may include an elastic or viscous element. The bumper may be disposed in at least one end of a path of a movement of one of the upper arms of one of the tilting units. Therefore, when one of the tilting units reaches the one of the ends of the paths of one of the upper arms, the bumper may stop one of upper arms of one of the tilting units, and may absorb at least a portion of mechanical energy associated with the stopping of one of the upper arms of one of the tilting units.

In the seventh example, the aircraft may define N rows of installation of the rotors starting in a direction from the front to the rear, where the rows are at least partly parallel with the lateral direction, and where N is a positive integer and greater than 2. A preset number of the rotors may be installed in each of the N rows.

In the eighteenth example, each of the N rows may be defined along N curvilinear lines which may be a straight line, a curve which may be convex upward with respect to the longitudinal axis in a direction from the front to the rear, or a curve which may be convex downward with respect to the longitudinal axis in the direction.

In the nineteenth example, the rotors installed in the N rows may have elevations which may be in [1] a first arrangement in which the rotors of all of the N rows have the same elevation, [2] a second arrangement in which the rotors of (n−1)-th row have a first elevation which is smaller than a second elevation of the rotors of n-th row, where n is an integer between 2 and N, [3] a third arrangement in which the rotors of (n−1)-th row have the first elevation which is greater than the second elevation of the rotors of n-th row, or the like.

In the twentieth example, the aircraft may include a first frame which may include a first upper arm and a first lower arm, where the first lower arm may be fixedly coupled to the upper arm, and where the first upper arm may be fixedly coupled to the rotor group. Thus, the tilting unit may be indirectly coupled to the rotor group through the first frame.

In the twenty-first example, the aircraft may include a second frame which may include a second upper arm and a second lower. The second upper arm may be fixedly coupled to the lower arm, while the second lower arm may be fixedly coupled to the body. Thus, the tilting unit may be indirectly coupled to the body through the second frame.

In the twenty-second example, the aircraft may include four rotor groups each including four rotors.

In the twenty-third example, each of the four rotors of each of the rotor groups may include the same propeller.

In the twenty-fourth example, the longitudinal and lateral axes may define, with respect to a center of the body, a front-left region, a rear-left region, a front-right region, and a rear-right region, where each of the rotor groups may be disposed at least substantially in each of the regions in a shape of a sign “+.”

In the twenty-fifth example, the rotor groups may include a longitudinal axis and a lateral axis, where the axes may define with respect to a center of the body a front region, a middle-left region, a middle-right region, and a rear region, and where each of the rotor groups may be disposed at least substantially in each of the regions in a shape of a cross.

In the twenty-sixth example, at least one of the upper arm and the lower arm may include at least one bent, or may be curved.

The second feature of this disclosure relates to a multi-rotor aircraft which may include a body, at least one rotor group, and at least one tilting unit. The body may include a front and a rear, may define a longitudinal axis extending between the front and the rear, and may also defines a lateral axis which is parallel with a horizontal plane and which is perpendicular to the longitudinal axis.

The rotor group may include at least one front rotor and at least one rear rotor, where the front and rear rotors may be disposed in a direction parallel with the longitudinal axis. Each of the rotors may include a plurality of propellers, and each of the rotors may be capable of generating a lift when the propellers rotate.

The tilting unit may include an upper arm and a lower arm, where the upper arm may be directly or indirectly coupled to the rotor group, where the lower arm may be directly or indirectly coupled to the body. The tilting unit may allow rotation of the upper arm about the lower arm such that a distance between the upper arm and the lower arm may vary due to the rotation.

When the rear rotor generates a rear lift which may be greater than a front lift generated by the front rotor, a first vector sum of the rear lift and front lift may tilt the tilting unit toward the front of the aircraft, and the rotor group coupled to the upper arm of the tilting unit may also be tilted toward the front. Therefore, the aircraft may perform moving in a moving direction which may be defined by a second vector sum of the first vector sum and a vector of a weight load of the aircraft.

This second feature of this disclosure may also include examples which may be identical or similar to those which have been described in conjunction with the first feature.

The third feature of this disclosure relates to a multi-rotor aircraft which may include at least one rotor group, a body, and at least one tilting unit. The rotor group may include at least two rotors each of which may include multiple propellers and each of which may be capable of generating a lift when the propellers rotate.

The body may include a front and a rear, where the body may define a longitudinal axis extending between the front and the rear, and may also define a lateral axis which may be parallel with a horizontal plane and which may be perpendicular to the longitudinal axis. The body may be disposed in the horizontal plane when a first vector sum of the lifts generated by the rotors is parallel with a vertical direction.

The tilting unit may include an upper arm and a lower arm, where the upper arm may be directly or indirectly coupled to the rotor group, where the lower arm may be directly or indirectly coupled to the body, and where the tilting unit may allow rotation of the upper arm about the lower arm such that a distance between the upper arm and the lower arm may vary due to the rotation.

Accordingly, when the first vector sum defines a tilted direction forming a non-zero angle with the vertical direction, the tilting unit may be tilted in the tilted direction, the rotor group coupled to the upper arm of the tilting unit may also be tilted in the tilted direction, and the aircraft performs moving in a moving direction which is defined by a second vector sum of the tilted direction and a vector of a weight load of the aircraft.

This third feature of this disclosure may also include example which may be identical or similar to those which have been described in conjunction with the first feature.

The fourth feature of this disclosure relates to a multi-rotor aircraft which may include a body, at least one rotor group, at least one tilting unit, and a control unit. The body may include a front and a rear, may define a longitudinal axis extending between the front and the rear, and may also define a lateral axis which is parallel with a horizontal plane and which is perpendicular to the longitudinal axis.

The rotor group which includes at least one first rotor, at least one second rotor, at least one first motor, and at least one second motor, where the first motor may rotate the first rotor at a first rpm, and where the second motor may rotate the second rotor at a second rpm. The first rotor may be disposed closer to the front than the second rotor, and generate a first lift while rotating at the first rpm, while the second rotor may be installed closer to the rear than the first rotor, and generate a second lift while rotating at the second rpm.

The tilting unit may define a first arm and a second arm and may allow the first arm to rotate about the second arm, where the first arm may be fixedly coupled to the rotor group, where the second arm may be fixedly coupled to body, and where a distance between the first and second arms may vary as the first arm is tilted.

The control unit capable may manipulate the first and second rpms. Thus, when the controller unit may increase the second rpm but not the first rpm, the second lift generated by the second rotor may become greater than the first lift, the second lift may tilt the first arm of the tilting unit and the rotor group coupled to the first arm toward the front, the second lift may include not only a vertical component but also a horizontal component, and the horizontal component may push the aircraft in a horizontal direction.

This fourth feature of this disclosure may also include examples which may be identical or similar to those which have been described in conjunction with the first feature.

The fifth feature of this disclosure relates to a tilting unit which may include an upper frame, a lower frame, and a mechanical joint. The upper frame may be directly or indirectly coupled to the rotor group, while the lower frame may be directly or indirectly coupled to the body.

The mechanical joint may include an upper arm and a lower arm, where the upper arm may fixedly couple with the upper frame, where the lower arm may fixedly couple with the lower frame, and where the joint may allow at least one rotation of the upper arm with respect to the lower arm.

When the rotor group generates lifts acting in a vertical direction, the tilting unit may be in an upright position in which the upper arm is disposed above the joint which is in turn disposed above the lower arm. When the rotor group generates the lifts acting in a tilted direction which includes not only a vertical component but also a horizontal component, the upper arm of the tilting unit may be tilted in the tilted direction, whereas the lower arm may remain at least substantially in the upright position.

The fifth feature of this disclosure may include the following examples.

In the first example, the tilting unit may include at least one mechanical joint capable of providing the rotation, where examples of such a mechanical joint may include [1] a ball-socket joint, [2] a bolted joint, [3] a condyloid joint, [4] a cotter-pin, [5] an ellipsoidal joint, [6] a ginglymus joint, [7] a gliding joint, [8] a hinge joint, [9] a knuckle joint, [10] a pin joint, [11] a pivot joint, [12] a plane joint, [13] a prismatic joint, [14] a revolute joint, [15] a saddle joint, [16] a screw joint, [17] a slider joint, [18] a spherical joint, [19] a turnbuckle, [20] a universal joint, or the like.

In the second example, the first tilting unit may have a first tilting range which may be about 15°, 30°, 45°, 60°, 75°, 90°, 105°, 120°, 135°, 150°, 165°, or 180°. The tilting range may also be about 195°, 210°, 225°, 240°, 255°, 270°, 285°, 300°, 315°, 330°, 345°, or 360°.

In the third example, the tilting unit may have a tilting range defining an upper bound and a lower bound, where the upper arm may not be tilted beyond the upper bound and below the lower bound.

In the fourth example, the tilting unit may include at least one stopper which may be configured to obstruct a first movement or a second movement of the first moving element. The first movement may be a movement of the first moving element beyond the first upper bound, while the second movement may be another movement of the first moving element below the first lower bound.

In the fifth example, the tilting unit may include at least one bumper which may include an elastic element or a viscous element. The bumper may be disposed along a path of a movement of the first moving element of the first tilting unit. Accordingly, when the first tilting unit reaches the first upper bound or first lower bound, the bumper may stop the first moving element of the first tilting unit and absorbing at least a portion of mechanical energy associated with the stopping of the first moving element of the first tilting unit.

The sixth feature of this disclosure relates to a tiltable rotor group which may include at least one rotor group, and at least one tilting unit. The rotor group may include multiple rotors.

The tilting unit may include an upper arm, a lower arm, and a mechanical joint, where the upper arm may be coupled to the rotor group, where the lower arm may be coupled to the body of the aircraft, where the joint may be disposed between the upper arm and the lower arm, and where the joint may allow at least one rotation of the upper arm with respect to the lower arm.

When the rotor group generates lifts acting solely in a vertical direction, the tilting unit may be in an upright position in which the upper arm may be disposed above the joint which may be in turn disposed above the lower arm. When the rotor group generates the lifts acting in a tilted direction which includes a non-zero vertical component as well as a non-zero horizontal component, the upper arm of the tilting unit may be tilted in the tilted direction, while the lower arm may remain at least substantially in the upright position.

Thus, the tiltable rotor group may be capable of moving the aircraft in a horizontal direction with the horizontal component, while at least substantially maintaining the lower arm in the upright direction.

The sixth feature of this disclosure may include the following examples.

In the first example, the moving and the moving direction may be [1] moving in a forward direction while maintaining the aircraft at a preset altitude, [2] moving in the forward direction while increasing the altitude, [3] moving in the forward direction while decreasing the altitude, [4] making a turning operation of a preset turning radius while maintaining the aircraft at the altitude, [5] making the turning operation of the turning radius while increasing the altitude, [6] making the turning operation of the turning radius while decreasing the altitude, [7] performing a yaw rotation while maintaining the aircraft at the altitude, [8] performing the yaw rotation while increasing the altitude, [9] performing the yaw rotation while decreasing the altitude, [10] moving in a backward direction while maintaining the aircraft at the altitude, [11] moving in the backward direction while increasing the altitude, [12] moving in the backward direction while decreasing the altitude, or the like.

In the second example, the tilting unit may include at least one mechanical joint capable of providing the rotation, where examples of such a mechanical joint may include [1] a ball-socket joint, [2] a bolted joint, [3] a condyloid joint, [4] a cotter-pin, [5] an ellipsoidal joint, [6] a ginglymus joint, [7] a gliding joint, [8] a hinge joint, [9] a knuckle joint, [10] a pin joint, [11] a pivot joint, [12] a plane joint, [13] a prismatic joint, [14] a revolute joint, [15] a saddle joint, [16] a screw joint, [17] a slider joint, [18] a spherical joint, [19] a turnbuckle, [20] a universal joint, or the like.

In the third example, the first tilting unit may have a first tilting range which may be about 15°, 30°, 45°, 60°, 75°, 90°, 105°, 120°, 135°, 150°, 165°, or 180°. The tilting range may also be about 195°, 210°, 225°, 240°, 255°, 270°, 285°, 300°, 315°, 330°, 345°, or 360°.

In the fourth example, the tilting unit may have a tilting range defining an upper bound and a lower bound, where the upper arm may not be tilted beyond the upper bound and below the lower bound.

In the fifth example, the tiltable rotor group may include at least one stopper which may be arranged to obstruct a first movement or a second movement of the upper arm, where the first movement may be a movement of the upper arm beyond the upper bound, and where the second movement may be another movement of the upper arm below the lower bound.

In the sixth example, the tiltable rotor group may include at least one bumper which may include an elastic element or a viscous element. The bumper may be disposed in at least one end of a path of a movement of the upper arm. Thus, when the upper arm reaches at least one of the upper and lower bounds, the bumper may be capable of stopping the upper arm of and absorbing at least a portion of mechanical energy associated with the stopping of the upper arm of the tilting unit.

In the seventh example, the tiltable rotor group may include a first tilting unit and a second tilting unit both of which are arranged in a series mode, where the first tilting unit may provide a first rotation of the upper arm about the lower arm in a first angular direction, and where the second tilting unit may provide a second rotation of the arm about the lower arm in a second angular direction which is different from the first angular direction.

In the eighth example, the first tilting unit may have a first tilting range which may be about 15°, 30°, 45°, 60°, 75°, 90°, 105°, 120°, 135°, 150°, 165°, 180°, 195°, 210°, 225°, 240°, 255°, 270°, 285°, 300°, 315°, 330°, 345°, or 360°. The second tilting unit may have a second tilting range which may be the same as or different from the first tilting range.

In the ninth example, the first tilting range and the second tilting range may be identical to each other or may be different from each other.

The seventh of this disclosure feature relates to another multi-rotor aircraft which includes at least one rotor group, a body, at least one tilting unit, and at least one load sharing unit. The rotor group includes multiple rotors. The body includes a front and a rear, defines a longitudinal axis and a lateral axis, and exerts on the rotor group a weight load in a direction of gravity.

The tilting unit includes an upper arm, a lower arm, and a mechanical joint, where the joint is disposed between the upper arm and the lower arm, where the upper arm is coupled to the rotor group and includes an upper flange, where the lower arm is coupled to the body and includes a lower flange, and where the joint allows the upper arm to be tilted about the lower arm in a tilting angle in a tilted direction along a tilting path.

The load sharing unit may be installed between the upper flange and the lower flange. Such a unit may bear at least a portion of the weight load of the aircraft, and while the joint may bear a remaining portion of the weight load. Accordingly, a friction force which exerts on the joint may be reduced and, therefore, the upper arm may be tilted about the lower arm with the reduced friction force.

The seventh feature of this disclosure may include the following examples.

In the first example, the mechanical joint includes at least one of various mechanical joints as exemplified in the fifth example of the first feature.

In the second example, the load sharing unit may be disposed in parallel with the tilting unit and, therefore, the load sharing unit and the tilting unit may share the weight load of the aircraft and, accordingly, each of the load sharing unit and tilting unit may not have to bear an entire portion of the weight load.

In the third example, the load sharing unit may include at least two springs each of which is stretched beyond an equilibrium length thereof and each of which is disposed between the upper and lower flanges in such a way that the springs pull the lower arm and the body coupled to the lower arm in an upward direction.

In the fourth example, such springs may be installed in various patterns such as [1] a first pattern in which the springs are distributed around the tilting unit at equal distances, [2] a second pattern in which the springs are distributed around the tilting unit at unequal distances, [3] a third pattern in which the springs are distributed at least substantially along the lateral axis, [4] a fourth pattern in which the springs are symmetrically distributed with respect to the longitudinal axis, or the like.

In the fifth example, the springs may be installed in various patterns such as [1] a fifth pattern in which the springs are distributed around the tilting path at equal distances, [2] a sixth pattern in which the springs are distributed around the tilting path at unequal distances, [3] a seventh pattern in which the springs are distributed symmetrically with respect to the tilting path, [4] an eighth pattern in which the springs are distributed away from the tilting path, or the like.

In the sixth example, at least one of the springs may be one of [1] a tension spring which is installed while being stretched beyond an equilibrium length thereof, [2] a compression spring which is installed while being compressed beyond an equilibrium length thereof, [3] a combination of [1] and [2], or the like.

In the seventh example, the load sharing unit may include at least two spacers which may be disposed between the upper and lower flanges in such a way that the spacers may pull the lower arm and the body coupled to the lower arm in an upward direction.

In the eighth example, at least one of the spacers may be one of [1] a solid rod which has a preset height, [2] a single or multiple solid articles which are coupled to each other and which has the preset height when hung in an upright position, [3] a single or multiple solid articles which are coupled to each other and which has the preset height when fully stretched, or the like.

In the ninth example, the portion of the weight load of the aircraft borne by the load sharing unit may be greater than the remaining portion of the weight load borne by the joint, e.g., by at least 25%, 50%, 75%, 100%, 125%, 150%, 175%, 200%, or more.

The eighth feature of this disclosure relates to another multi-rotor aircraft which includes at least one rotor group, a body, at least one tilting unit, and at least one load sharing unit. The rotor group includes multiple rotors. The body includes a front and a rear, defines a longitudinal axis and a lateral axis, and exerts on the rotor group a weight load in a direction of gravity. The tilting unit includes an upper arm, a lower arm, and a mechanical joint, where the joint is disposed between the upper arm and the lower arm, where the upper arm is coupled to the rotor group and includes an upper flange, where the lower arm is coupled to the body and includes a lower flange, and where the joint allows the upper arm to be tilted about the lower arm in a tilting angle in a tilted direction along a tilting path.

The load sharing unit may include at least one tension spring which may be installed between the upper and lower flanges, while being stretched beyond an equilibrium length thereof. The spring may exert a tension force which pulls the lower flanges and the body coupled thereto in an upward direction and which bears at least a portion of the weight load of the aircraft. The joint may bear the remaining portion of the weight load, instead of an entire portion of the weight load. Accordingly, a friction force which exerts on the joint may be reduced and, therefore, the upper arm is tilted about the lower arm with the reduced friction force.

The eighth feature of this disclosure may include the following examples.

The first and second examples are the same as the first and fourth examples of the seventh feature, respectively, and the third and fourth examples are the same as fifth and ninth examples of the seventh feature, respectively.

The ninth feature of this disclosure relates to a method of operating a multi-rotor aircraft capable of switching between hovering and cruising, where the aircraft includes a body which includes a front and a rear.

The method may include the steps of, e.g., (1) installing, (2) providing, (3) first coupling, (4) second coupling, (5) first rotating, (6) second rotating, and (7) allowing.

The step of installing is to install multiple rotor groups in a preset arrangement, where each of the rotor groups may include at least two rotors, and where each of the rotor groups may be capable of generating lifts when the rotors rotate. The step providing is to provide at least one tilting unit which includes an upper arm and a lower arm and which allows the upper arm to rotate about the lower arm in at least one angular direction. The step of first coupling is to couple at least one of the rotor groups to the upper arm of the tilting unit, whereas the step of second coupling is to couple the lower arm to the body of the aircraft.

The step of the first rotating is to rotate the rotors of the rotor groups in a first set of rpms in such a way that a first vector sum of the lifts may act in an upward direction and that a magnitude of the first vector sum may be at least substantially equal to a weight load of the aircraft, whereby the aircraft performs the hovering. The step of second rotating is to rotate the rotors of the rotor groups in a second set of rpms in such a way that the first vector sum of the lifts may include a second non-zero vertical component and a second non-zero horizontal component.

The step of allowing is to allow the upper arm of the tilting unit and the rotor group coupled to the upper arm to be tilted by a tilting angle in a tilted direction which is a direction of the first vector sum, whereby the aircraft performs the cruising.

The ninth feature of this disclosure may include the following examples.

In the first example, the step of installing may include one of the steps of [1] installing two rotors into at least one of the rotor groups, [2] installing two rotors into each of the rotor groups, [3] installing four rotors into at least one of the rotor groups, [4] installing four rotors into each of the rotor groups, [5] installing more than four rotors into at least one of the rotor groups, [6] installing more than four rotors into each of the rotor groups, [7] installing an odd number of the rotors into at least one of the rotor groups, [8] installing an odd number of the rotors into each of the rotor groups, where the odd number is greater than one, or the like.

In the second example, the step of installing may include one of the steps of [1] installing the rotor groups in a first arrangement which is symmetric with respect to a longitudinal axis of the aircraft, [2] installing the rotor groups in a second arrangement which is symmetric with respect to a lateral axis of the aircraft, [3] installing the rotor groups in a third arrangement which is asymmetric with respect to at least one of the longitudinal and lateral axes of the aircraft, or the like.

In the third example, the step of installing may include one of the steps of installing the rotors of all of the rotor groups at the same elevation from a horizontal plane of the body, installing a first rotor of the rotor groups at a first elevation, while installing a second rotor of the rotor groups at a second elevation, where the first rotor is installed closer to the front of the aircraft than the second rotor, and where the first elevation is smaller than the second elevation, and installing a third rotor and a fifth rotor of the rotor groups at a third elevation and a fifth elevation, respectively, while installing a fourth rotor of the rotor groups at a fourth elevation, where the fourth rotor is disposed closer to a longitudinal axis of the aircraft, and where the fourth elevation is less than the third and fifth elevations.

In the fourth example, the step of installing may include one of the steps of [1] installing a first rotor, a second, and a third rotor of the rotor groups in a direction from the front to the rear, [2] arranging the first, second, and third rotors respectively at a first elevation from a horizontal plane of the body, a second elevation from the horizontal plane, and a third elevation from the horizontal plane, where the first elevation is smaller than the second elevation which is smaller than the third elevation, or the like.

In the fifth example, the step of providing may include the step of incorporating at least one mechanical joint between the moving element of the tilting unit and the stationary element of the tilting unit.

The sixth example is the same as the fifth example of the first feature.

In the seventh example, the step of providing may include the step of tilting the moving element within the tilting range which is one of about 15°, 30°, 45°, 60°, 75°, 90°, 105°, 120°, 135°, 150°, 165°, 180°, or the like. The tilting range may also be about 195°, 210°, 225°, 240°, 255°, 270°, 285°, 300°, 315°, 330°, 345°, or 360°.

In the eighth example, the step of providing may include the step of tilting the moving element with respect to the stationary element in at least one of a roll, a pitch, and a yaw.

In the ninth example, the step of providing may include the steps of installing at least one stopper along the angular direction, and stopping the moving element from being tilted beyond the stopper, thereby defining at least one of an upper bound and a lower bound of the tilting range.

In the tenth example, the step of providing may include the steps of providing at least one bumper which exhibits viscous property and installing the bumper in one of an upper bound and a lower bound of the tilting range, whereby the bumper absorbs at least a portion of mechanical energy of the moving element when the moving element reaches the one of the upper and lower bounds and abuts the bumper.

In the eleventh example, the step of providing may include the step of providing a first tilting unit as well as a second tilting unit each of which includes the moving element and the stationary element.

In the twelfth example, the first tilting unit may have a first tilting range which is one of about 15°, 30°, 45°, 60°, 75°, 90°, 105°, 120°, 135°, 150°, 165°, 180°, 195°, 210°, 225°, 240°, 255°, 270°, 285°, 300°, 315°, 330°, 345°, or 360°. The second tilting unit may have a second tilting range which may be the same as or different from the first tilting range.

In the thirteenth example, the step of first coupling may include one of the steps of [1] directly coupling the at least one of the rotor groups to the moving element, or [2] directly coupling the at least one of the rotor groups to a frame, and then directly coupling the frame to the moving element.

In the fourteenth example, the step of second coupling may include one of the steps of [1] directly coupling the stationary element to the body, [2] directly coupling the stationary element to a frame, and then directly coupling the frame to the body, or the like.

In the fifteenth example, the step of first rotating may include the steps of manipulating the first set of rpms such that the first vector sum is greater than the weight load, thereby increasing an altitude of the aircraft, manipulating the first set of rpms such that the first vector sum is less than the weight load, thereby decreasing the altitude of the aircraft, and manipulating the first set of rpms such that the first vector sum is at least substantially equal to the weight load, thereby at least substantially maintaining the altitude of the aircraft.

In the sixteenth example, the step of second rotating may include the steps of assigning a first rotor and a second rotor of at least one of the rotor groups respectively as a front rotor and a rear rotor of the at least one of the rotor groups, where the front rotor is installed closer to the front of the aircraft than the rear thereof, and increasing a front lift generated by the front rotor so that the front lift is greater than a rear lift generated by the rear rotor, whereby the second non-zero horizontal component points the rear of the aircraft, and whereby the aircraft moves in a backward direction.

In the seventeenth example, the step of second rotating may include the steps of assigning a first rotor and a second rotor of at least one of the rotor groups respectively as a front rotor and a rear rotor of the at least one of the rotor groups, where the front rotor is installed closer to the front of the aircraft than the rear thereof, and increasing a rear lift generated by the rear rotor so that the rear lift is greater than a front lift generated by the front rotor, whereby the second non-zero horizontal component points the front of the aircraft, and whereby the aircraft moves in a forward direction.

In the eighteenth example, the step of the second rotating may include one of the steps of performing [1] a roll operation, [2] a pitch operation, [3] a yaw operation, [4] a turning around operation while maintaining an altitude of the aircraft, [5] a turning around operation while changing an altitude of the aircraft, [6] an operation of changing an altitude of the aircraft, or the like.

In the nineteenth example, the step of allowing may include one of the steps of [1] rotating the moving element in a forward direction while maintaining the stationary element at a preset altitude, [2] rotating the moving element in the forward direction while increasing the altitude of the stationary element, [3] rotating the moving element in the forward direction while decreasing the altitude of the stationary element, [4] rotating the moving element about a center axis of the moving element while maintaining the stationary element at the altitude, [5] rotating the moving element in a backward direction while maintaining the stationary element at a preset altitude, [6] rotating the moving element in the backward direction while increasing the altitude of the stationary element, [7] rotating the moving element in the backward direction while decreasing the altitude of the stationary element, [8] performing a combination of at least two of [1] to [8] of this paragraph, or the like.

In the twentieth example, the step of allowing may include one of the steps of [1] maintaining the body at least substantially in a horizontal plane while the upper arm and the rotor group are tilted in the tilted direction, [2] tilting the body at least substantially in the tilted direction, [3] tilting the body at least substantially in the tilted direction but at an angle which is less than the tilting angle of the upper arm and the rotor group, or the like.

The tenth feature of this disclosure relates to a method of operating a multi-rotor aircraft including a body which includes a front and a rear. The method may include the steps of, e.g., (1) providing, (2) configuring, (3) installing, (4) first coupling, (5) second coupling, (6) first rotating, (7) second rotating, (8) allowing, and (9) moving.

The step of providing is to provide at least one tilting unit which may include a moving element and a stationary element. The step of configuring is to make the moving element be tilted with respect to the stationary element in at least one angular direction and within a preset tilting range. The step of installing is to install multiple rotor groups in a preset arrangement, where each of the rotor groups includes at least two rotors, and where each of the rotor groups is capable of generating lifts when the rotors rotate.

The step of first coupling is to couple at least one of the rotor groups to the moving element of the tilting unit. The step of second coupling is to couple the stationary element with the body of the aircraft.

The step of first rotating is to rotate the rotors of the rotor groups in a first set of rpms such that a first vector sum of the lifts at least substantially includes a first non-zero vertical component but at least substantially no non-zero horizontal component. The step of second rotating is to rotate the rotors of the rotor groups in a second set of rpms such that the first vector sum of the lifts includes a second non-zero vertical component and a second non-zero horizontal component.

The step of allowing is to allow the moving element of the tilting unit and the rotor group coupled to the moving element of the tilting unit to be tilted in a tilted direction which is a direction of the first vector sum. The step of moving is to move the aircraft in the tilted direction, where the moving includes a horizontal movement of the aircraft which is proportional to the horizontal component of the first vector sum, and where the moving also includes a vertical movement which is proportional to a second vector sum of the vertical component of the first vector sum and a vector of a weight load of the aircraft.

Accordingly, the aircraft may perform the moving, while the stationary element of the tilting unit and the body coupled to the stationary element of the tilting unit are at least substantially not tilted in the tilted direction.

The tenth feature of this disclosure may include the following examples.

The first to sixth examples are identical or similar to the first to sixth examples of the above ninth feature.

In the seventh example, the configuring may include the step of tilting the moving element within the tilting range which is one of about 15°, 30°, 45°, 60°, 75°, 90°, 105°, 120°, 135°, 150°, 165°, 180°, 195°, 210°, 225°, 240°, 255°, 270°, 285°, 300°, 315°, 330°, 345°, or 360°.

In the eighth example, the configuring may include the step of tilting the moving element with respect to the stationary element in at least one of a roll, a pitch, and a yaw.

In the ninth example, the configuring may include the steps of installing at least one stopper along the angular direction, and stopping the moving element from being tilted beyond the stopper, thereby defining at least one of an upper bound and a lower bound of the tilting range.

In the tenth example, the configuring may include the steps of providing at least one bumper which exhibits viscous property, and installing the bumper in an upper bound or a lower bound of the tilting range, whereby the bumper absorbs at least a portion of mechanical energy of the moving element when the moving element reaches the one of the upper and lower bounds and abuts the bumper.

The eleventh to twentieth examples are identical or similar to the eleventh to twentieth examples of the above ninth feature.

The eleventh feature of this disclosure relates to a method of cruising a multi-rotor aircraft including a body which includes a front and a rear. The method may include the steps of, e.g., (1) installing, (2) providing, (3) first coupling, (4) second coupling, (5) first rotating, (6) second rotating, (7) allowing, or the like.

The step of installing is to install at least one rotor group including at least two rotors each generating a lift when rotated. The step of providing is to provide at least one tilting unit including an upper arm, a lower arm, and a joint allowing the upper arm to rotate about the lower arm in at least one angular direction.

The step of first coupling is to couple the rotor group to the upper arm of the tilting unit, while the step of second coupling is to couple the lower arm to a body of the aircraft.

The step of first rotating is to rotate the rotors of the rotor group in a first set of rpms so that a first vector sum of the lifts acts in an upward direction, and that a magnitude of the first vector sum is at least substantially equal to a weight load of the aircraft, whereby the aircraft performs the hovering, The step of second rotating is to rotate the rotors of the rotor groups in a second set of rpms in such a way that the first vector sum of the lifts includes a second non-zero vertical component and a second non-zero horizontal component.

The step of allowing is to allow the upper arm of the tilting unit and the rotor group coupled to the upper arm to be tilted by a tilting angle in a tilted direction which is a direction of the first vector sum, whereby the aircraft performs the cruising.

The eleventh feature of this disclosure may include the examples, where the first to twentieth examples may be identical or similar to the first to twentieth examples of the above ninth feature.

The twelfth feature of this disclosure relates to a method of cruising a multi-rotor aircraft including a body which includes a front and a rear. The method may include the steps of, e.g., (1) installing, (2) providing, (3) first coupling, (4) second coupling, (5) generating, or the like.

The step of installing is to include at least one rotor group including at least two rotors each generating a lift when rotated. The step of providing is to provide at least one tilting unit including an upper arm, a lower arm, and a joint allowing the upper arm to rotate about the lower arm in at least one angular direction;

The step of first coupling is to couple the rotor group to the upper arm of the tilting unit, while the step of second coupling is to couple the lower arm to a body of the aircraft. By varying rpms of the rotors, the step of generating is to generate lifts so that a vector sum of the lifts includes a non-zero vertical component and a non-zero horizontal component.

Accordingly, the upper arm of the tilting unit and the rotor group coupled to the upper arm may be tilted by a tilting angle in a tilted direction which is a direction of the vector sum, whereby the aircraft performs the cruising in a cruising direction which is a difference between the vector sum of the lifts and a vector of gravity.

The twelfth feature of this disclosure may include the examples, where the first to twentieth examples may be identical or similar to the first to twentieth examples of the above ninth feature.

Unless otherwise defined in this disclosure, all technical and scientific terms used herein have the same meaning as commonly understood by one of ordinary skill in the art to which multi-rotor aircrafts belong. Although other configurations or methods equivalent or similar to those described in this disclosure may be used in making or using such aircrafts, suitable configurations or methods are to be described below. All publications, patent applications, patents or other references mentioned herein are to be incorporated herein by reference in their entirety. In case of any conflict, this disclosure will prevail. In addition, the configurations or methods of this disclosure are only illustrative and not intended to be limiting.

### BRIEF DESCRIPTION OF THE DRAWINGS

FIG. 1 is a top view of a conventional multi-rotor air vehicle;

FIG. 2 is a cross-sectional view of the multi-rotor air vehicle of FIG. 1 hovering in the sky;

FIG. 3 is a cross-sectional view of the multi-rotor air vehicle of FIG. 1 about to tilt its body;

FIG. 4 is a cross-sectional view of the multi-rotor air vehicle of FIG. 2 in cruising with its body tilted in a forward direction;

FIG. 5 is a cross-sectional view of an exemplary passively tiltable rotor group of this disclosure which is coupled to a body of a multi-rotor aircraft;

FIG. 6 is a cross-sectional view of an exemplary multi-rotor aircraft of this disclosure which hovers in the sky;

FIG. 7 is a cross-sectional view of the exemplary multi-rotor aircraft of FIG. 6 which starts to cruise;

FIG. 8 is a cross-sectional view of the multi-rotor aircraft of FIG. 7 in cruising with its rotor groups tilted in a forward direction;

FIG. 9 is a cross-sectional view of a conventional multi-rotor air vehicle shown in FIGS. 1 to 4 which is tilted at 45° in a forward direction;

FIG. 10 is a cross-sectional view of an exemplary multi-rotor aircraft of this disclosure of which rotor groups are tilted at 45° in a forward direction;

FIG. 11 is a top view of an exemplary multi-rotor aircraft of this disclosure which includes four rotor groups and four tilting units;

FIG. 12 is a perspective view of the multi-rotor aircraft of FIG. 11;

FIG. 13 is a perspective view of the exemplary multi-rotor aircraft of FIGS. 11 and 12 which performs a yaw rotation;

FIG. 14 is a cross-sectional view of an exemplary multi-rotor aircraft of this disclosure including a pair of tilting units which are symmetrically positioned with respect to its longitudinal axis;

FIG. 15 is a cross-sectional view of another exemplary multi-rotor aircraft of this disclosure which includes a pair of tilting units on a left side of the aircraft, and two additional tilting units on a right side thereof;

FIG. 16 is a perspective view of another exemplary multi-rotor aircraft of this disclosure which includes four tilting units on a left side, and four more tilting units in a right side;

FIG. 17 is a cross-sectional view of an exemplary path-dependent tilting unit of this disclosure which is coupled to a rotor group of a multi-rotor aircraft during hovering;

FIG. 18 is a cross-sectional view of a path-dependent tilting unit of this disclosure which tilts the rotor group along a preset path;

FIG. 19 is a cross-sectional view of an exemplary rod-end tilting unit of this disclosure which couples with a rotor group of a multi-rotor aircraft during hovering;

FIG. 20 is a cross-sectional view of the rod-end tilting unit of FIG. 19 which is cruising while a rotor group is tilted in a forward direction;

FIG. 21 is a cross-sectional view of an exemplary turn-table tilting unit of this disclosure which is vertically coupled to a rotor group of a multi-rotor aircraft and allows the rotor group to tilt in a first direction FIG. 22 is a cross-sectional view of another exemplary turn-table tilting unit of this disclosure which is coupled to a rotor group in a horizontal direction and allows the rotor group to tilt in a different direction;

FIG. 23 is a cross-sectional view of a ball-socket joint-type tilting unit under a weight load;

FIGS. 24A-24B are cross-sectional views of an exemplary configurations in which a tension spring-type load sharing unit are incorporated around a tilting unit;

FIG. 25 are bottom views of the spring-type load sharing units of this disclosure which are distributed around rotor groups and tilting units of a multi-rotor aircraft;

FIG. 26 is a bottom view of another spring-type load sharing units of this disclosure which are distributed preferentially along a lateral axis of a multi-rotor aircraft;

FIGS. 27A-27B are cross-sectional views of an exemplary configuration in which multiple spring-type load sharing units are installed around a tilting unit;

FIG. 28 is a cross-sectional view of an exemplary configuration in which a compression spring-type load sharing unit are incorporated around a tilting unit;

FIGS. 29A-29B are cross-sectional views of an exemplary configuration in which solid spacers are installed around a tilting unit;

FIG. 30 is an exemplary protocol for defining various tilting ranges of the tilting units;

FIG. 31 is an exemplary tilting unit which provides at least two degrees of freedom to a rotor group;

FIG. 32 is a cross-sectional view of a ball-socket joint-type tilting unit of this disclosure which includes stoppers;

FIG. 33 is a cross-sectional view of an exemplary obstruction which is installed around a mechanical joint-type tilting unit;

FIG. 34 is a cross-sectional view of another exemplary obstruction which is installed along a path of a path-dependent tilting unit;

FIG. 35 is a top view of a multi-rotor aircraft including four rotor groups which are arranged in a shape of “X”;

FIG. 36 is a top view of a multi-rotor aircraft including three rotor groups which are arranged in vertices of a triangular shape;

FIG. 37 is a top view of a multi-rotor aircraft including four rotor groups each of which includes rotors of different sizes;

FIG. 38 is a top view of another multi-rotor aircraft including four rotor groups which include rotors of different sizes;

FIG. 39 is a cross-sectional view of a multi-rotor aircraft including four rotor groups which are installed at the same height or elevation with respect to a horizontal plane;

FIG. 40 is a cross-sectional view of another multi-rotor aircraft including two front rotor groups and two rear rotor groups, where the rear rotor groups are installed at a greater height or elevation than the front rotor groups;

FIG. 41 is a cross-sectional view of yet another multi-rotor aircraft including four rotor groups which are installed at an increasingly greater height or elevation from a front to a rear of the aircraft;

FIG. 42 is a cross-sectional view of yet another multi-rotor aircraft including four rotor groups at least one of which may be manipulated upward or downward, thereby changing its height or elevation;

FIG. 43 is a cross-sectional view of a tilting unit and a bumper capable of absorbing a sudden bump or shock caused by a tilting unit approaching an upper or lower bound of its tilting ranges;

FIG. 44 is a cross-sectional view of a tilting unit and another bumper with such absorbing capability when a tilting unit approaching an upper or lower bound of its tilting ranges;

FIG. 45 is a cross-sectional view of a tilting unit and yet another bumper with such absorbing capability when a tilting unit approaching an upper or lower bound of its tilting ranges;

FIG. 46 is a cross-sectional view of an exemplary assisted tilting unit employing a gear assembly and power transmitter;

FIG. 47 is a top view of an exemplary multi-rotor aircraft of this disclosure which is performing a turning operation;

FIG. 48 is a perspective view of a four-quadcopter-type multi-rotor aircraft of this disclosure which includes at least one biased rotor groups;

FIG. 49 is a cross-sectional view of exemplary biased rotor groups which may be coupled to various parts of a multi-rotor aircraft;

FIG. 50 is a perspective view of an exemplary multi-rotor aircraft which is similar to that of FIG. 16, which has a shape of a four-quadcopter, which includes eight tilting units, and which is about to switch from hovering to cruising in a forward direction; and

FIG. 51 is a perspective view of the multi-rotor aircraft of FIG. 50, where a control unit is about to tilt the outer set of tilting units and the outer rotor groups.

### DETAILED DESCRIPTION

This disclosure relates to a multi-rotor aircraft including at least one rotor group and at least one tilting unit which may be directly or indirectly coupled to the rotor group such that the rotor group can be tilted along with the tilting unit within a tilting range of the tilting unit in almost any tilting direction. Accordingly, contrary to a prior art multi-rotor air vehicle, the multirotor aircraft of this disclosure can cruise with its rotor group tilted but without having to tilt other parts of the aircraft.

More importantly, the “passively tiltable rotor group” (i.e., the rotor group and the tilting unit which is coupled to the rotor group) of the multi-rotor aircraft of this disclosure can be tilted passively in a tilted direction, without having to resort to any additional electric motor or power generating devices. In addition, the multi-rotor aircraft including the passively tiltable rotor group can cruise at a higher speed, can fly over a longer flight distance, and can provide excellent stability, agility, and controllability, compared to various conventional vehicles.

This disclosure relates to various methods of making the tilting unit, coupling the tilting unit indirectly or directly to the rotor group, making and installing a load sharing unit which can bear a portion of a weight load of the aircraft and, therefore, which can relieve the tilting unit and rotor group from the entire portion of the weight load, making and operating the multirotor aircraft which includes the passively tiltable rotor group and optionally the load sharing unit, and cruising or performing turning operations.

Disclosed hereinafter are various exemplary aspects, embodiments, and examples of various multi-rotor aircrafts each of which includes at least one passively tiltable rotor group and each of which may include at least one load sharing unit. In addition, this disclosure also relates to various configurational and operational features of such a multi-rotor aircraft, its tilting unit, its load sharing unit, or the like. This disclosure further relates to various methods of fabricating or using such tiltable rotor groups and multi-rotor aircrafts including such tiltable rotor groups, and the like.

This disclosure relates to various methods of driving or controlling operations of the multirotor aircraft during its taking off, hovering, cruising (i.e., moving in a forward or tilted direction), performing a yaw operation, performing turning operations, or landing. This disclosure also relates to various control algorithms or control software for the multi-rotor aircraft.

It is noted that this disclosure is provided with reference to accompanying drawings and text, in which the exemplary aspects, embodiments or examples only represent different forms. However, various multi-rotor aircrafts and various methods related thereto may instead be embodied in many other different configurations, structures, methods, or processes so that they should not be limited to various exemplary aspects, embodiments, and examples as set forth hereinabove and hereinafter. Rather, such exemplary aspects, embodiments, and examples described in this disclosure are provided so that this disclosure will be thorough and complete, and fully convey the scope of such multi-rotor aircrafts or related methods to one of ordinary skill in the relevant art.

Unless otherwise specified, various groups, units or elements of such multi-rotor aircrafts may not be drawn to actual scales in the accompanying figures for illustration purposes. It is noted that such groups, units or elements of the multi-rotor aircrafts, and operations, steps or sequences designated by the same numerals in the accompanying figures may represent the same, similar or functional equivalent groups, units, elements, operations, steps or sequences, respectively.

Reference is made to accompanying drawings which may show, by way of illustration, various exemplary aspects, embodiments or examples in which the multi-rotor aircrafts may be constructed, and various methods related to operating such multi-rotor aircrafts may be performed.

It is noted that numerals appearing between parentheses “(” and “)” in this disclosure such as, e.g., (10) or (60), mean those groups, units or elements which appear in the drawings. Alternatively, the numerals between the parentheses may be used to better represent a long list those groups, units, elements or their characteristics.

It is also noted that numerals disposed between square brackets “[” and “]” such as, e.g., [1] or [2], mean that they are alternatives to each other. For example, “examples of such joints include [1] a ball-socket joint, [2] a pin joint, or the like” means that the joint may be a ball-socket joint, a pin joint, or any equivalent of such joints.

It is further noted that various exemplary aspects, embodiments, or examples of such multirotor aircrafts of this disclosure, although different, are not necessarily mutually exclusive. That is, a particular feature, structure, operation, function or method of such multi-rotor aircrafts described in connection with one exemplary aspect, embodiment or example may be implemented into another aspect, embodiment or example of this disclosure interchangeably, as long as such implementation does not contradict such aspect, embodiment or example, and as long as such implementation is not departed from a spirit and a scope of such aircrafts.

When desirable, one feature of a certain aspect, embodiment, example or objective of this disclosure [1] may be applied to, [2] may be incorporated into, [3] may replace, [4] may be replaced by, or [5] may be combined with a corresponding feature of another aspect, embodiment, or example of this disclosure which has been described throughout this disclosure, as long as such application, incorporation, replacement, or combination does not contradict each other.

An arrangement or a position of each group, unit or element of various exemplary aspects, embodiments or example of this disclosure may be modified to a certain extent without departing from the spirit and scope of such multi-rotor aircrafts of this disclosure. Thus, following detailed description is not to be taken to limit the scope of the multi-rotor aircrafts and various methods related thereto.

The scope of various multi-rotor aircrafts and methods of making or using such are to be defined by appended claims which must be appropriately interpreted in a full range of equivalents to which the claims are entitled. In the drawings, like reference numerals identify like (or similar) groups, units, elements or functions in different views.

Hereinafter, exemplary aspects, embodiments or examples of various multi-rotor aircrafts of this disclosure will be explained in detail in both hardware and software perspectives and with reference to the accompanying drawings such that one skilled in the art can easily understand and use such multi-rotor aircrafts, make such aircrafts, operate such aircrafts, or the like.

### 1. First Exemplary Aspect—A Passively Tiltable Rotor Group

### 1-1. Basic Configuration

The first exemplary aspect of this disclosure relates to a passively tiltable rotor group which includes at least one rotor group and at least one tilting unit which is either directly or indirectly coupled to the rotor group. More particularly, by manipulating rpms of rotors of the rotor group, the sum of such lifts generated by such rotors may tilt the tilting unit in a preset tilted direction along a preset tilting path. Because the tilting unit is coupled to the rotor group, that rotor group may also be tilted in the preset direction along the preset tilting path. It is noted that the passively tiltable rotor group of various multi-rotor aircrafts of this disclosure can be tilted, without requiring any additional electric motor or any additional power-generating element.

In the first exemplary embodiment of the first aspect of this disclosure, a multi-rotor aircraft may include at least one tilting unit which can be directly or indirectly coupled to at least one rotor group on one arm, and which can be directly or indirectly coupled to a wing, a body or another part of such an aircraft on an opposing arm.

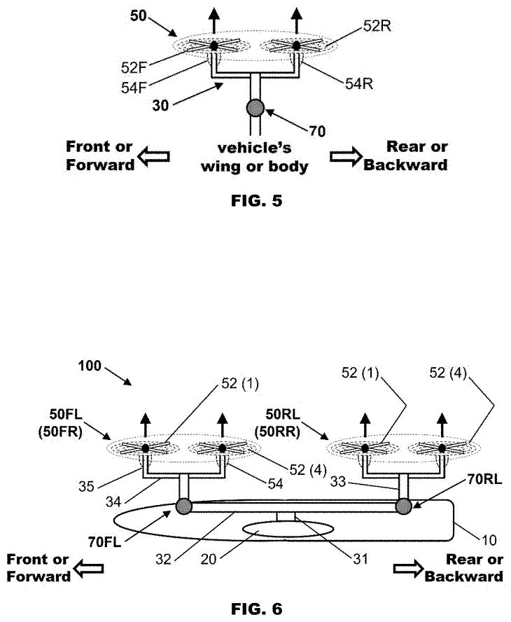

FIG. 5 is a cross-sectional view of an exemplary passively tiltable rotor group indirectly coupled to a wing or a body of a multi-rotor aircraft. It is noted that detailed configuration of the aircraft is not included in the figure for ease of illustration.

A typical passively tiltable rotor group includes at least one rotor group (50) and at least one tilting unit (70). The rotor group (50) includes at least two rotors (e.g., a front rotor (52F) and a rear rotor (52R)) along with at least two rotor motors (54F), (54R) each of which is designated to drive propellers of each of such rotors (52F), (52R).

The tilting unit (70) is incorporated between the rotor group (50) and a wing or a body of an aircraft in such a way that the rotor group (50) can be mechanically coupled to the body through the tilting unit (70). To embody such mechanical coupling, one or multiple frames (30) may be incorporated as well, where details of such frames (30) are to be provided below.

As will be explained in greater detail below, the tilting unit (70) is so constructed that it (70) can be tilted in at least one tilted direction. Because the rotor group (50) is directly or indirectly coupled to the tilting unit (70), the tilting unit (70) can also provide the rotor group (50) with at least one degree of freedom. Therefore, the rotor group (50) may be tilted or rotated along with the tilting unit (70) in at least one tilted direction with respect to the wing or the body of the aircraft about or along the tilting unit (70). Following FIGS. 6 to 8 illustrate mechanisms of such tilting of the tilting unit and the rotor group of the passively tiltable rotor group.

FIG. 6 is a cross-sectional view of an exemplary multi-rotor aircraft (100) which is hovering while maintaining a preset altitude. The exemplary multi-rotor aircraft (100) includes a body (10), a pair of wings (20) (only the left wing is shown in the figure), and four rotor groups (50FL), (50FR), (50RL), (50RR) each of which includes four identical rotors (52 (1)), (52 (2)), (52 (3)), (52 (4)), where propellers of each rotor (52) are rotated (or driven) by its own rotor motor (54).

It is noted that only two rotor groups such as a front-left rotor group (50FL) and a rear-left rotor group (50RL) are shown in the figure, while other two rotor groups such as a front-right rotor group (50FR) and a rear-right rotor group (50RR) are omitted in the figure for ease of illustration. It is also noted that only two rotors such as a first rotor (52 (1)) and a fourth rotor (52 (4)) of each rotor group (50FL), (50RL) are shown in the figure, whereas other two rotors such as a second rotor (52 (2)) and a third rotor (52 (3)) are not shown in the figure for ease of illustration.

For ease of illustration, all of such rotor groups may be collectively or individually referred to as (50), while all of such rotors may be collectively or individually referred to as (52) hereinafter.

In general, when a rotor group (50) includes four rotors (52 (1)), (52 (2)), (52 (3)), (52 (4)) as shown in FIG. 6, the odd-numbered (or even-numbered) rotors may rotate in a clockwise (or CW) direction, while the even-numbered (or odd-numbered) rotors may rotate in a counter-clockwise (or CCW) direction. By employing such an arrangement, each rotor group (50) maintains a balance in torque such that the rotor group (50) does not exert any net torque forcing the rotor group (50) to rotate about its vertical center axis.

It is noted that the same balance in torque may be achieved as well by rotating each pair of adjacent rotors (52) to rotate in the same direction. For example, a first pair of adjacent rotors (52 (2)), (52 (3)) may rotate in the CW direction, while a second pair of rotors (52 (4)), (52 (1)) may rotate in the CCW direction.

The rotor groups (50) may couple with the body (10) or the wing (20) of the aircraft (100) in various arrangements. As illustrated in the figure, the rotor groups (50) may mechanically couple to the wing (20) through a third vertical frame (35), a second horizontal frame (34), a second vertical frame (33), a first horizontal frame (32), and a first vertical frame (31). For ease of illustration, all of such frames may be collectively or individually referred to as (30).

For example, the multi-rotor aircraft (100) includes at least one frame on the left wing (20), and also includes the same frame on its right wing as well. In the configuration exemplified in the figure, the left (or right) wing is coupled to the left (or right) first vertical frame (31) which is then coupled to the left (or right) first horizontal frame (32) which is coupled to the left (or right) second vertical frame (33) which is coupled to the left (or right) second horizontal frame (34) which is coupled to the left (or right) third vertical frame (35).

It is noted that the multi-rotor aircraft (100) may recruit a certain number of frames having a certain shape or size which may be different from those shown in the figure. For example, the rotor groups (50) may couple with the aircraft (100) through a greater (or smaller) number of frames than the one shown in the figure.

That is, when the aircraft includes a different number of such vertical or horizontal frames or when the aircraft may include a curved frame or a branched frame, the rotor groups (50) may mechanically couple to the body (10) or the wing (20) through a different combination or sequence of such frames.

The front-left rotor group (50FL) and rear-left rotor group (50RL) couple with various frames (31)˜(35) directly or indirectly, and then couple with the tilting units (70). Thus, when the rotors (52) of a certain rotor group (50) rotate at different rpms, the rotor group (50) generates the lifts. When a vector sum of such lifts acts (or points) a direction which forms a non-zero angle with a direction of gravity, the rotor group (50) may be tilted [1] in one direction (e.g., as defined by a pin joint-type tilting unit), [2] in two directions (e.g., as defined by a screw joint-type tilting unit), [3] in three directions (e.g., as defined by a ball-socket joint-type tilting unit), or the like.

In the configuration exemplified in FIG. 6, the front-left (or right) tilting unit (70FL), (70FR) is incorporated at a junction of the left (or right) first horizontal frame (32) and the left (or right) second vertical frame (33) which is disposed closer to a front-left (or right) rotor group (50FL), (50FR). Similarly, a rear-left (or right) tilting unit (70RL), (70RR) is incorporated at the similar junction disposed closer to a rear-left (or right) rotor group (50RL), (50RR).

It is noted that the tilting units (70) can be tilted in at least one tilted direction, where the tilted direction usually includes a forward direction. To this end, the tilting units (70) can have a configuration which may be identical or similar to a prior art joint which is capable of providing at least one degree of freedom.

In operation, a control unit (now shown in FIG. 6) can manipulate the multi-rotor aircraft (100) to perform various operation, simply by manipulating the rpm of at least one rotor (52), by manipulating the lift generated by at least one rotor (52), by manipulating the (net) lifts generated by at least one rotor group (50), or the like.

The first exemplary operation of the aircraft (100) is a cruising or an operation of moving in a forward direction. To this end, the aircraft (100) is assumed to be hovering, i.e., the aircraft does not change its position and altitude.

Each rotor group (50) or each rotor (52) of the rotor groups (50) in the figure may rotate at the same rpm and, therefore, generate an upward lift of the same magnitude in a direction opposite to a direction of gravity. Alternatively, each rotor group (50) or each rotor (52) of the rotor groups (50) may generate the lift of the same magnitude in the same vertical and upward direction.

When an amplitude of a vector sum of such lifts becomes equal to an amplitude of the gravitational force exerted on the aircraft (100) (i.e., its weight load) and when there are no external disturbances, the multi-rotor aircraft (100) can maintain hovering in the sky, while maintaining a preset altitude.

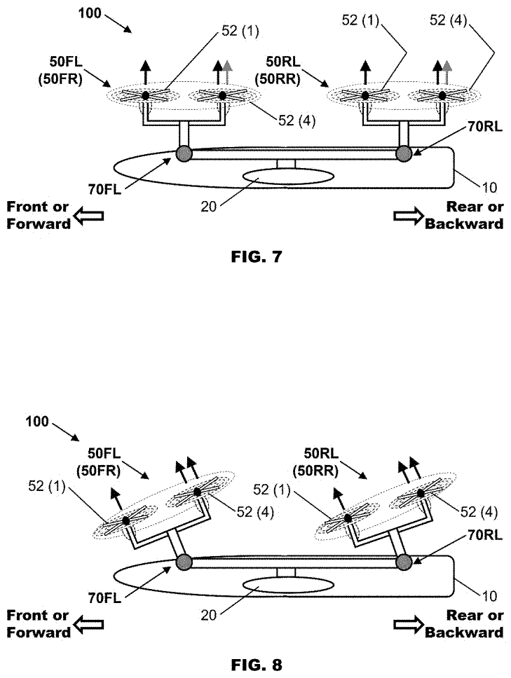

FIG. 7 is a cross-sectional view of the exemplary multi-rotor aircraft (100) of FIG. 6, where the rotor groups (50) are about to be tilted. For example, when a control unit of the multi-rotor aircraft (100) increases rpms of the rear rotors (52 (4)) of the rotor groups (50), the rear rotors (52 (4)) begin to increase their lifts (to be referred to as the “rear lifts”), where such increased lifts are represented by a gray arrow in the figure. As a result, the rear lifts which are generated by the rear rotors (52 (4)) become greater than the lifts which are generated by the front rotors (52 (1)) (to be referred to as the “front lifts”) of the same rotor groups (50).

While increasing the rpms of the rear rotors (52 (4)), the control unit may maintain the rpms of the front rotors (52 (1)) of the rotor groups (50). Alternatively, the control unit may decrease the rpms of the rear rotors (52 (4)) of the same rotor groups (50). Accordingly, a difference between the rear lifts and the front lifts increases.

FIG. 8 is a cross-sectional view of the multi-rotor aircraft of FIG. 7 with its tiltable tilting units tilted in a tilted direction and cruising in that tilted direction. For example, when the rear rotors (52 (4)) of the rotor groups (50) rotate faster than the front rotors (52 (1)) of the same rotor groups (50) or when the rear rotors (52 (4)) generate the rear lifts which are greater than the front lifts generated by the front rotors (52 (1)), a difference between such rear and front lifts tends to generate a torque acting around the tilting unit (70) in a counter-clockwise direction.

Because the tilting units (70) operate as rotatable joints, a vector sum of such rear and front lifts tilts (or rotate) the tilting unit (70) in a counter-clockwise direction (e.g., in the forward direction shown in the figure). Because the rotor groups (50) are either directly or indirectly coupled to the tilting units (70), a vector sum of such rear lifts and front lifts generated by the rotor groups (50FL), (50RL) tilts (or rotates) the rotor groups (50FL), (50RL) as well in the same counter-clockwise or forward direction.

As the rotor groups (50) are tilted in the tilted or forward direction, the vector sum of the lifts generated by the rotor groups (50) begins to have a horizontal component of a non-zero magnitude. As a result, the aircraft (100) can move in the direction of the horizontal component of the vector sum of such lifts.

As the rear rotors (52 (4)) of the rotor groups (50) begin to rotate far faster than the front rotors (52 (1)) of the same rotor groups (50), or as the rear rotors (52 (4)) begins to generate the rear lifts which are far greater than the front lifts generated by the front rotors (52 (1)), a difference between the rear lifts and the front lifts further increases. As a result, the aircraft (100) can move in the direction of the horizontal component of the vector sum of such lifts at an even faster speed.

It is noted that the control unit may employ the same control mechanism to move the aircraft (100) in a backward direction.

For example, the control unit may increase the rpms of the front rotors (52 (1)), (52 (2)) of the rotor groups (50), while maintaining or decreasing the rpms of the rear rotors (52 (3)), (52 (4)) of the rotor groups (50). Alternatively, the control unit may increase the front lifts but maintain or decrease the rear lifts. In a mechanism which is opposite to that explained in conjunction with the cruising (e.g., moving in the forward direction), the aircraft (100) may then move in the backward direction.

In both the forward cruising and backward cruising, the aircraft (100) may maintain the same altitude or its altitude may increase (or decrease), depending on an amplitude of the vector sum of such rear and front lifts. Based on such an amplitude, the control unit may adjust the rpm of at least one rotor, thereby maintaining, increasing or decreasing the altitude of the aircraft (100).

The second exemplary operation of the aircraft (100) is a turning operation, e.g., to the right. To this end, the aircraft (100) is assumed to be moving in the forward direction (e.g., cruising), while maintaining the same altitude.

During such cruising, a control unit may increase rpms of the left rotors (52 (1)), (52 (4)) of the front-left rotor group (50FL), while maintaining or decreasing rpms of the right rotors (52 (2)), (52 (3)) of the same rotor group (50FL), as well as the rotors of other rotor groups.

Alternatively, the control unit may increase the lifts generated by the left rotors (52 (1)), (52 (4)) of the same rotor group (50FL), (to be referred to as the “left lifts”), while maintaining or even decreasing the lifts generated by the right rotors (52 (1)), (52 (4)) of the same rotor group (50FL) (to be referred to as the “right lifts”) as well as the rotors of other rotor groups.

As a result, a difference between the left lifts and the right lifts tends to generate a torque acting in a right direction (i.e., a direction going into the paper in the figure) around the tilting unit (70).

Because the front-left tilting unit (70FL) operate as a rotatable joint, a vector sum of such left lifts and right lifts may tilt (or rotate) the tilting unit (70) in the right direction. In addition, the front-left rotor group (50FL) is directly or indirectly coupled to the front-left tilting unit (70FL). As a result, a vector sum of such left lifts and the right lifts generated by the left and right rotors of the rotor group (50FL) may tilt (or rotate) the front-left rotor group (50FL) in the right direction.

However, because the aircraft (100) has been moving in the forward direction, the aircraft (100) has a certain inertia which also acts (or points) the forward direction. As a result, another vector sum of the above horizontal component and the inertia moves the aircraft (100) to the right, and the aircraft (100) can perform a turning operation (to the right).

Depending upon an amplitude of, e.g., the vertical component of the vector sum of such left lifts and right lifts, the aircraft (100) may main, increase or decrease its altitude during the turning (to the right) operation.

The control unit may also manipulate the rpms of (or lifts generated by) the left rotors (52 (1)), (52 (4)) of at least one of other three rotor groups (50FR), (50RL), (50RR). The aircraft (100) may then perform the turning operation at an increased speed, at a decreased turning radius, or the like.

In addition, the control unit may instead manipulate the aircraft (100) to perform a turning operation to the left. For example, the control unit may increase rpms of the right rotors (52 (2)), (52 (3)) of at least one of the rotor groups (50), while maintaining or decreasing rpms of the left rotors (52 (1)), (52 (4)) of the same rotor group (50), as well as the rotors of other rotor groups. In the alternative, the control unit may increase the right lifts generated by the right rotors (52 (1)), (52 (4)) of the same rotor group (50), while maintaining or even decreasing the left lifts generated by the left rotors (52 (1)), (52 (4)) of the same rotor group (50).

As a result, a difference between the left lifts and the right lifts tends to generate a torque acting in a left direction (i.e., a direction popping out the paper in the figure) around the tilting unit (70).

Because the tilting unit (70) operate as a rotatable joint, a vector sum of such left lifts and right lifts may tilt (or rotate) the tilting unit (70) in the left direction, and may also tilt (or rotate) the rotor group (50) coupled to that rotor group (50) in the left direction. When combined with the inertia of motion in the forward direction, another vector sum of the above horizontal component and the inertia moves the aircraft (100) to the left, and the aircraft (100) can perform a turning operation (to the right).

The third exemplary operation of the aircraft (100) is a yaw rotation, e.g., in a clockwise (CW) direction. To this end, the aircraft (100) is assumed to be hovering, i.e., the aircraft does not change its position and altitude.

For example, the control unit may manipulate the rpms of the rotors (52) of the front-left rotor group (50FL) such that a vector sum of the lifts generated by such rotors (52) of the rotor group (50FL) has a first horizontal component which acts (or points) to the right (i.e., into the paper of FIG. 8). As a result, the aircraft (100) begins to make a rotation about its vertical center axis, thereby performing a clockwise yaw rotation.

It is appreciated that the vertical center axis may not coincide with a center of the above yaw rotation. Accordingly, when they do not coincide, the aircraft (100) may rotate off from the vertical center axis.

To prevent such an off-center yaw rotation, the control unit may manipulate the rpms of the rotors (52) of another rotor group such as, e.g., the rear-right rotor group (50RR) in such a way that a vector sum of the lifts which are generated by such rotors (52) of the rear-right rotor group (50RR) has a second horizontal component acting (or pointing) to the left (i.e., coming out of the paper of FIG. 8).

The control unit may manipulate the rpms of (or the lifts generated by) the rotors (50) of the front-left rotor group (50FL) and the rear-right rotor group (50RR) such that the first and second horizontal components may have the same amplitudes. Thus, the aircraft (100) may perform the clockwise yaw rotation.

The control unit may also manipulate the rpms of the rotors (52) of the front-right rotor group (50FR) and the rear-left rotor group (50RL), or may manipulate the lifts generated by such rotors (52) of the rotor groups (50FR), (50RL), by employing the control strategy which is similar to the one used for the rotors (52) of the front-left rotor group (50FL) and the rear-right rotor group (50RR). The aircraft (100) may then perform the yaw rotation at an increased speed.

Similarly, the control unit may instead manipulate the aircraft (100) to perform a counter-clockwise yaw rotation, where details of such an operation is omitted for simplicity of explanation.

### 1-2. Advantages and Benefits

The second exemplary embodiment of the first aspect of this disclosure relates to various benefits or advantages offered by the tilting unit, by the passively tiltable rotor group which includes the tilting unit, and by the multi-rotor aircraft which includes the passively tiltable rotor group.

The first benefit is that the multi-rotor aircraft of this disclosure or its pilots can readily tilt the tilting unit as well as the rotor groups of the aircraft which are coupled to the tilting unit, simply by increasing the rpms of certain rotors of the (passive) tiltable rotor groups, or by increasing the lifts generated by such rotors, without requiring any additional electric motor or power-generating element for such (passive) tilting.

As a result, the multi-rotor aircraft of this disclosure can offer an increased cruising speed (i.e., the speed in the tilted or forward direction) than the prior art multi-rotor air vehicles.

Even when compared with the prior art tiltrotor air vehicles or lift-and-cruise air vehicles, the multi-rotor aircrafts of this disclosure can offer at least comparable or even higher cruising speed.

The second benefit which is corollary to the above first benefit is that the multi-rotor aircraft of this disclosure can move in a tilted (or forward) direction at a significantly higher cruising speed due to its inherent advantages.

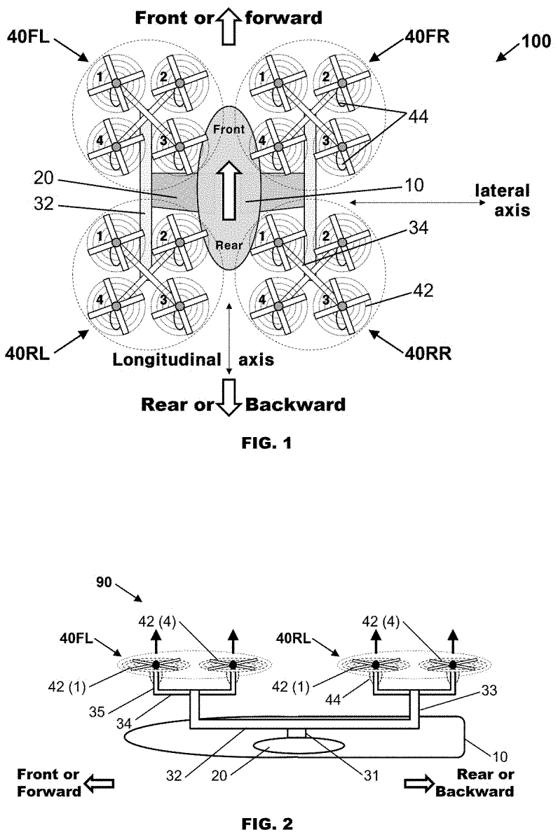

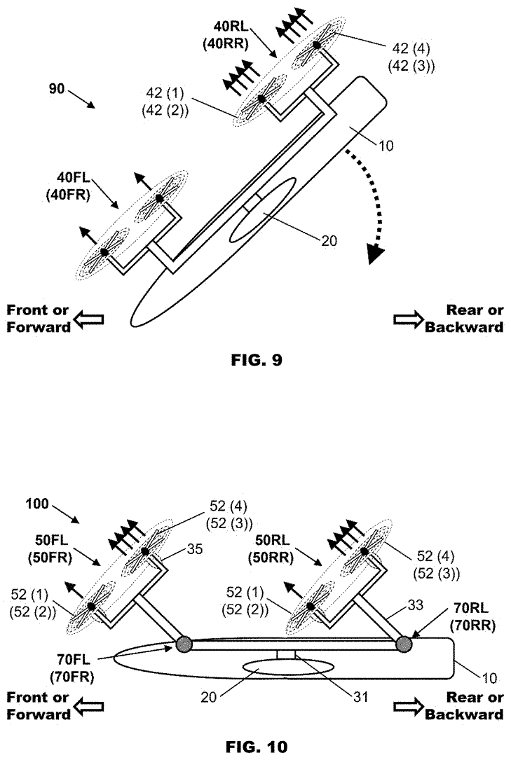

FIGS. 9 and 10 explain this benefit by comparing the tilting mechanism of the prior art multirotor air vehicle with that of the multi-rotor aircraft of this disclosure. It is noted that the prior art multi-rotor air vehicle (90) as well as the multi-rotor aircraft (100) of this disclosure exemplified in FIGS. 9 and 10 have the shape of a four-quadcopter which has been illustrated in FIG. 1.

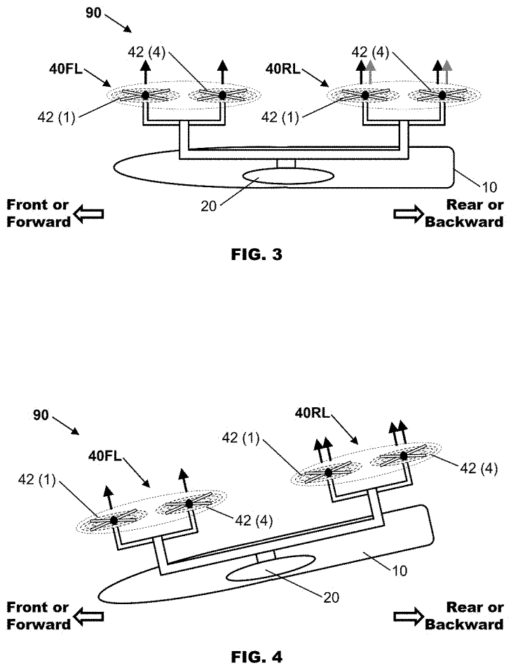

More particularly, FIG. 9 is a cross-sectional view of the conventional multi-rotor air vehicle (90) shown in FIGS. 1 to 4, where all four rotors (42 (1)) to (42 (4)) of each rear rotor group (40RL), (40RR) rotate at a higher rpm than the rotors of the front rotor groups (40FL), (40FR) to the point where the entire body (10) of the vehicle (90) is tilted, e.g., at 45° in a forward direction.

In contrary, FIG. 10 is a cross-sectional view of the multi-rotor aircraft of this disclosure illustrated in FIGS. 6 to 8, where two rear rotors (52 (3)), (52 (4)) of each of the four rotor groups (50FL), (50LR), (50FR), (50RR) rotate faster than two front rotors (51 (1)), (52 (1)) of the same rotor groups (50) to the point where all rotor groups (50FL), (50FR), (50RL), (50RR) and all tilting units (70FL), (70FR), (70RL), (70RR) are tilted at 45° in the forward direction.

It is noted that both of the multi-rotor aircraft (100) of this disclosure and the prior art multirotor air vehicle (90) can cruise at a speed which is proportional to a magnitude of the horizontal component of a vector sum of the lifts which are generated by the tilted rotors. It is also noted that an amplitude of the horizontal component of a vector sum of such lifts typically becomes greater as the rotors are tilted at greater angles.

Due to various reasons to be provided below, it is neither advantageous nor favorable that the prior art multi-rotor air vehicle has to cruise while the vehicle (90) has to be tilted at greater angles. In contrast, the horizontal component of the vector sum of the lifts generated by the multi-rotor aircraft (100) can be significantly increased than that of the lifts generated by the prior art multi-rotor air vehicles. It then follows that the multi-rotor aircraft (100) of this disclosure can cruise at a significantly higher speed than the prior art multi-rotor air vehicles.

For example, a pilot of the prior art multi-rotor air vehicle (90) may tilt the vehicle (90), and try to increase the horizontal component of the sum of the lifts and to attain a higher cruising speed. However, when the pilot tilts the vehicle (90) at a greater angle during cruising, almost entire body (10) of the vehicle (90) has also to be tilted at the greater angle.

At that tilting angle, the pilot would find it pretty difficult to operate or maneuver the vehicle (90). The passengers would also feel uncomfortable, and a prolonged flight in the tilted vehicle (90) may cause additional discomfort such as, e.g., nausea, air-sickness, vomiting, and the like. Therefore, it is not practical to tilt the prior art multi-rotor air vehicle (90) more than, e.g., 30° or so, As a result, most prior art multi-rotor air vehicles (90) have to cruise at a relatively slower speed.

In contrary, the multi-rotor aircraft (100) of this disclosure including at least one tiltable rotor group does not have to suffer from such shortcomings of the prior art multi-rotor air vehicle.

For example, the multi-rotor aircraft (100) can keep its body at least substantially horizontal during cruising, for the rotor groups (50) and the tilting units (70) are tilted during cruising, but the body (10) of the aircraft (100) does not have to be tilted during cruising, unless a pilot desires to do so. Therefore, the pilot would be able to readily maneuver the aircraft (100) at the greater tilting angle, which cannot be fulfilled using the prior art multi-rotor air vehicle (90). In addition, regardless of the tilting angle of the rotor groups (50) and the tilting units (70), the passenger can also enjoy the flight in a substantially horizontal cabin.

Accordingly, the pilot of the multi-rotor aircraft of this disclosure can tilt the rotor groups at any angle as he or she sees fit, and can move the aircrafts in the tilted or forward direction at the speed which is significantly higher than the speed attainable with the prior art multi-rotor air vehicle (90).

The third benefit which is also corollary to the first benefit is that the multi-rotor aircraft (100) of this disclosure can cruise at a significantly higher speed due to, e.g., a reduced drag or air resistance to flight.

For cruising, the prior art multi-rotor air vehicle (90) has to tilt its body (10), wings (20), and the like. As a result, the prior art vehicle (90) has to cruise while fighting against increased drag or resistance. To make matters worse, such drag or resistance would increase as the prior art vehicle (90) is tilted more at the greater angle. Accordingly, the prior art multi-rotor air vehicle (90) cannot easily attain a suitable cruising speed, a reasonable flight distance, and the like.

However, the multi-rotor aircraft (100) of this disclosure can readily keep its body and its wings at least substantially horizontal while cruising, regardless of the tilting angles. Because the multi-rotor aircraft (100) can fly against the minimum drag or resistance to flight, the aircraft (100) can cruise at a significantly higher cruising speed, over a greater flight distance, or the like.

The fourth benefit is that the multi-rotor aircraft (100) of this disclosure can cruise at a significantly higher speed due to minimum waste of the lifts in reacting against the torque during cruising.

Referring to FIG. 9, the prior art multi-rotor air vehicle (90) tilts its body (10) and its wings (20) during cruising. But such tilting generates a torque which acts around a center of mass of the vehicle (90) and which tends to rotate the entire vehicle (90) in a clockwise direction, as shown by the dotted arrow.

To offset such a torque, the vehicle (90) has to waste at least a portion of the horizontal component of a vector sum of the lifts generated by the rotor groups (40). Because the prior art vehicle (90) cannot fully use the horizontal component of the vector sum of the lifts, the prior art multi-rotor air vehicle (90) cannot easily attain a suitable cruising speed, a reasonable flight distance, and the like.

In contrary, the multi-rotor aircraft (100) can keep its body at least substantially horizontal during cruising and does not usually generate any substantial torque. Thus, the aircraft (100) can efficiently use the horizontal component of the vector sum of the lifts, and can cruise at a significantly higher speed, and over a greater flight distance.

The fifth benefit is that the multi-rotor aircraft (100) of this disclosure can make sharper turns (e.g., a small turning radius) than the prior art multi-rotor air vehicle (90), In addition, the aircraft (100) may even perform a yaw rotation in a clockwise or counterclockwise direction.

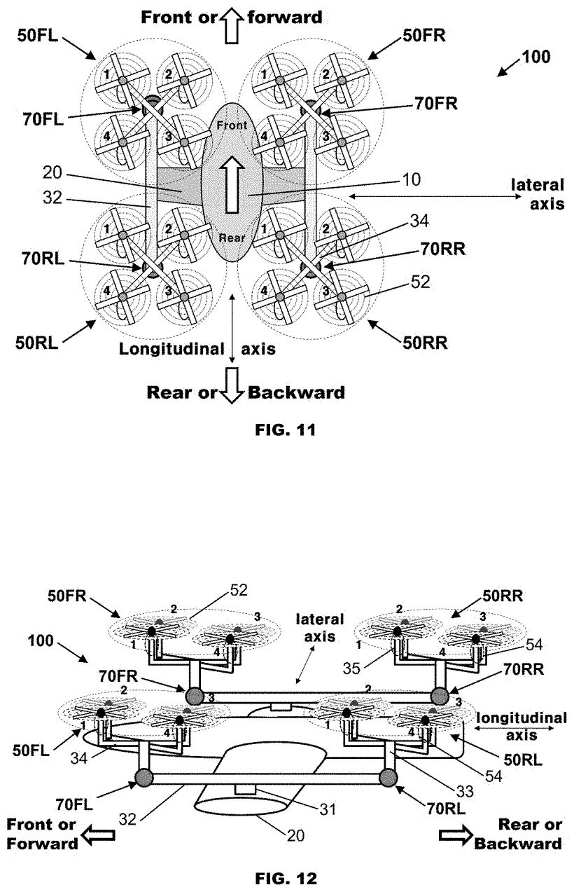

FIGS. 11 to 13 explain this benefit with an exemplary four-quadcopter-type multi-rotor aircraft (100).

FIG. 11 is a top view of an exemplary multi-rotor aircraft (100) which includes four rotor groups such as, e.g., a front-left rotor group (50FL), a rear-left rotor group (50RL), a front-right rotor group (50FR), and a rear-right rotor group (50RR). FIG. 12 is a perspective view of the multi-rotor aircraft shown in FIG. 11. It is noted in both figures that each rotor group (50) is indirectly coupled to its own tilting unit (70FL), (70FR), (70RL), (70RR).

Each rotor group (50) includes four identical rotors (52), where the rotors (52) may be numbered in a clockwise direction as a first rotor (52 (1)), a second rotor (52 (2)), a third rotor (52 (3)), and a fourth rotor (52 (4)). In this configuration, the first and second rotors (52 (1)), (52 (2)) may correspond to the front rotors of such rotor groups (50), and the third and fourth rotors (52 (3)), (52 (4)) may correspond to the rear rotors of such rotor groups (50). In addition, each rotor (52) is rotated or driven by its own electric rotor motor (54).

The aircraft (100) also includes four tilting units (70) such as, e.g., a front-left tilting unit (70FL), a front-right tilting unit (70FR), a rear-left tilting unit (70RL), and a rear-right tilting unit (70RR). Each tilting unit (70FL), (70RL), (70FR), (70RR) is configured to provide at least one degree of freedom to each rotor group (50FL), (50RL), (50FR), (50RR), respectively. Therefore, when a certain tilting unit (70) is tilted in a tilted direction, a corresponding rotor group (50) attached thereto is also tilted in the same direction.

In the first example of this fifth benefit, the multi-rotor aircraft (100) of this disclosure may move in a forward direction by performing various operations. For example, when there are no external disturbances, the aircraft (100) may increase the lifts generated by the rear rotors (52 (3)), (52 (4)) of each rotor group (50FL), (50FR), (50RL), (50RR), while maintaining or decreasing the lifts generated by the front rotors (52 (1)), (52 (2)) of each rotor group (50FL), (50FR), (50RL), (50RR). In this example, each rear rotor (52 (3)), (52 (4)) may generate the same lift, and each front rotor (52 (1)), (52 (2)) may generate the same lift as well.

In the second example of this fifth benefit, the multi-rotor aircraft (100) may move in a backward direction by performing various operations, e.g., the operations opposite to those of the first example. When there are no external disturbances, the aircraft (100) may increase the lifts generated by the front rotors (52 (1)), (52 (2)) of each rotor group (50), while maintaining or decreasing the lifts generated by the rear rotors (52 (3)), (52 (4)) of the rotor groups (50). In this example, each front rotor (52 (1)), (52 (2)) may generate the same lift, and each rear rotor (52 (3)), (52 (4)) may generate the same lift as well.

In the third example of this fifth benefit, the multi-rotor aircraft (100) may move to a lateral and right direction by performing various operations. For example, when there are no external disturbances, the aircraft (100) may increase the lifts generated by the left rotors (52 (1)), (52 (4)) of each rotor group (50), while maintaining or decreasing the lifts generated by the right rotors (52 (2)), (52 (3)) of the rotor groups (50). Each left rotor (52 (1)), (52 (4)) may generate the same lift, and each right rotor (52 (2)), (52 (3)) may generate the same lift as well.

In the fourth example of this fifth benefit, the multi-rotor aircraft (100) may move to a lateral and left direction by performing various operations, e.g., the operations opposite to those of the third example. For example, when there are no external disturbances, the aircraft (100) may increase the lifts generated by the right rotors (52 (2)), (52 (3)) of each rotor group (50), while maintaining or decreasing the lifts generated by the left rotors (52 (1)), (52 (4)) of the rotor groups (50). Each left rotor (52 (1)), (52 (4)) may generate the same lift, and each right rotor (52 (2)), (52 (3)) may generate the same lift as well.

As described above, the aircraft (100) in the above first to fourth examples may manipulate the rpms of the rotors (52) and increase (or decrease) the lift generated by each rotor (52) simply by varying the rpms of the rotors (52) depending on whether or not the propellers of the rotors (52) have the same or different shapes, sizes, or pitches.

When the external disturbances affect the lifts generated by the rotors (52) and rotor groups (50) to some extent in the above first to fourth examples, the aircraft (100) may vary the lifts generated by the rotors (52) and compensate the effects from the disturbances.

For example, when the wind blows in a certain angle with respect to the longitudinal axis of the aircraft (100), the aircraft (100) estimates a net vector of such disturbances and manipulate the lifts generated by the rotors (52) in such a way to compensate the net disturbances vector. Therefore, in case when the net disturbances vector is in a direction which may slow down, pitch, or roll the body (10) of the aircraft, the aircraft (100) may increase the lifts such that a net vector sum of the lifts may not only move the aircraft (100) in a desired direction at a desired speed and altitude, but also oppose (or cancel) the net disturbances vector.

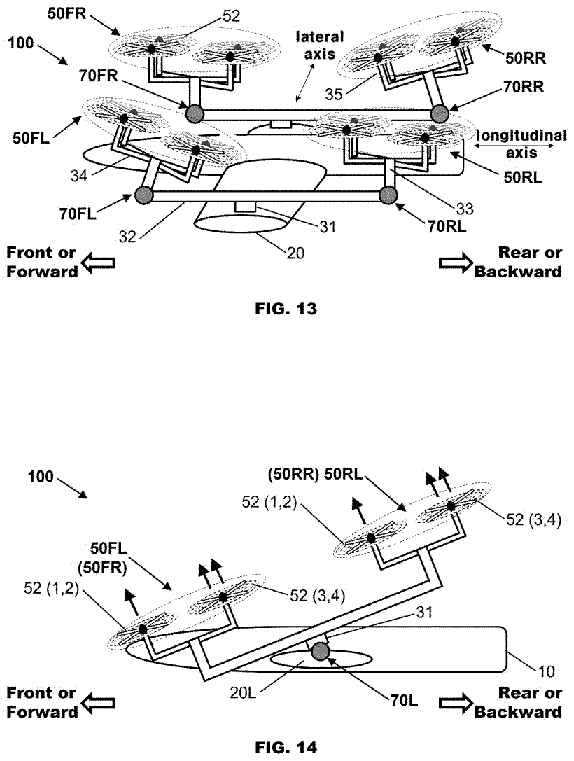

In the fifth example of this fifth benefit, the multi-rotor aircraft (100) of this disclosure may perform a yaw rotation by tilting, e.g., at least one rotor group, two opposing rotor groups, two neighboring rotor groups, three rotor groups, or all rotor groups. FIG. 13 is a perspective view of the multi-rotor aircraft (100) of FIGS. 11 and 12 which is performing a yaw rotation.

In particular, during hovering, the multi-rotor aircraft (100) may tilt a first set of two opposing rotor groups so that, e.g., the front-left rotor group (50FL) and rear-right rotor group (50RR) generate lifts, where a vector sum of the lifts includes a non-zero horizontal component.

The horizontal component of the vector sum of the lifts generates a torque which rotates the aircraft (100) around a center of the aircraft (100) in a clockwise or counter-clockwise direction. As a result, the multi-rotor aircraft (100) can perform a yaw rotation.

The aircraft (100) may instead tilt a second set of two opposing rotor groups in such a way 40 that the front-right rotor group (50FR) and rear-left rotor group (50RL) generate lifts, where a vector sum of the lifts includes a non-zero horizontal component. Alternatively, the aircraft (100) may tilt all four rotor groups (50) in order to perform the yaw rotation as well. As long as tilting of at least one rotor group (50) generates such horizontal components, the aircraft (100) may perform the yaw rotation in a clockwise or counter-clockwise direction.

In the sixth example of this fifth benefit, the multi-rotor aircraft (100) of this disclosure may perform a turning operation (i.e., making turns) at a higher turning speed along a curved path having a minimum turning radius, e.g., by tilting at least one rotor group, at least two opposing rotor groups, at least two neighboring rotor groups, at least three rotor groups, or all rotor groups.

More particularly, during cruising, the aircraft (100) can manipulate the rotors (52) of the rotor groups (50) similar to the manipulation for performing the yaw rotation. However, because the cruising aircraft (100) inevitably has an inertia, the aircraft (100) cannot perform the yaw rotation. Rather, the aircraft (100) can make the turn in the clockwise or counter-clockwise direction, while minimizing the turning radius.

It is appreciated in the fifth and sixth examples that the second and fourth rotors (52 (2)), (52 (4)) of the quadcopter-type aircraft (100) rotate in the counter-clockwise direction, while the first and third rotors (52 (1)), (52 (3)) rotate in the clockwise direction. When desirable, the rotation directions can be opposite or a pair of adjacent rotors may rotate in the clockwise direction, while another pair of adjacent rotors may rotate in the counter-clockwise direction.

The sixth benefit is that the multi-rotor aircraft (100) can make a quick stop. As described above, the multi-rotor aircraft (100) can tilt its rotor groups (50) at greater angles and, accordingly, can maximize the horizontal component of the sum of the lifts which are generated by the rotor groups (50). It then follows that, by tilting the rotor groups (50) to generate the lifts a vector sum of which has the horizontal component pointing the backward direction, the multi-rotor aircraft (100) can make a stop in a reduced period of time.

The seventh benefit is that the multi-rotor aircraft (100) can provide enhanced stability against external disturbances such as, e.g., strong winds. For example, because the multirotor aircraft (100) can easily and precisely manipulate the tilted directions or the tilting angles of the tiltable rotor groups, the aircraft (100) can more readily maintain stability during cruising or making turns against the strong wind.

The eighth benefit is that at least a portion of the weight load of the multi-rotor aircraft (100) of this disclosure can be borne or shared by various load sharing units and, as a result, the tilting units (70) can be tilted without having to bear the entire weight load of the aircraft (100). In addition, wear and tear of the tilting units (70) caused by such weight load can be minimized. Further details of such load sharing units are to be provided below.

The ninth benefit is that the multi-rotor aircraft (100) of this disclosure may include various tilting units each of which may have the same or different shape, size, type, or the like. In addition, each passively tiltable rotor group of the multi-rotor aircraft (100) may include a single or multiple tilting units of the same or different types such as, e.g., [1] at least one mechanical joint-type tilting unit, [2] at least one path-dependent tilting unit, [3] at least one bearing-type tilting unit, [4] a combination of at least two of [1] to [3], or the like.

### 1-3. Positioning Tilting Units

In the third exemplary embodiment of the first aspect of this disclosure, the multi-rotor aircraft can include at least one tilting unit in various locations on or around its wing or body.

The multi-rotor aircraft of this disclosure may incorporate any number of rotor groups, any number of tilting units, or the like. The multi-rotor aircraft may also allocate any number of rotor groups to each tilting unit. Accordingly, each tilting unit may tilt the same (or different) number of rotor groups, may tilt the same (or different) number of rotors, or the like.

In general, a control algorithm can be more complex (or simpler) as the multi-rotor aircraft may include more (or fewer) tilting units. However, incorporating more tilting units may allow more agile or precise control of various operations performed by the aircraft. Thus, a designer or a manufacturer of the aircraft may select the number of the rotor groups and the matching number of the tilting units as he or she sees fit, depending on his or her design objectives or design considerations. Therefore, the multi-rotor aircraft of this disclosure can include a suitable number of tilting units which may be incorporated into one or multiple strategic locations on or around such aircrafts.

Followings are several exemplary embodiments regarding different dispositions of the tilting units. It is noted in the following embodiments that the multi-rotor aircrafts have the configuration of four-quadcopters including 16 identical rotors as have been exemplified in FIGS. 6 to 8, FIG. 10, and FIGS. 11 to 13. In addition, each aircraft includes four tilting units such as, e.g., a front-left tilting unit (70FL), a front-right tilting unit (70FR), a rear-left tilting unit (70RL), and a rear-right tilting unit (70RR).

In the first example of this third exemplary embodiment, two tilting units can be installed to tilt multiple (e.g., 16) rotor groups, where one tilting unit is designated to tilt all rotor groups positioned on one side of the aircraft, and where one side may be, e.g., a left side of the aircraft, its right side, its front side, its rear side, or the like.

FIG. 14 is a cross-sectional view of a multi-rotor aircraft (100) which includes a pair of tilting units which are symmetrically installed with respect to a longitudinal axis of the aircraft (100), where the longitudinal axis connects a front and a rear of the body (10) of the aircraft (100).

For example, a left tilting unit (70L) is installed at a junction of a left wing (20L) and a first left vertical frame (31), while a right tilting unit (not shown in the figure) is installed at a junction of a right wing and a first right vertical frame. As a result, when the left tilting unit (70L) is tilted in one direction, all rotors (52) of the front-left rotor group (50FL) and rear-left rotor group (50RL) are tilted in the same direction.

Compared with the multi-rotor aircraft of FIGS. 6 to 8, and FIGS. 10 to 13, the multi-rotor aircraft (100) of FIG. 14 includes a smaller number of tilting units (70). Therefore, the aircraft (100) can manipulate the rotor groups (50) and the tilting units (70) while using a relatively simpler control algorithm or unit. But the multi-rotor aircraft (100) may have less maneuvering agility or less ability in coping with external disturbances.

In the second example of the third exemplary embodiment, a tilting unit may be installed closer to rotors of a tiltable rotor group and tilt the rotors of the tiltable rotor group.

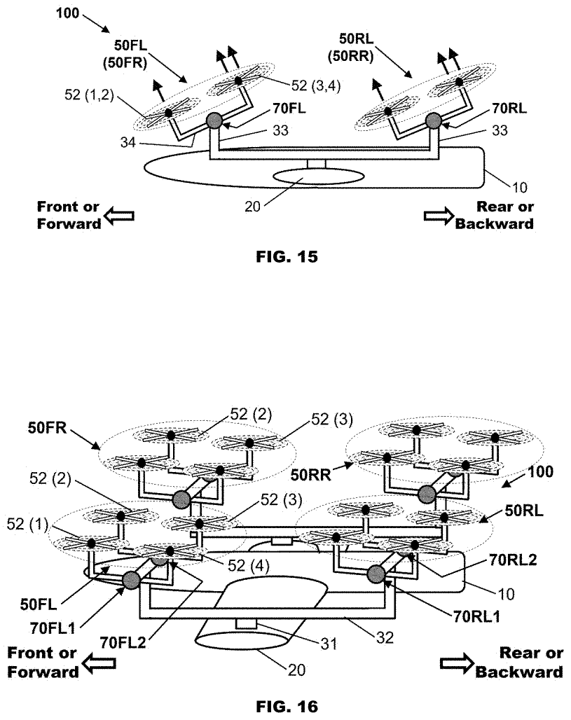

FIG. 15 is a cross-sectional view of another exemplary multi-rotor aircraft which includes a pair of tilting units on a left side of the aircraft, and two additional tilting units (not shown in the figure) on its right side.

For example, a front-left tilting unit (70FL) is installed at a junction of a second vertical frame (33) and a second horizontal frame (34) of a front-left rotor group (50FL), while a rear-left tilting unit (70RL) is installed at a junction of a second vertical frame (33) and a second horizontal frame (34) of a rear-left rotor group (50RL). Similarly, two additional tilting units (not shown in the figure) may be installed in the similar junctions of a front-right rotor group (50FR) and a rear-right rotor group (50RR).

Compared with the multi-rotor aircraft of FIGS. 6 to 8, and FIGS. 10 to 13, the multi-rotor aircraft (100) of FIG. 15 includes the same number of tilting units (70). Thus, the aircraft (100) can provide similar maneuvering agility as the multi-rotor aircraft of FIGS. 6 to 8 and FIGS. 10 to 13.

In the third example of the third exemplary embodiment, a greater number of tilting unit are installed so that each tilting unit can tilt a smaller number of rotors such as, e.g., a pair of rotors of a tiltable rotor groups.

FIG. 16 is a perspective view of another exemplary multi-rotor aircraft which includes four tilting units on its left side, and four more tilting units on its right side.

More particularly, the aircraft (100) includes four tilting units (70FL1), (70FL2), (70RL1), (70RL2) on its left side, and four more tilting units on its right side. For example, a front-left rotor group (50FL) of the aircraft (100) includes four rotors (52 (1)), (52 (2)), (52 (3)), (52 (4)), where the first front-left tilting unit (70FL1) is coupled to and tilts two rotors (52 (1)), (52 (4)) on the left, and the second front-left tilting unit (70FL2) is coupled to and tilts two rotors (52 (2)), (52 (3)) on the right. In other words, each of two tilting units (70FL1), (70FL2) can tilt two rotors of the front-left rotor group (70FL).

Similarly, each of the first rear-left tilting unit (70RL1) and the second rear-left tilting unit (70RL2) can tilt two rotors of the rear-left rotor group (50RL). The same applies to the right side of the aircraft (100) such that each of a first front-right tilting unit and a second front-right tilting unit can tilt two rotors of the front-right rotor group (50FR), while each of a first rear-right tilting unit and a second rear-right tilting unit can tilt two rotors of the rear-right rotor group (50RR).

Other things being equal, the configuration of this third example of the third embodiment includes the largest number of tilting units and, accordingly, the aircraft may require a more complicated control algorithm. However, such a configuration can significantly enhance the maneuvering agility, stability, and other various benefits which have been illustrated above in this first exemplary aspect of this disclosure.

In the fourth example of the third exemplary embodiment, the multi-rotor aircraft may include N tilting units such that [1] each tilting unit can tilt at least two and the same number of rotors, [2] at least one of N tilting units can tilt a preset number of rotors, but each of the rest of N tilting units can tilt a different number of rotors, or the like.

As described above, a designer or a manufacturer may incorporate any number of tilting units into the multi-rotor aircraft, where each tilting unit may also be arranged to tilt any number of rotors. The designer or manufacturer may select such numbers as long as the resulting multi-rotor aircraft can offer at least some of such benefits illustrated in this first exemplary aspect of this disclosure

### 1-4. Variations or Modifications

In the fourth exemplary embodiment of the first aspect of this disclosure, configurations of various multi-rotor aircrafts or various methods of constructing or operating the aircrafts may be modified in various ways. Followings are several selected exemplary variations or modifications of such configurations or methods.

In the first example of this fourth exemplary embodiment, the multi-rotor aircraft of this disclosure can include at least one tilting unit installed in at least one location on or around its wing or body which is different from those exemplified hereinabove.

In the second example of this fourth exemplary embodiment, when the multi-rotor aircraft includes multiple rotor groups, [1] all rotor groups may be coupled to at least one tilting unit such that all rotor groups can be tilted by the tilting unit(s), or [2] only some but not all rotor groups may be coupled to the tilting units such that some rotor groups can be tilted by the tilting unit(s), while the tilting unit(s) cannot tilt the rest of the rotor groups.

In the third example of this fourth exemplary embodiment related to the above second example, the rotor groups can have different orientations when the rotor motors are turned off and, therefore, the rotors do not rotate. As used herein, this state is referred to as a “turned-off state.”

For example, all rotors of a certain rotor group in the turned-off state may be oriented [1] upward (or in a vertical direction), [2] forward (or in a horizontal direction), or [3] in a slanted direction which is neither the vertical direction nor the horizontal direction. Similarly, at least one rotor of the rotor group may be oriented in one of the directions of [1] to [3], but at least another rotor of the same rotor group may be oriented in another of the directions of [1] to [3].

In another example, all rotor groups in the turned-off state may be oriented [1] upward (or in a vertical direction), [2] forward (or in a horizontal direction), or [3] in a slanted direction which is neither the vertical direction nor the horizontal direction. Similarly, at least one rotor group may be oriented in one of the directions of [1] to [3], but at least another rotor group may be oriented in another of the directions of [1] to [3].

In the fourth example of this fourth exemplary embodiment, at least one rotor group of the multi-rotor aircraft may include, [1] two rotors of the same or different shapes, sizes or pitches, [2] three rotors of the same or different shapes, sizes or pitches, [4] four rotors of the same or different shapes, sizes or pitches, [4] five rotors of the same or different shapes, sizes or pitches, [5] six rotors of the same or different shapes, sizes or pitches, or the like.

In the fifth example of this fourth exemplary embodiment, at least one rotor group of the multi-rotor aircraft may include, [1] two rotor motors of the same or different power, torque or maximum rpm, [2] three rotor motors of the same or different power, torque or maximum rpm, [4] four rotor motors of the same or different power, torque or maximum rpm, [4] five rotor motors of the same or different power, torque or maximum rpm, [5] six rotor motors of the same or different power, torque or maximum rpm, or the like.

In the sixth example of this fourth exemplary embodiment, when multiple rotor groups of the multi-rotor aircraft are coupled to multiple tilting units, such tilting units [1] may have the same or different shapes, sizes or types, [2] may tilt the rotor groups in the same or different tilted directions, [3] may tilt the rotor groups in the same or different tilting ranges (of angles), or the like.

More particularly, each tilting unit may be tilted in a certain tilting range of (angles), where examples of such tilting ranges may include, but not limited to, e.g., 15°, 30°, 45°, 60°, 75°, 90°, 105°, 120°, 135°, 150°, 165°, 180°, 195°, 210°, 225°, 240°, 255°, 270°, 285°, 300°, 315°, 330°, 345°, or 360°.

In addition, the tilting unit may be tilted [1] in the forward direction, [2] in the backward direction, [3] in another direction which is neither the forward nor backward direction, [4] in at least two orthogonal directions, [5] in at least two non-orthogonal directions, [6] in at least three directions two of which may be orthogonal to each other, [7] in at least three directions two of which may not be orthogonal to each other, or the like.

In the seventh example of this fourth exemplary embodiment, a body of the multi-rotor aircraft may have a configuration or the tilting unit may have a configuration (or installed in strategic positions) in such a way that the tilting unit may be tilted in a preset tilting range in at least one preset directions.

In other words, as long as its configuration and installation location may not impede intended operations of the aircraft, its tilting unit may be shaped or sized to guarantee that the tilting unit can be tilted within a preset tilting range, in at least one preset direction, or the like.

In the eighth example of this fourth exemplary embodiment, the rotor group of the passively tiltable rotor group can be tilted along with the tilting unit, when a first rotor and a second rotor of a certain rotor group generate a first lift and a second lift, respectively, and when a vector sum of such first and second lifts has a non-zero horizontal component.

Accordingly, one way of accomplishing this is to rotate the first rotor(s) faster than the second rotor(s). However, when the first rotor is bigger than the second rotor, the first rotor can be rotated at a first rpm which may be the same as or lower than a second rpm of the second rotor. Of course, when the first rotor is smaller than the second rotor, the first rotor may have to be rotated at an rpm which is significantly higher than the rpm of the second rotor.

That is, the magnitude of the lift generated by a rotor can be determined not only by the rpm of the rotor but also by other characteristics such as, e.g., a size of a propeller, a pitch of the propeller, or the like. In other words, a rotor which rotates at a lower rpm can generate a lift which can be greater than another lift generated by another rotor which rotates at a higher rpm.

In other words, when a rotor rotating at a first rpm generates a lift of a first amplitude, the same rotor can be modified to generate [1] the same lift at a higher rpm, or [2] the same lift at a lower rpm, e.g., by changing a shape of the rotor, its size, its pitch, or the like. For ease of illustration, however, this disclosure assumes that a rotor rotating at a higher rpm generates a lift of a greater amplitude, unless otherwise specified.

It is noted that one feature of a certain embodiment, example or objective of this first aspect of this disclosure [1] may be applied to, [2] may be incorporated into, [3] may replace, [4] may be replaced by, or [5] may be combined, with a corresponding feature of another embodiment, example or objective of this first aspect, as long as such application, incorporation, replacement, or combination does not contradict each other.

It is also noted that one feature of this first aspect of this disclosure [1] may be applied to, [2]may be incorporated into, [3] may replace, [4] may be replaced by, or [5] may be combined with, a corresponding feature of another aspect of this disclosure, as long as such application, incorporation, replacement, or combination does not contradict each other.

### 2. Second Exemplary Aspect—a Tilting Unit

The second exemplary aspect of this disclosure relates to various tilting units capable of tilting at least one rotor group coupled thereto. In general, the tilting unit may be directly or indirectly coupled to at least one rotor group at its one arm (or end) so that the rotor group can be tilted along with the tilting unit.

Accordingly, the rotor group can be tilted within a preset tilting range of the tilting unit and in at least one preset tilting direction of the tilting unit. Various conventional articles or their variations may be incorporated into various tilting units of the multi-rotor aircraft of this disclosure.

Throughout this disclosure, a “rotor group” refers to a group of at least two rotors having the same or different shapes, sizes or pitches, and a “(passively) tiltable rotor group” means a combination of at least one rotor group and at least one tilting unit which is directly or indirectly coupled to that rotor group. It then follows that whether or not a certain rotor group may be referred to as a tiltable rotor group depends on the presence or absence of the tilting unit coupled thereto.

### 2-1. Mechanical Joint-Type Tilting Unit

In the first exemplary embodiment of the second aspect of this disclosure, a multi-rotor aircraft of this disclosure may employ at least one “mechanical joint-type tilting unit,” where a mechanical joint-type tilting unit refers to an assembly of a first arm (or end), a second arm (or end), and a mechanical joint capable of providing at least one degree of freedom (e.g., rotation or revolution) to one of such first and second arms.

In the first example of this first exemplary embodiment, a mechanical joint-type tilting unit may include at least one prior art joint as its mechanical joint, where examples of such prior art joints may include, but not limited to, a ball-socket joint, a bolted joint, a condyloid joint, a cotter-pin, an ellipsoidal joint, a ginglymus joint, a gliding joint, a hinge joint, a knuckle joint, a pin joint, a pivot joint, a plane joint, a prismatic joint, a revolute joint, a saddle joint, a screw joint, a slider joint, a spherical joint, a turnbuckle, a universal joint, and the like.

In the second example of this first exemplary embodiment, the mechanical joint-type tilting unit in the above paragraph can provide one, two, three or even greater degrees of freedom to the rotor groups which is directly or indirectly coupled to such tilting units.

It is noted that the mechanical joint-type tilting unit may include more than two arms, multiple mechanical joints or the like, where such joints may be coupled to each other or to one of such arms [1] in a series mode, [2] in a parallel mode, or [3] in a hybrid mode which includes the features of both of the series and parallel modes.

Similarly, a single tiltable rotor group may include multiple tilting units which may be coupled to each other or to one of such arms [1] in a series mode, [2] in a parallel mode, or [3] in a hybrid mode.

For example, at least two mechanical joint-type tilting units can be used together to provide a greater degrees of freedom. In one example, two hinge joint-type tilting units may be coupled to each other so that the assembly of two tilting units provides two degrees of freedom.

In another example, two mechanical joint-type tilting units of different types (e.g., the hinge joint-type and slider joint-type tilting units) may be coupled to each other in a series mode, in a parallel mode or in a hybrid mode, and provide a greater degree of freedom.

Conversely, the mechanical joint included in the mechanical joint-type tilting unit can be modified or an external structure can be implemented near the joint such that the joint can only provide a less degrees of freedom than the joint can provide without any confinement or obstruction.

For example, the ball-socket joint-type tilting unit which provides three degrees of freedom such as roll, pitch, and yaw may be modified to provide only a single degree of freedom, e.g., [1] by replacing a spherical ball of the joint with a ball which has two parallel flat surfaces on its sides, thereby allowing only pitch, with no roll or yaw, [2] by installing a con fining object on one side of a saddle joint such that the joint can only provide only one of pitch and yaw, or the like.

In the third example of this first exemplary embodiment, a designer or a manufacturer of a multi-rotor aircraft can use one or multiple mechanical joint-type tilting units of different types, while maximizing various benefits which can be offered by such tilting units.

Because the mechanical joints are generally available in different shapes and sizes, a designer or manufacturer can easily find a suitable joint, incorporate the joint into the mechanical joint-type tilting unit, and install such a tilting unit in a certain space of the aircraft.

It is appreciated that the mechanical joint-type tilting unit has to operate under severe tension, for a limited number of tilting units have to tilt many rotor groups while being pulled downward by an entire weight load of the aircraft. Therefore, a designer or a manufacturer may incorporate the load sharing units of this disclosure details of which are provided below.

### 2-2. Path-Dependent Tilting Unit

In the second exemplary embodiment of the second aspect of this disclosure, a multi-rotor aircraft may employ at least one “path-dependent tilting unit,” where the “path-dependent tilting unit” refers to an assembly of at least one curvilinear path and at least one roller which may be shaped, sized, or configured to travel (e.g., translate, rotate, or the like) along the path.

By mechanically coupling a rotor group to the roller, the rotor group can be tilted in a forward, backward or slanted direction, as the roller travels along a two- or three-dimensional curvilinear path. By manipulating the shape, length or orientation of the path, a designer or a manufacturer can design a custom-made tilting unit which may best suit certain design objectives of the multi-rotor aircraft.

It is appreciated that examples of such design objectives or design considerations may include, but not limited to, a desired maximum cruising speed, a desired maximum travel distance, a desired maximum or minimum turning radius, availability of a surface on which the tilting unit can be installed, availability of a space in which the tilting unit can be installed, or the like.

It is also noted that the path-dependent tilting unit does not have to include any mechanical joint. In this aspect, a (passively) tiltable rotor group of this Section 2-2 may be deemed to include a rotor group, at least one path, and at least one roller.

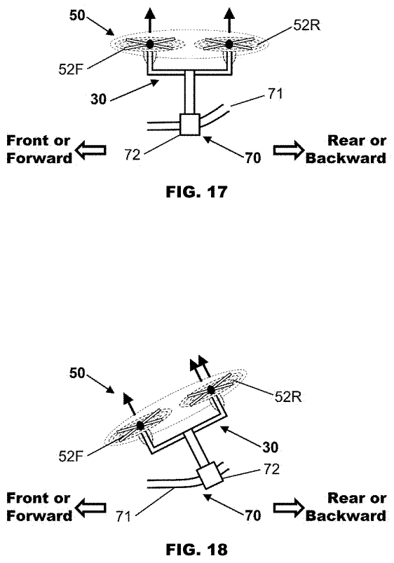

FIG. 17 is a cross-sectional view of an exemplary path-dependent tilting unit (70) which is coupled to a rotor group (50) of a multi-rotor aircraft during hovering, while FIG. 18 is a cross-sectional view of the path-dependent tilting unit which is shown in FIG. 17 and which is tilted along its path (71) with the rotor group (50).

The path-dependent tilting unit (70) includes at least one path (71) and at least one roller (72) which is shaped and sized to translate along or to rotate around the path (71). A rotor group (50) is mechanically coupled to the roller (72) via at least one frame (30). As a result, the rotor group (50) can travel with the roller (72) along the path (71), and can be tilted along with the roller (72).

More particularly, as a rear rotor (52R) generates the lift of which an amplitude is greater than that of the lift generated by a front rotor (52F) as exemplified in FIG. 18, the rotor group (50) begins to be tilted to the upward-left direction of the figure. A difference in such lifts generates the (net) lifts, where a vertical component of a vector sum of such lifts points upwardly and, as a result, the roller (72) can translate along the curved path (71), thereby tilting the rotor group (50) coupled to the roller (72) in this tilting direction as well.

The assembly of the path (71) and the roller (72) can be constructed in various configurations. In one example, the path (71) may be shaped as a curved rod, while the roller (72) may be shaped and sized as a ring which may be disposed around the path (71). As a result, the roller (72) may be able to travel along or rotate around the path (71).

In another example, the path (71) may be shaped as a conventional rail, while the roller (72) may be shaped and sized to be able to travel along the path (71) while maintaining mechanical coupling with the path (71). Other configurations may also be used as long as the roller translates along (or rotates about) the path, while not derailing from the path during such translation (or rotation).

Various path-dependent tilting units offer the benefit of allowing a designer or a manufacturer of the multi-rotor aircraft to custom-make the tilting unit which may readily fit into a confined space of the aircraft.

Depending on the detailed configuration of such tilting units or mechanical properties of the materials used in making such tilting units, the path-dependent tilting units may be configured to exhibit enhanced mechanical strength, durability, stability, and the like.

### 2-3. Bearing-Type Tilting Unit

Various articles which include bearings can also be used or included in the tilting units of this disclosure. Although the bearings can be applied in numerous configurations, followings illustrate several exemplary configurations which incorporate a prior art “rod-end bearing” or a prior art “turn-table” to the tilting units of this disclosure.

In the third exemplary embodiment of the second aspect of this disclosure, a multi-rotor aircraft of this disclosure may employ at least one tilting unit which utilizes multiple prior art bearings so that a moving element of the tilting unit may rotate with respect to a stationary element of the tilting unit.

In the first example of this third exemplary embodiment, a multi-rotor aircraft may employ at least one “rod-end bearing-type tilting unit” or simply “rod-end tilting unit,” where the rod-end tilting unit may typically include a prior art rod-end ball joint, rod-end-bearing, a helm joint or a rose joint. The rod-end tilting unit can maintain a fixed contact with at least one rotor group, while allowing rotation of the rotor group in one, two or three directions.

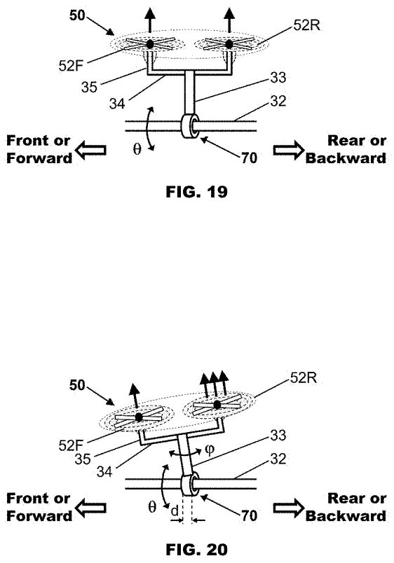

FIG. 19 is a cross-sectional view of an exemplary rod-end tilting unit (70) which is coupled to a rotor group (50) of a multi-rotor aircraft during hovering, while FIG. 20 is a cross-sectional view of the same multi-rotor aircraft with its rod-end tilting unit (70) tilted in a tilted direction for cruising, while the rotor group (50) which is coupled to the tilting unit (70) is also tilted in the same tilting (or forward) direction.

In FIGS. 19 and 20, the rod-end tilting unit (70) is fixedly coupled to a second vertical frame (33) on its exterior, and rotatably coupled to a first horizontal frame (32) through its opening.

Therefore, a rotor group (50) which is fixedly coupled to an exterior of the tilting unit (70) can also rotate or tilt about the first horizontal frame (32) in, e.g., a θ direction of the spherical coordinate as the rear rotors (52R) generate the greater lifts than the front rotors (52F).

Depending upon its shape, size or detailed structure and as illustrated in FIG. 20, the rod-end tilting unit (70) can allow the rotor group (50) to rotate or tilt in another direction such as, e.g., the φ direction of the spherical coordinate.

It is appreciated that the rod-end tilting unit capable of providing two degrees of freedom preferably has a small width, as denoted by “d” in FIG. 20. In contrast, the rod-end tilting unit tends to provide a single degree of freedom as the rod-end tilting unit gets wider, although such a wider rod-end tilting unit can endure a greater weight load of the aircraft.

In addition, because the wider rod-end tilting unit includes the ball bearings which may be arranged in multiple rows or lines and which may distribute a weight load of the aircraft to a greater number of bearings, the wider configuration can decrease the problems of wear and tear of the bearings caused by a friction force attributed the weight load of the aircraft.

In the second example of this third exemplary embodiment, a multi-rotor aircraft may incorporate at least one “turn-table tilting unit,” where the “turn-table tilting unit” means a tilting unit which includes a prior art turn-table capable of allowing an outer planar element to rotate with respect to an inner planar element, where multiple spherical ball bearings may be inserted between the outer and inner elements. The “turn-table tilting unit” may also refer to different prior art objects capable of rotating at least one article attached to its top surface, its bottom surface, or its sides.

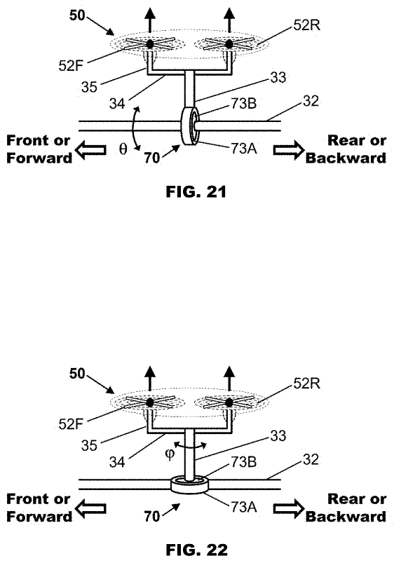

FIG. 21 is a cross-sectional view of an exemplary turn-table tilting unit (70) coupled to a rotor group (50) of a multi-rotor aircraft and allowing the rotor group (50) to be tilted in a first tilted direction, while FIG. 22 is a cross-sectional view of another exemplary turn-table tilting unit (70) which is vertically coupled to the rotor group (50) and which allows the rotor group (50) to be tilted in a second direction which is orthogonal to the first direction.

In the examples of FIGS. 21 and 22, a turn-table tilting unit (70) includes an outer element (73A) and an inner element (73B) which is rotatably positioned inside or on the outer element (73A). To facilitate easy rotation, the outer element (73A) typically includes multiple bearings along its inner periphery, and an external surface of the inner element (73B) rotates while abutting such bearings.

The turn-table tilting unit (70) may be installed in a horizontal arrangement such that a second vertical frame (33) fixedly couples with an exterior of the outer element (73A) of the tilting unit (70), and that a first horizontal frame (32) fixedly couples with the top and bottom surfaces of the disk-shaped inner element (73B). Accordingly, the turn-table tilting unit (70) can rotate or tilt about the first horizontal frame (32), e.g., in the θ direction of the spherical coordinate.

Alternatively, the turn-table tilting unit (70) may be installed in a vertical arrangement such that a first horizontal frame (32) fixedly couples with an exterior of the outer element (73A) of the tilting unit (70), and that a second vertical frame (33) fixedly couples with the top and bottom surfaces of the disk-shaped inner element (73B). Accordingly, the turn-table tilting unit (70) can rotate or tilt about the second vertical frame (33), e.g., in the φ direction of the spherical coordinate.

It is noted that an assembly of two turn-tables can be used as a tilting unit which can provide at least two degrees of freedom, where the first turn-table is installed in the horizontal arrangement but the second turn-table is installed in the vertical arrangement.

In addition, an assembly of one turn-table and one rod-end bearing can be used as the tilting unit, thereby providing multiple degrees of freedom to the rotor group attached thereto. For example, the turn-table of the tilting unit may allow the rotation in the θ direction of the spherical coordinate, while rod-end bearing of the same tilting unit may allow the rotation in the φ direction.

### 2-4. Variations or Modifications

The fourth exemplary embodiment of the second aspect of this disclosure relates to modifications or variations of the above configurations of the mechanical joint-type tilting units, path-dependent tilting units or bearing-type tilting units of the multi-rotor aircrafts, or relates to modifications or variations of the above methods of constructing, installing or using such various tilting units. Followings are some exemplary variations or modifications of such configurations or methods.

In the first example of this fourth exemplary embodiment, each joint included in the mechanical joint-type tilting units may be [1] replaced by a different joint, [2] used in conjunction with another joint of the same or different type, [3] replaced by the path and roller of the path-dependent tilting unit, or [4] replaced by the mobile and stationary elements of the bearing-type tilting units.

In addition, a first joint which provides multiple degrees of freedom can be replaced by a combination of a second joint and a third joint which together provide the same (or greater) number of degrees of freedom. Conversely, an assembly of two or more joints which together provide a certain number of degrees of freedom can be similarly replaced by another joint capable of providing a smaller number of degrees of freedom.

In the second example of this fourth exemplary embodiment, various tilting units can fixedly couple with various frames at the right angle or at a slanted (i.e., neither vertical nor horizontal) angle, depending upon detailed configurations of the wings or body of the multi-rotor aircraft, various design objectives or considerations, or the like.

For example, when a certain frame extends neither in a vertical direction nor in a horizontal direction and when the tilting unit has to couple with such a frame, various tilting units can be coupled to the frame at any angle as a designer or a manufacturer sees fit.

Alternatively, a designer or a manufacturer can bend an upper arm or a lower arm of the tilting unit at a certain angle such that the tilting unit may be disposed in an upright position when the tilting unit is coupled to the frame of the above paragraph.

In another alternative, a designer or a manufacturer can couple the joint to an upper arm or a lower arm of the tilting unit at a slanted angle. Accordingly, when the tilting unit is coupled to the frame of the above paragraph, the tilting unit may be disposed in an upright position.

In the third example of this fourth exemplary embodiment, the multi-rotor aircraft may include a tilting unit which is a combination of at least two of the above mechanical joint-type tilting unit, path-dependent tilting unit, bearing-type tilting unit, or the like. More particularly, a designer or a manufacturer may pick and choose and then combine suitable tilting units such that a certain rotor group can be tilted within a desired tilting range in a desired direction.

In doing so, a designer or a manufacturer may consider a maximum (or minimum) amplitude of the vector sum of the lifts which should be generated by the rotor group, a tilting range of the rotor group, a total weight load of the aircraft, a certain portion of the weight load which has to be supported or borne by the tilting unit or the rotor group, or the like.

In the fourth example of this fourth exemplary embodiment, the multi-rotor aircraft may incorporate different types of tilting units to tilt different rotor groups. For example, when the aircraft is mainly designed for intercity travel, an improved cruising speed and an extended flight distance may be the primary objectives. In this case, a majority of the tilting units of the aircraft may be chosen to provide a single degree of freedom, while only a minority of the tilting units may provide two or more degrees of freedom.

In contrary, when the aircraft is mainly designed for inner-city travel, an agility in maneuvering may become important than an improved cruising speed and an extended flight distance.

In this case, a majority of the tilting units of the aircraft may be chosen to provide at least two degrees of freedom, while only a minority of the tilting units may provide a single degree of freedom.

Alternatively, the multi-rotor aircraft may include different types of tilting units for different rotor groups. For example, depending on the maximum magnitude of the sum of the lifts which should be generated by a certain rotor group, a tilting range of the rotor group, a total weight of the aircraft, or a certain portion of the aircraft weight which has to be supported by the rotor group, a designer or a manufacturer may use multiple tilting units of different types for a certain single rotor group, or for multiple rotor groups.

In the fifth example of this fourth exemplary embodiment, the mechanical joint-type tilting unit may include a stopper or a confining object each of which can limit a tilting range (i.e., a range of tilting angle) of the tilting unit. Detailed configurations and operations of the stopper or confining object typically depend on, e.g., an installment location of the tilting unit, a desired tilting range, or the like. As used herein, the stopper and the confining object will be collectively referred to as the “stopper” hereinafter.

In the sixth example of this fourth exemplary embodiment, a tilting range of the path-dependent tilting unit may be determined by various features examples of which may include, but not limited to, a shape of the path, a size of the path, a curvature of the path, an orientation of the path, and the like. As a result, the designer has ample options of constructing the path-dependent tilting unit which may best suit the specific design objectives or considerations of various parts of the multi-rotor aircraft.

In the seventh example of this fourth exemplary embodiment, various tilting units may be configured to be tilted in various directions as determined by a designer or a manufacturer.

For example, a tilting unit may be given one, two, three or more degrees of freedom, where one of multiple degrees of freedom may include [1] a roll, [2] a revolution about a longitudinal axis of the aircraft, [3] a revolution about a lateral axis thereof, [4] a revolution about another axis thereof, or the like.

In the eighth example of this fourth exemplary embodiment, the multi-rotor aircraft may include multiple tilting units which may be tilted over various tilting ranges or within different tilting ranges. Therefore, the aircraft may include those tilting units such that [1] all tilting units may be tilted within the same tilting range, [2] at least one of such tilting units may be tilted in a certain tilting range which is different from the tilting range of the rest of the tilting units, [3] the tilting range of a certain tilting unit may be determined primarily based on its location of installment, or the like.

In the ninth example of this fourth exemplary embodiment, the multi-rotor aircraft may include multiple tilting units which may be tilted in various tilted directions. Therefore, the aircraft may include those tilting units such that [1] all tilting units may be tilted in the same tilted direction(s), [2] at least one of such tilting units may be tilted in a certain direction(s) which may be different from the tilting direction(s) of the rest of the tilting units, [3] the tilting direction of a certain tilting unit may be determined primarily based on its location of installment, or the like.

In the tenth example of this fourth exemplary embodiment, various elastic elements may be installed into or around the tilting units of this disclosure, where examples of such elastic elements may include elastic rods, springs, or the like. For example, at least one elastic element may be used as [1] one of the first, second, or third vertical frame, [2] as the tilting unit itself, or the like. Alternatively, at least one elastic element may be used in conjunction with at least one of such tilting units described in this disclosure.

In the eleventh example of this fourth exemplary embodiment, the tilting units may be installed in a location which is different from those exemplified hereinabove and hereinafter.

It is noted that the multi-rotor aircraft exemplified in many figures typically includes three vertical frames (31), (33), (35) and two horizontal frames (32), (34). However, the multi-rotor aircrafts of this disclosure may include [1] more (or less) than three vertical frames, [2] more (or less) than two horizontal frames, [3] no vertical frame at all, [4] no horizontal frame at all, or the like.

In the alternative, the multi-rotor aircrafts may include at least one frame which may be regarded neither as the vertical frame nor as the horizontal frame. Examples of such frames may include, e.g., [1] a frame which installed at a non-zero slanted angle and which forms a non-0° and non-90° angle with respect to a horizontal or vertical plane of the aircraft, [2] a bent frame, [3] a zigzag frame, [4] a curved frame, or the like.

Depending upon the exact numbers or exact locations of such horizontal, vertical, or slanted frames, a designer or a manufacturer can install the tilting unit [1] at any junction of two of such frames, [2] at any junction of three of such frames, or [3] on a certain position on any of the frames, where exact locations of such junctions or positions may be different from those exemplified in this disclosure.

In the twelfth example of this fourth exemplary embodiment, the tilting units may be coupled to the rotor group(s) or to the wing, body or other parts of the aircraft either “directly” or “indirectly.”

For example, the tilting unit can be “directly” coupled to a wing, a body or another part of the multi-rotor aircraft. In this configuration, the aircraft may not include any frames for coupling the tilting unit to the rotor group, wing, body or another part of the aircraft. Of course, the aircraft may include any number of frames for other purposes such as, e.g., providing mechanical support to the rotor group, wing or body, coupling the rotor group to the wing or body, or the like.

As a result, the upper arm of the tilting unit may [1] “indirectly” couple with the rotor group(s) through at least one of such frames, [2] “directly” couple with the rotor group(s) without requiring any intervening frames, or the like.

In addition, the lower arm of the tilting unit may [1] “indirectly” couple with a wing, a body or another part of the aircraft through at least one of such frames, [2] “directly” couple with the wing, body or another part of the aircraft without requiring any intervening frames, or the like.

It is noted that one feature of a certain embodiment or example of this second aspect of this disclosure [1] may be applied to, [2] may be incorporated into, [3] may replace, [4] may be replaced by, or [5] may be combined, with a corresponding feature of another embodiment or example of this second aspect, as long as such application, incorporation, replacement, or combination does not contradict each other.

It is also noted that one feature of this second aspect of this disclosure [1] may be applied to, [2] may be incorporated into, [3] may replace, [4] may be replaced by, or [5] may be combined with, a corresponding feature of another aspect of this disclosure, as long as such application, incorporation, replacement, or combination does not contradict each other.

### 3. Third Exemplary Aspect—Load Sharing Units

Various one-seater multi-rotor aircrafts of this disclosure may weigh from about 50 ton to 200 ton. When the multi-rotor aircraft is expanded to carry 20 or more passengers, the aircraft may weigh up to 500 tons. Whether the aircraft may be for a single pilot or for 20 passengers, the weight of the aircraft would have a severe impact on various mechanical parts of the aircraft.

### 3-1. Problems Attributed to Weight Loads of Multi-Rotor Aircrafts

More particularly, when a weight load amounting to several tens or hundreds of tons is exerted on a tilting unit, various moving elements of the tilting unit are subjected to such an enormous weight load. As a result, the moving elements may be easily worn out, not to mention a friction force of an enormous amplitude which acts against a tiling movement of the tilting unit, which may lead to improper tilting, incomplete tilting or loss of battery power to overcome the friction force.

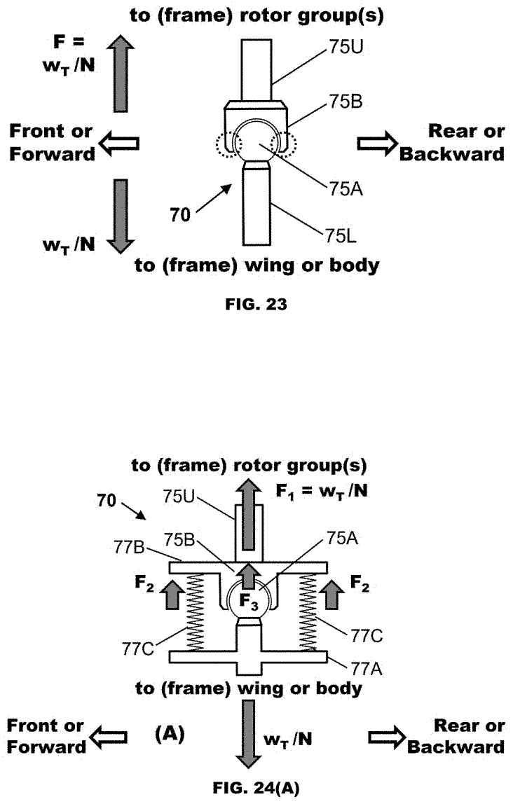

FIG. 23 is a cross-sectional view of a ball-socket joint-type tilting unit (70) which includes a ball (75A), and a socket (75B) shaped and sized to receive the ball (75A) therein. In this simplified configuration, the ball (75A) is fixedly coupled to a first (or second) vertical frame (75L) and eventually to a wing or a body of the multi-rotor aircraft, while the socket (75B) is coupled to a second (or third) vertical frame (75U), and then eventually coupled to at least one rotor group.

Based on a different perspective, however, the first (or second) vertical frame (75L) may be regarded as a part of the tilting unit (70), e.g., its lower arm (75L). Similarly, the second (or third) vertical frame (75U) may be classified as another part of the tilting unit (70), e.g., its upper arm (75U).

When “N” tilting units (70) are incorporated into a multi-rotor aircraft which has a weight, w_{T}, and when “N” tilting units (70) and the weight of the aircraft are evenly distributed, each tilting unit (70) bears a weight load of w_{T}/N.

Accordingly, when “N” ball-socket joint-type tilting units (70) are used, contacting areas between the ball (75A) and the socket (75B) of each tilting unit (70) (denoted by dotted circles) has to bear that weight load of w_{T}/N.

In the case of the multi-rotor aircraft which includes four or eight tilting units, each tilting unit has to be tilted against the weight load of w_{T}/4 or w_{T}/8. More particularly, due to such an enormous weight load, rotation of the ball (75A) inside the socket (75B) may face an enormous friction force, and may easily lead to wear and tear of the ball (75A), the socker (75B) or both.

In fact, whenever the weight load of a substantial amplitude is exerted onto the moving elements of such tilting units, such wear and tear problems must be common to all mechanical joint-type tilting units, path-dependent tilting units, bearing-type tilting units or other tilting units of this disclosure.

### 3-2. Configurations of Load Sharing Units

Accordingly, the third exemplary aspect of this disclosure relates to various load sharing units (or load bearing units) which may be incorporated into or around various tilting units such that at least a portion of the weight load exerted on the tilting unit can be born (or shared) by the load sharing units. To this end, the load sharing units are constructed and installed to divert at least a portion of a weight load of the aircraft to the load sharing units, while at the same time leaving only a remaining portion of the weight load to the tilting unit.

As a result, the tilting unit can be easily tilted and then tilt the rotor groups attached thereto, without having to work against an entire portion of the weight load exerted to the tilting unit. In addition, by minimizing the friction force exerted on various moving elements of the tilting units, wear and tear of such elements can be minimized and durability of the tilting units can be improved.

Followings are a few exemplary embodiments of such load sharing units (or load bearing units) which employ at least one tension spring, compression spring, or spacer, which may be constructed and installed in various arrangements or locations for relieving the tilting units from an excessive weight load of the aircraft.

Although following examples illustrate various load sharing units while referring to a ball-socket joint-type tilting unit or a revolute joint-type tilting unit, various load sharing units can be equally applied to other types of tilting units.

The first exemplary embodiment of the third aspect of this disclosure relates to a multi-rotor aircraft which employs at least one tension spring as its load sharing unit, where the stretched tension spring can divert at least a portion of a weight load of a multi-rotor aircraft away from a tilting unit, regardless of the types of such tilting unit.

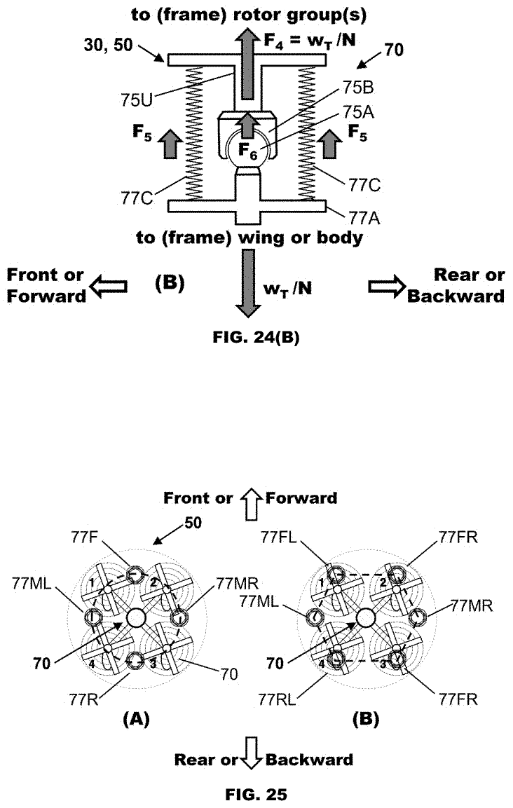

FIGS. 24A-24B are cross-sectional views of an exemplary load sharing unit, where multiple tension springs are installed around a tilting unit and divert at least a portion of a weight load of a multi-rotor aircraft away from the tilting unit. It is assumed that the aircraft has a weight of w_{T} and includes N tilting units, and each tilting unit is coupled to at least one rotor group which generates the minimum lifts of, e.g., w_{T}/N in an upward direction. For ease of illustration, the portion of the weight load, w_{T}/N, may be simply referred to as the weight load throughout this disclosure.

In Panel (A), a ball (75A) includes a ball flange (or a lower flange) (77A), and a socket (75B) includes a socket flange (or an upper flange) (77B). Between such flanges (77A), (77B), at least two tension springs (77C) are inserted so that the springs (77C) tend to pull the ball flange (77A) in an upward direction, along with other structures of the aircraft coupling with the ball flange (77A), where examples of such structures may include, but not limited to, at least one frame of the aircraft, its wing, or its body. More particularly, the springs (77C) are installed such that the lengths of the springs (77C) are greater than their equilibrium lengths, and that such springs (77C) pull the ball flange (77A) and the socket flange (77B) closer to each other.

Regardless of the number of flanges and tension springs incorporated in this configuration, it is noted that the socket (75B) and the rotor groups coupled to the socket (75B) have to carry the weight load of w_{T}/N. However, because the tension springs (77C) are stretched beyond their equilibrium lengths, such springs (77C) constantly pull the ball flange (77A) in the upward direction as denoted by F₂.

As a result, a force F₃ which acts on the ball (75A) and the socket (75B) can be significantly reduced, e.g., down to tens of percent or only a few percent of w_{T}/N. The friction force acting on the contacting areas between the ball (75A) and the socket (75B) of the tilting unit (70) can be reduced as well and, therefore, the friction force resisting the tilting can also be reduced. Therefore, the load sharing unit can facilitate the ball-socket joint-type tilting unit (70) to be tilted more smoothly, with less friction.

In Panel (B), a ball (75A) includes a ball flange (77A), while a socket (75B) may be directly coupled to a frame or a rotor group. Between the ball flange (77A) and the frame or rotor group, at least two tension springs (77C) are inserted such that the springs (77C) tend to pull the ball flange (75A) and other structures coupling therewith in the upward direction. More particularly, the springs (77C) are installed such that their lengths are greater than their equilibrium lengths.

Similar to the configuration of Panel (A), the socket (75B) and the rotor groups coupled to the socket (75B) have to carry the weight load of w_{T}/N. However, the tension springs (77C) already stretched beyond their equilibrium lengths constantly pull the ball flange (77A) in the upward direction, as denoted by F₅. As a result, the force F₅ acting on the ball (75A) and the socket (75B) can be significantly reduced, e.g., down to tens of percent or only a few percent of w_{T}/N. Thus, the friction force which acts on the contacting areas between the ball (75A) and the socket (75B) of the tilting unit and which also resists the tilting of the tilting unit (70) can be reduced as well. Therefore, the load sharing unit can facilitate the ball-socket joint-type tilting unit (70) to be tilted more smoothly, with less friction.

In Panels (A) and (B), it is theoretically possible that the weight load exerted onto the tilting unit due to the weight of the aircraft can be minimized to any desired percent. For example, a designer or a manufacturer may select the tension springs having desired spring constants and equilibrium lengths, and may stretch such springs to desired lengths during installation.

By carefully selecting such spring constants, equilibrium lengths, and stretching, the designer or manufacturer can manipulate the tension force exerted by such springs and acting in the upward direction to have a desired amplitude.

The second exemplary embodiment of the third aspect of this disclosure relates to various spatial arrangements of such load sharing units with respect to the tilting units or the rotor groups. Although various multi-rotor aircrafts may include two or more load sharing units in almost any spatial arrangements, disposition of the load sharing units in certain patterns may facilitate tilting of the tilting units or rotor groups, while disposition of such springs in different patterns may impede such tilting. For ease of illustration, the tension springs are taken as the example of the load sharing units.

In the first example of this second exemplary embodiment, the tension spring-type load sharing units having the same or different shapes, sizes, types or spring constants may be installed radially around a tilting unit at preset distances, where an even or odd number of springs may be incorporated.

FIG. 25 is a bottom view of exemplary rotor groups, tilting units, and load sharing units. It is noted in this figure that the rotors of a rotor group (50) lie on this paper, whereas the tilting units (70) and load sharing units (77) protrudes out of the paper toward a reader. A wing or a body of the aircraft lie on top of the load sharing units and therefore, even closer to the reader.

Panel (A) shows a multi-rotor aircraft with four load sharing units (77F), (77ML), (77MR), (77R) which are distributed at equal distances (or angles) along a periphery of a circle of which the center corresponds to a center of a tilting unit (70). Panel (B) also shows a similar aircraft including six load sharing units (77FL), (77FR), (77ML), (77MR), (77RL), (77RL) which are similarly distributed at equal distances (or angles) along a periphery of a hexagon of which the center corresponds to a center of a tilting unit (70).

It is noted that the aircraft may include a greater or smaller number of load sharing units (77) than exemplified in Panels (A) and (B) such that the aircraft includes two, three, five, seven or more load sharing units which may be disposed along a periphery of a certain geometric object such as, e.g., a circle, oval, triangle, square, rectangle or other polygons.

It is noted that a center of that object of the above paragraph may or may not correspond to a center of the tilting unit. In addition, such load sharing units may not have to be disposed along any periphery of any geometric object.

The tension spring-type load sharing units exemplified in FIGS. 24 and 25 may have the same spring constant, may have the same equilibrium lengths, or the like. Such springs may be installed so that they have the same displacement (i.e., a difference between a stretched or installed length and its equilibrium length) in an upright position or during hovering.

When desirable, at least one of such springs may have [1] a spring constant which may be different from that of at least one of other springs, [2] an equilibrium length which may be different from that of at least one of other springs, or the like.

The springs may also be installed to have different displacements in its upright position. To this end, [1] the springs of the same equilibrium lengths may be installed while being stretched over different lengths, [2] the springs of different equilibrium lengths may be installed while being stretched to the same or different lengths, or the like.

When the springs have the same spring constant as well as the same equilibrium lengths and when they are installed to have the same displacement in the upright position, such springs generate tension forces of the same amplitude and pull the aircraft in the upward direction. It is noted, however, that a designer or a manufacturer may have to consider various factors in selecting the displacement of such springs.

It is appreciated that arranging the tension springs around the tilting units may adversely affect tilting function of the tilting units, for such tilting may stretch some springs more than the other and may render more stretched spring exert an additional resisting force to such tilting. That is, the stretched springs of the load sharing units may pull the tilting unit and the rotor groups attached thereto back to their upright position.

Referring to Panel (A) of FIG. 25, assume that the rear rotors (rotors 3 and 4) of a rotor group (50) begin to generate the “rear lifts” which are greater than the “front lifts” generated by the front rotors (rotors 1 and 2). As a difference between such “rear” and “front” lifts increases, a horizontal component of a vector sum of such lifts also increases, and the rotor group (50) begins to tilt in a tilting (or forward) direction.

As the rotor group (50) gradually tilts, the rear spring (77R) begins to be stretched more, while the front spring (77F) may recoil. As the rear spring (77R) is stretches even more, a tension force generated by the rear spring (77R) also increases in its amplitude, and pulls the tilting unit (70) as well as the rotor group (50) coupled to the tilting unit (70) back to their upright position.

During the forward tilting (i.e., tilting in the forward direction), the lengths of the middle springs (77ML), (77MR) do not change significantly. In other words, when the tilting is solely in the forward direction, the middle springs (77ML), (77MR) substantially retain their lengths, and the tension forces generated by the middle springs (77ML), (77MR) do not change either.

In addition, because the length of the front spring (77F) decreases during such tilting, the front spring (77F) can recoil back toward its equilibrium length. As the forward tilting continues, the length of the front spring (77F) decreases beyond its equilibrium length, and the front spring (77F) may begin to generate a compression force which in effect resists the forward tilting and which pushes the tilting unit (70) and the rotor group (50) coupled thereto back to their upright position.

As described above, when the tension springs are uniformly installed around the tilting unit (70), at least one radially disposed spring can always impede the tilting of the tilting unit (70) and rotor group (50), regardless of the direction of tilting. Therefore, the location of the tilting unit, the number of the spring-type load sharing units to be implemented, and orientation or disposition of the spring-type load sharing units have to be determined based on the foregoing.

In the second example of this second exemplary embodiment, the tension spring-type load sharing units may be installed at least substantially perpendicular to the direction of tilting in such a way that changes in the lengths of the springs during tilting and tension force generated by such tilting do not change at least significantly as the tilting unit and the rotor group coupled thereto are tilted.

By maintaining the lengths of the spring-type load sharing units during such tilting, the spring-type load sharing units may not exert any additional tension or compression force which pulls the tilting unit and rotor group back to their upright position and, therefore, none of such springs would impede tilting of the tilting unit and rotor group.

It is appreciated that one major objective of such tilting is to obtain a greatly increased cruising speed in the forward direction or in the backward direction. It then follows that such tension spring-type load sharing units may be preferentially disposed along a lateral axis of a multi-rotor aircraft, where the lateral axis extends from a right end of the aircraft to a left end of the aircraft (or vice versa) and is typically perpendicular to a longitudinal axis of the aircraft.

It is also appreciated that disposition of the tension spring-type load sharing units preferentially in the lateral direction may bring in a disadvantage of allowing the tilting unit to be tilted only in a single direction. However, by incorporating a secondary joint or a secondary tilting unit, the multi-rotor aircraft may guarantee that the tilting unit has to bear only a portion of the weight load of the aircraft, while leaving the remaining portion of the weight load to be borne by the load sharing unit, and that the rotor group can be tilted in at least two directions.

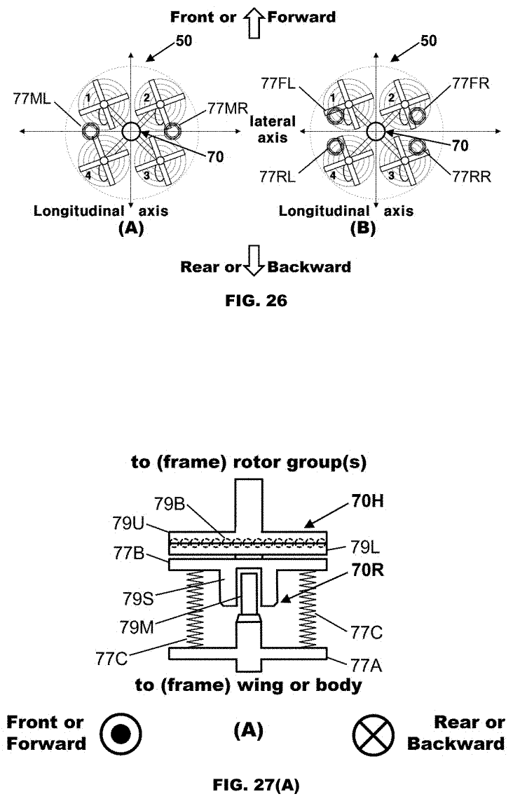

FIG. 26 is another bottom view of exemplary rotor groups, tilting units, and load sharing units, where the load sharing units are installed in an arrangement or an orientation capable of minimizing interference on proper tilting of the tilting units. Again the tension springs are taken as the examples of the load sharing units.

Panel (A) exemplifies a multi-rotor aircraft with a left spring (77L) and a right spring (77R) which are installed respectively on a left side and a right side of a tilting unit (70) and which are positioned at least partially parallel to a lateral axis of the aircraft (or at least partially perpendicular to a longitudinal axis of the aircraft). When the tilting units are tilted in tilted direction (e.g., a forward or backward direction), the aircraft also moves in the same direction.

During the tilting movement, the springs (77L), (77R) may be tilted in the same direction, while minimally changing their lengths. Therefore, such springs (77L), (77R) do not exert any additional force resisting the tilting of the tilting unit (70) (and at least one rotor group (50) coupled thereto), and do not interfere with the forward or backward tilting of the tilting unit (70) and the rotor group (50).

Panel (B) is a configuration similar to that of Panel (A), except that the aircraft may include four load sharing units (e.g., four tensions springs) (77FL), (77FR), (77RL), (77RR) two of which are positioned on the left side and other two of which are positioned on the right side of the tilting unit (70).

Compared to the arrangements of Panels (A) and (B) of FIG. 25, this arrangement of Panel (B) of FIG. 26 includes four springs (77FL), (77FR), (77RL), (77RR) which are disposed substantially along the lateral axis of the aircraft. Therefore, these four load sharing units (77FL), (77FR), (77RL), (77RR) are also guaranteed to flip in the tilting direction, e.g., in the forward, backward or slanted direction, while minimally interfering the tilting of the tilting unit (70) and the rotor group (50) coupled thereto.

Compared to that of Panel (A), the arrangement of Panel (B) ensures that the tilting unit (70) and the rotor group (50) coupled thereto do not inadvertently flip easily by strong winds flowing in a lateral direction. Accordingly, such an arrangement can provides more stability to various operations of the aircraft which accompany the tilting of the tiltable rotor groups.

As explained above, disposing the load sharing units preferentially along the lateral axis may facilitate easy tilting of the tilting unit and the rotor group in the forward or backward direction. However, this disposition may impede tilting in other slanted directions which are parallel to neither the forward direction nor the backward direction.

Accordingly, the third exemplary embodiment of the third aspect of this disclosure relates to various tilting units and the load sharing units which can not only divert at least a portion of a weight load of a multi-rotor aircraft away from the tilting unit (regardless of its types) but also facilitate tilting in the forward direction, backward direction, and other slanted directions, without hindering the tilting in any of such directions.

Followings are details of the embodiment which is applied to multiple tilting units, e.g., to an assembly of a pair of tilting units one of which is a turn-table tilting unit and another of which is a revolute joint-type tilting unit. Although each of the turn-table tilting unit and the revolute joint-type tilting unit typically provides a single degrees of freedom, the assembly may provide multiple degrees of freedom.

It is noted that following configurations may be applied to a combination of other two tilting units or even three tilting units, where each of such tilting units may be the mechanical joint-type tilting unit, the path-dependent tilting unit, the bearing-type tilting unit, and the like.

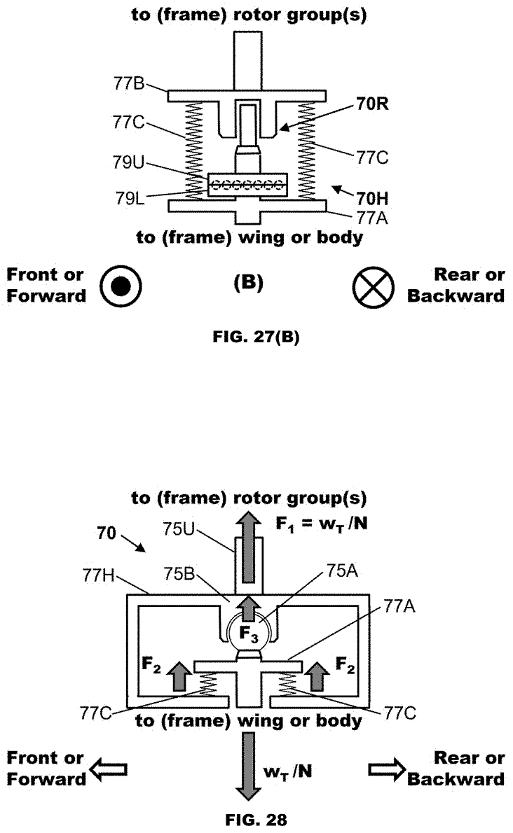

FIGS. 27A-27B are cross-sectional views of exemplary configurations in which multiple tilting units are incorporated with the load sharing units which can divert at least a portion of a weight load of a multi-rotor aircraft away from the tilting unit. It is appreciated in FIGS. 27A-27B that a direction coming out of this paper corresponds to a forward direction, while an opposite direction going into this paper corresponds to a backward direction.

In Panel (A), a revolute joint-type tilting unit (70R) is coupled to (or sits on top of) a frame, a wing or a body of a multi-rotor aircraft. The revolute joint (70R) typically includes a disc-shaped moving element (79M) and a stationary element (79S) which defines a planar slit therein.

The moving element (79M) is also shaped and sized such that the moving element (79M) can slide inside the silt of the stationary element (79S), thereby providing a single degree of freedom such as, e.g., an angular rotation in a direction of coming out of this paper and in another direction of penetrating into this paper.

Similar to the ball-socket joint-type tilting unit of FIGS. 24A-24B, the revolute joint-type tilting unit (70R) has a lower flange (77A) and an upper flange (77B). At least two tension springs (77C) are inserted such that the springs (77C) tend to pull the lower flange (77A) as well as other structures coupling therewith in an upward direction, where examples of such structures may include, but not limited to, a wing, a body or at least one frame of the aircraft.

More particularly, the springs (77C) are installed in such a way that the lengths of the springs (77C) in the stretched or installed state are greater than their equilibrium lengths, and that the springs (77C) pull objects at their opposing ends closer to each other.

On top of the revolute joint-type tilting unit (70R) is installed a turn-table tilting unit (70H) which has an upper plate (79U), a lower plate (79L), and multiple bearings (79B) placed between such plates (79U), (79L). As a result, the turn-table tilting unit (70H) provides a single degree of freedom which is an angular rotation in a clockwise or counter-clockwise direction.

It is noted that the springs (77C) are preferentially installed only on the left side and the right side of the moving and stationary elements (79M), (79S). In other words, the springs (77C) are preferentially positioned not in the direction (or along the path) of the angular movement of the revolute joint-type tilting unit (70R), but in the direction which is at least partially perpendicular to the direction of the angular movement.

Rather, such springs (77C) are preferentially positioned at least partially or substantially perpendicular to the direction (or along the path) of the angular movement of the revolute joint-type tilting unit (70R). As a result, when the revolute joint-type tilting unit (70R) as well as the rotor groups coupled thereto is tilted in the angular direction or along its angular path, such tension springs (77C) do not get in the way of the tilting unit (70R).

Because the displacements of the springs (77C) do not significantly change, they do not interfere or adversely affect the tilting of the tilting unit (70R) and the rotor groups coupled thereto. This results in more smooth tilting of the tilting units (70R), (70H) and other structures coupled to such tilting units (70R), (70H).

This configuration can be regarded as assigning the task of vertical and angular rotation in the θ direction to the revolute joint-type tilting unit (70R), and assigning the task of horizontal and angular rotation in the φ direction to the turn-table tilting unit (70H). By including multiple tilting units and assigning each tilting unit to be tilted in different directions, not only the tilting units but also the rotor groups coupled thereto may be more easily tilted in any of the 0 and φ directions.

This configuration in Panel (A) may have a drawback that the turn-table tilting unit (70H) has to carry a substantial portion (e.g., w_{T}/N) of the weight load of the aircraft, and that the turn-table tilting unit (70H) is subjected to severe wear and tear. Such a problem may be avoided by positing the same tilting units in different arrangements.

In Panel (B), a revolute joint-type tilting unit (70R) is incorporated in a manner which is similar to the configuration of Panel (A). Unlike that of Panel (A), however, a turn-table tilting unit (70H) is installed on top of a lower flange (77A) of the revolute joint-type tilting unit (70R).

Then multiple tension springs (77C) are installed similar to those of Panel (A), i.e., between the upper flange (77B) and the lower flange (77A) of the revolute joint-type tilting unit (70R).

In this configuration, instead of bearing the entire portion of the weight load (e.g., w_{T}/N), the turn-table tilting unit (70H) may only have to bear only a portion of w_{T}/N, for the tension springs (77C) are bearing a majority of the weight load (e.g., a majority of w_{T}/N). As a result, the friction exerted on the contacting areas between the moving elements of the revolute joint-type tilting unit and the turn-table tilting unit (70H) can be minimized.

The fourth exemplary embodiment of the third aspect of this disclosure relates to various load sharing units which do not include the tension springs but include compression springs.

This configuration can be readily used by slightly modifying the configurations of those of FIGS. 11 to 14. That is, the compression springs of the load sharing units may be arranged to bear at least a portion of a weight load of the multi-rotor aircraft.

FIG. 28 is a cross-sectional view of another exemplary load sharing unit, where multiple compression springs are installed around a tilting unit and divert at least a portion of a weight load of a multi-rotor aircraft away from the tilting unit.

It is noted that the configuration in FIG. 28 is a modification of that of FIGS. 24A-24B. Accordingly, the ball-socket joint-type tilting unit (70) is similar to that of FIGS. 24A-24B. However, the tilting unit (70) includes a upper housing (77H) instead of the socket flange (77B) of FIGS. 24A-24B, and the ball flange (77A) is installed closer to the ball (75A). Multiple compression springs (77C) are then installed between the ball joint (75A) and a bottom of the upper housing (77H).

More particularly, such compression springs (77C) are installed while being compressed in such a way that their lengths are shorter than their equilibrium lengths. Accordingly, when the tilting unit (70) is in its upright position, the compressed compression springs (77C) tend to push the ball flange (77A) and other structures which are coupled thereto in an upward direction.

Through this mechanism, the compression spring-type load sharing unit (77C) can bear at least a portion of the weight load of the multi-rotor aircraft, while leaving only the remaining portion of the weight load to the tilting units.

By bearing at least a substantial portion of the weight load of the aircraft, this load sharing unit can divert that portion of the weight load away from the tilting unit (70), and can allow the tilting unit (70) and rotor groups coupled thereto to perform more smooth tilting. By the same token, such compression springs can be applied to various arrangements of the load sharing units exemplified in FIGS. 25 to 27B.

The fifth exemplary embodiment of the third aspect of this disclosure relates to various load sharing units which do not include the above tension or compression springs, but include various spacers which have preset lengths and which can not only divert at least a portion of a weight load of a multi-rotor aircraft from the tilting unit (regardless of the types of the tilting units) but also facilitate tilting in the forward direction, backward direction, and other slanted directions, without hindering the tilting in such directions.

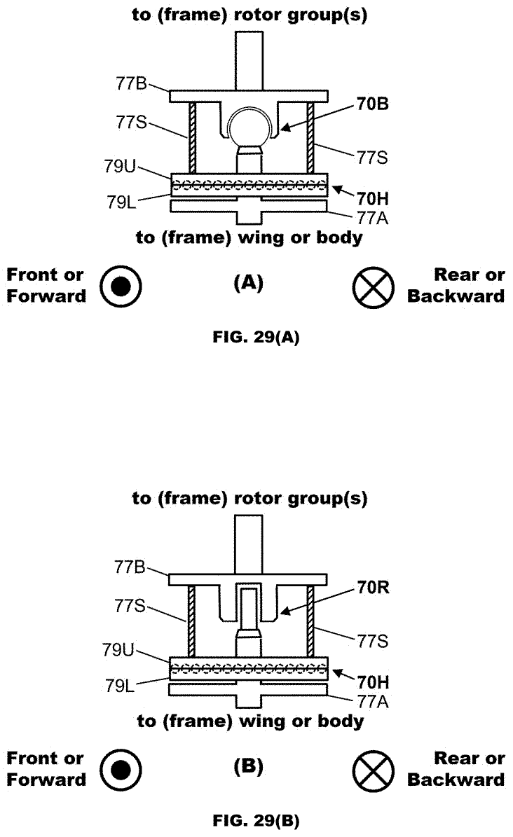

FIGS. 29A-29B are cross-sectional views of an exemplary spacer-type load sharing unit which is incorporated in or around a tilting unit (70) and which can divert at least a portion of a weight load of a multi-rotor aircraft away from the tilting unit (70).

In Panel (A), a ball-socket joint-type tilting unit (70B) is installed similar to that of Panel (A) of FIGS. 24A-24B. The joint-type tilting unit (70B) includes an upper flange (77B) and a lower flange (77A). On top of such a lower flange (77A) sits a turn-table tilting unit (70H) which is similar to that of Panel (B) of FIG. 27B. That is, the turn-table tilting unit (70H) includes an upper plate (79U), a lower plate (79L), and multiple bearings (79B) placed between such plates (79U), (79L). Thus, the turn-table tilting unit (70H) provides a single degree of freedom which is an angular rotation in a clockwise or counter-clockwise direction.

At least two spacers (77S) (neither the tension spring nor the compression spring) are installed between the upper flange (77B) of the ball-socket joint-type tilting unit (70B) and the upper plate (79U) of the turn-table tilting unit (70H). Such spacers (77S) may be installed [1] around the ball-socket joint-type tilting unit (70B), similar to the arrangement exemplified in FIG. 25, [2] preferentially along the lateral axis, similar to the arrangement exemplified in FIG. 26, or the like.

It is noted that a main function of the spacer (77S) is to couple with the lower flange (77A), the turn-table tilting unit (70H), or any structure of a multi-rotor aircraft which is directly or indirectly coupled to the lower flange (77A) or turn-table tilting unit (70H). Through such coupling, the spacer (77S) can bear at least a portion of a weight load exerted on the tilting units (70B), (70H). Accordingly, such a spacer (77S) may be carefully manufactured and installed such that the length of the spacer (77S) must not be too short or long to bear at least a portion of a weight load which is exerted on the tilting units (70B), (70H).

In general, the spacer (77S) may be shaped or sized as an article which can bear at least a portion of the weight load of the aircraft. Examples of such articles may include, e.g., [1] a solid rod having a preset height, [2] a solid chain having a preset height when hung in a vertical direction, or [3] similar articles which can bear such a portion of the weight load when disposed in the vertical direction.

As noted above, the length of the spacer (77S) must be carefully adjusted such that the spacer (77S) not only bears such a portion of the weight load but also facilitate tilting of the tilting units (70B), (70H) and the rotor groups coupled thereto. Accordingly, the multi-rotor aircraft may include at least one length-adjusting mechanism with which a mechanic or a pilot may easily adjust the exact length of the spacer (77S).

### 3-3. Variations or Modifications

The sixth exemplary embodiment of the third aspect of this disclosure relates to variations or modifications of the load sharing units which have been exemplified in the above embodiments or examples of this Section 3.

In the first example of this sixth exemplary embodiment, those exemplary load sharing units of FIGS. 24 to 28 can be modified to include at least one tension spring and at least one compression spring in combination so that the springs pull or push one flange in the upward direction, thereby minimizing the friction between the moving elements and abutting elements of various joints of the tilting unit.

Regardless of how many springs may be used as the load sharing unit, such springs may be installed in a series mode, in a parallel mode or in a hybrid mode, where the hybrid mode refers to a combination of the series and parallel modes. In addition, a designer or a manufacturer may incorporate at least one dash-pot along with such spring(s) when he wants to incorporate a viscoelastic response into the load sharing unit.

In the second example of this sixth exemplary embodiment, the spring-type load sharing units may be easily implemented into different types of mechanical joint-type tilting units which may include at least one of a ball-socket joint, a bolted joint, a condyloid joint, a cotter-pin, an ellipsoidal joint, a ginglymus joint, a gliding joint, a hinge joint, a knuckle joint, a pin joint, a pivot joint, a plane joint, a prismatic joint, a revolute joint, a saddle joint, a screw joint, a slider joint, a spherical joint, a turnbuckle, or a universal joint. The above configurations with the tension springs or compression springs may easily be applied to various path-dependent tilting units, or bearing-type tilting units as well.

In the third example of this sixth exemplary embodiment, the load sharing units may use springs which may be different from prior art tension or compression springs. Alternatively, various tension springs or compression springs of the above configurations may be replaced by other springs or prior art articles which do not have the shape of coils but which can [1] generate or release a tension force, [2] generate or release a compression force, or [3] have an elastic property capable of storing or releasing mechanical energy.

Accordingly, examples of such non-coil-type springs may include, but not limited to, an arc spring, a balance spring, a Belleville washer, a cantilever spring, a constant spring, a constant-force spring, a flat spring, a Garter spring, a gas spring, a hollow tube spring, a leaf spring, a machined spring, a mainspring, a negator spring, a serpentine spring, a spring washer, a torsion spring, a V spring, a variable spring, a variable stiffness spring, a volute spring, a wave spring, or the like.

In the fourth example of this sixth exemplary embodiment, the load sharing units such as the above springs may serve as tilting units, even without including any of the tilting units described heretofore. In other words, this configuration may correspond to one which is identical to those of FIGS. 24 to 28 but which does not include any tilting units such that the tension or compression springs themselves serve as the tilting units.

In the fifth example of this sixth exemplary embodiment, the multi-rotor aircraft with springs as its tilting unit would exhibit purely elastic behavior in tilting the rotor groups. That is, when such springs are used as the tilting units, purely elastic response of the springs may provide the tilting operation with overshooting, i.e., the springs may be tilted to a great extent and then may recoil back.

In order to rectify such a problem, at least one viscos element such as a dash-pot may be incorporated such that the tilting unit may include not only the elastic springs but also the viscous dash-pots.

In the sixth example of this sixth exemplary embodiment, the load sharing unit of the multirotor aircraft of this disclosure may have configurations which may be different from those exemplified in this third aspect.

For example, the load sharing unit may include an elastic, viscous, or a viscoelastic element which is implemented with the tilting unit (or into the tiltable rotor group) in a series mode so that the element may bear (or share) at least a portion of the weight load of the aircraft.

When the load sharing unit includes the elastic or viscoelastic element, such an element may absorb at least a portion of the weight load when the element is stretched (or compressed), and then release the portion of the weight load when the element returns to its equilibrium length. Therefore, this load sharing unit may be able to facilitate the tilting unit to be easily tilted, while decreasing friction exerted on the moving element.

When the load sharing unit includes the viscous or viscoelastic element, such a unit may be able to dampen the change in the weight load of aircraft, particularly the dynamic inertia of the aircraft which is caused by an acceleration or deceleration of the aircraft in any direction.

Thus, this load sharing unit may also be able to facilitate the tilting unit to be easily tilted, while decreasing friction exerted on the moving element.

In another example, the load sharing unit may include a non-elastic and non-viscous element which may be implemented with the tilting unit (or into the tiltable rotor group) in a series mode such that the element may bear (or share) at least a portion of the weight load of the aircraft.

Various elements of the load sharing unit in the above paragraph may be implemented with the tilting unit (or into the tiltable rotor group) in parallel with or at a slanted angle with respect to the tilting unit (or into the tiltable rotor group), where the slanted angle is a non-zero and non-90° angle with respect to the tilting unit which is in an upright position.

It is noted that one feature of a certain embodiment or example of this third aspect of this disclosure [1] may be applied to, [2] may be incorporated into, [3] may replace, [4] may be replaced by, or [5] may be combined, with a corresponding feature of another embodiment or example of this third aspect, as long as such application, incorporation, replacement, or combination does not contradict each other.

It is also noted that one feature of this third aspect of this disclosure [1] may be applied to, [2] may be incorporated into, [3] may replace, [4] may be replaced by, or [5] may be combined with, a corresponding feature of another aspect of this disclosure, as long as such application, incorporation, replacement, or combination does not contradict each other.

### 4. Fourth Exemplary Aspect—Tilting Manipulation

The fourth exemplary aspect of this disclosure relates to various configurations or methods of manipulating a tilting range of the tilting units. As described above, the tilting unit is coupled to at least one rotor group on its upper arm, while coupling with at least one of a frame, a wing or a body of the multi-rotor aircraft on its lower arm. Accordingly, various configuration can be used to manipulate the tilting ranges of various tilting units.

The tilting units may also be configured in such a way that the tilting ranges of the tilting units may be limited to a preset range of angles or lengths. In addition, conventional viscous or elastic elements can be incorporated into or around the tilting units in such a way that the multi-rotor aircraft may manipulate not only static features but also dynamic features related to such tilting within such tilting ranges.

### 4-1. Tilting Ranges

In the first exemplary embodiment of the fourth aspect of this disclosure, each tilting unit may be tilted in a preset tilting range, i.e., a preset range of (tilting) angles, where examples of such ranges may include, but not limited to, 15°, 30°, 45°, 60°, 75°, 90°, 105°, 120°, 135°, 150°, 165°, 180°, or the like. The tilting range may also be about 195°, 210°, 225°, 240°, 255°, 270°, 285°, 300°, 315°, 330°, 345°, or 360°.

Alternatively, the tilting range, α, may be represented as, e.g., D₁≤α≤D₂, where D₁ and D₂ are real numbers, and where |D₂−D₁| may be 15°, 30°, 45°, 60°, 75°, 90°, 105°, 120°, 135°, 150°, 165°, 180°, 195°, 210°, 225°, 240°, 255°, 270°, 285°, 300°, 315°, 330°, 345°, or 360°, or the like.

For example, the tilting range of 60° may be equivalent to the ranges expressed as −75°≤α≤−15°, −60°≤α≤0°, −45°≤α≤+15°, −30°≤α≤+30°, −15°≤α≤+45°, 0°≤α≤+60°, +15°≤α≤+75°, or the like. Similarly, the tilting range of 45° may be equivalent to the ranges expressed as −60°≤α≤−15°, −45°≤α≤0°, −30°≤α≤+15°, −15°≤α≤+30°, 0°≤α≤+45°, 15°≤α≤+60°, or the like.

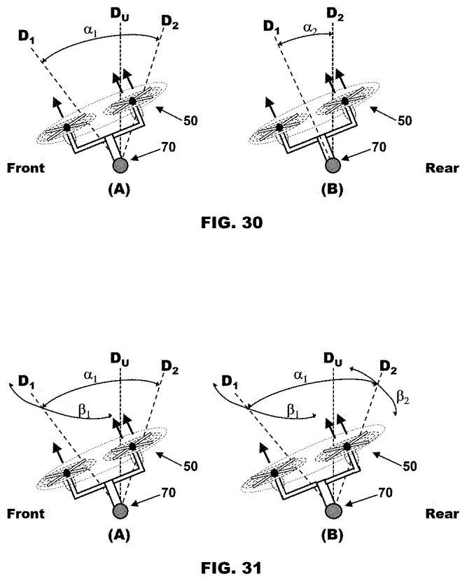

Different ways of expressing such tilting ranges as explained in the preceding paragraph can also be shown graphically. FIG. 30 shows different ways for defining the tilting ranges of the tilting units, where D₁ and D₂ are a lower bound (or limit) and an upper bound (or limit) of such ranges, respectively, and where D_{U} is the vertical direction, the direction of gravity or the upright direction of a multi-rotor aircraft during hovering.

As illustrated in Panel (A) of FIG. 30, a tilting range (α₁) of a rotor group (50) may be defined as −30°≤α₁≤+15° or simply as 45°, where D_{U} is represented as the vertical line or where D_{U} corresponds to when α=0°. Therefore, the rotor group (50) can be tilted along with a tilting unit (70) up to 30° in the forward direction, and up to 15° in the backward direction, thereby allowing the aircraft to move in the forward direction, to move in a backward direction, or to not move in either direction while hovering in the sky.

In contrary, a tilting range (α₂) of a rotor group (50) of Panel (B) of FIG. 30 may be defined as −30°<α₁≤0° or simply as 30°. Therefore, the rotor group (50) can be tilted along with a tilting unit (70) up to 30° in the forward direction, but not in the backward direction, thereby allowing the aircraft either to move in the forward direction or to not move in either direction while hovering in the sky.

Although not shown in the figure, a tilting range of a rotor group may be defined as −45°<α₁<−15° or simply as 30°. This tilting range means that the tilting unit and the rotor group coupled thereto may be tilted up to 45° in the forward direction, but may not be tilted at an angle greater than −15°. That is, a vector sum of the lifts generated by the rotors of the rotor group (50) always has a non-zero horizontal component and, therefore, the tilting unit and the rotor group coupled thereto cannot be oriented in the vertical direction. Therefore, this rotor group (50) can move the aircraft in the forward direction even when its rotors are all rotating at the same rpm. Of course, whether or not the aircraft may maintain its altitude or may increase or decrease its altitude depends upon an amplitude and a direction of a vertical component of the vector sum of such lifts.

It is appreciated that the tilting unit of FIG. 30 provides a single degree of freedom to the rotor group. Accordingly, when a spherical coordinate (r, θ, φ) is used, that single degree of freedom may be an angular movement in the θ direction or in the φ direction.

The tilting unit may also provide multiple degrees of freedom to the rotor group. Accordingly, when the spherical coordinate (r, θ, φ) is used, multiple degrees of freedom may correspond to an angular movement (rotation) in the θ direction, another angular movement (or rotation) in the φ direction and, when desirable, yet another angular movement (or rotation) may be a revolution around at least one of the φ or θ direction.

FIG. 31 shows exemplary tilting units which provides at least two degrees of freedom to a rotor group, where α represents a tilting range in the direction of θ in the spherical coordinate, while β means a tilting range in the direction of φ in the spherical coordinate.

Panel (A) of FIG. 31 exemplifies a case where a tilting unit (70) can be tilted along with a rotor group (50) within a range of α₁° in the θ direction, and within a range of β₁° in the φ direction. Accordingly, when α₁° is between D₁ (−45°) and D₂ (+15°) and β₁° is between −15° and +15°, the tilting unit (70) and the rotor group (50) can be tilted at any angle between D₁ and D₂ in the θ direction, as long as a tilting angle in the φ direction may be any angle between −15° and +15°.

In addition, Panel (B) of FIG. 31 shows a case where a tilting unit (70) and a rotor group (50) coupled thereto can be tilted within a range of α₁° in the θ direction, but a tilting range in the φ direction may vary according to the value of α₁°. For example, when the rotor group (50) is tilted at D₁ in the θ direction, the rotor group (50) can tilt within a range of β₁° in the φ direction.

However, as the tilting angle in the θ direction increases (i.e., the tilting unit (70) is tilted in the backward direction), the tilting range in the φ direction also decreases. When the rotor group (50) is tilted at D₂ in the θ direction, the tilting range in the φ direction eventually decreases down to β₂° which is smaller than β₁°.

### 4-2. Configurations for Limiting Tilting Ranges

In the second exemplary embodiment of the fourth aspect of this disclosure, at least one stopper or at least one confining object (or obstruction) may be incorporated into or around the tilting unit and may limit a tilting range of the tilting unit within a desirable value. For ease of illustration, the stopper, the confining object or the obstruction are collectively referred to as a “stopper” in this disclosure.

Followings relate to exemplary stoppers which can be applied to a mechanical joint-type tilting unit, more particularly, a ball-socket joint-type tilting unit, It is to be noted, however, that the stoppers can be similarly applied to other tilting units of different types illustrated in the above Section 2.

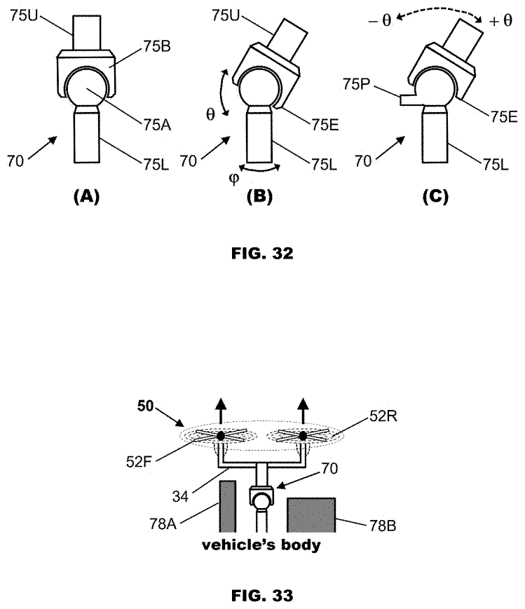

FIG. 32 is a cross-sectional view of a ball-socket joint-type tilting unit, where Panel (A) shows such a tilting unit in an upright position, and Panel (B) shows the tilting unit of Panel (A) without any stopper, and Panel (C) shows the tilting unit incorporated with a stopper.

A typical ball-socket joint-type tilting unit (70) includes a ball (75A) as well as a socket (75B) shaped and sized to receive the ball (75A) therein. The ball (75A) is fixedly and directly coupled to a first (or second) vertical frame (75L), while the socket (75B) is fixedly and directly coupled to a second (or third) vertical frame (75U), and then indirectly coupled to a rotor group (not shown in the figure).

When the rear rotors of the rotor group generate the lifts which are greater than those generated by the front rotors of the same rotor group, a vector sum of the lifts generated by the rotor group tends to have a growing horizontal component, and the rotor group and the tilting unit (70) are tilted in the tilted (i.e., forward) direction. As the socket (75B) gets tilted at greater angles as illustrated in Panel (B), an edge (75E) of the socket (75B) eventually comes into contact and is abutted by an edge of the ball (75A), and the socket (75B) cannot be tilted beyond that tilting angle.

It is noted in the tilting unit (70) of Panel (B) has the same tilting range in the θ direction for all angles in the φ direction. Due to limitations in installation space, stability during cruising or turning around operations or other design objectives or considerations, a need may arise to restrict the tilting range in one tilted direction or in multiple tilted directions.

To this end, various stopper may be incorporated into the tilting units and limit the tilting range of the tilting units. Panel (C) is a first example of such a stopper, where the edge (75E) of the socket (75B) may be trimmed in different lengths or heights. Due to such asymmetrical geometry, the tilting unit (70) may have a greater tilting range in the θ direction of, but may have a less tilting range in the −θ direction.

In the alternative, the ball (75A) may include on a certain location on its surface at least one stopper (75P) which corresponds to a protrusion or a projection which bulges from a surface of the ball (75A) in an outward direction. Due to the presence of such a stopper (75P), the smaller tilting range of the tilting unit (70) in the direction of −θ can be decreased even further.

Instead of or in conjunction with the stopper, the multi-rotor aircraft can include at least one stopper which has a shape of an obstructing object and which is disposed on or around the tilting unit for limiting the tilting range of the tilting unit.

FIG. 33 is a cross-sectional view of a multi-rotor aircraft which positions obstruction-type stoppers (78A), (78B) around a mechanical joint-type tilting unit (70), where a rotor group (50) corresponds to the one exemplified in FIGS. 14 to 16 and where a ball-socket joint-type tilting unit (70) is selected as the mechanical joint-type tilting unit only for illustration purposes.

As shown in the figure, a first obstruction (78A) is disposed near the front of the aircraft, whereas a second obstruction (78B) is disposed near the rear of the aircraft. When the rear rotors (52R) generate the lifts greater than those generated by the front rotors (52F), the rotor group (50) is tilted in the forward direction.

However, as the rpm of the rear rotors (52R) increases further and the rotor group (50) begins to tilt at a greater angle, a second horizontal frame (34) comes into contact with the first obstruction (78A), and cannot tilt anymore in the forward direction. As a result, the obstruction (78A) can limit the tilting range of the rotor group (50).

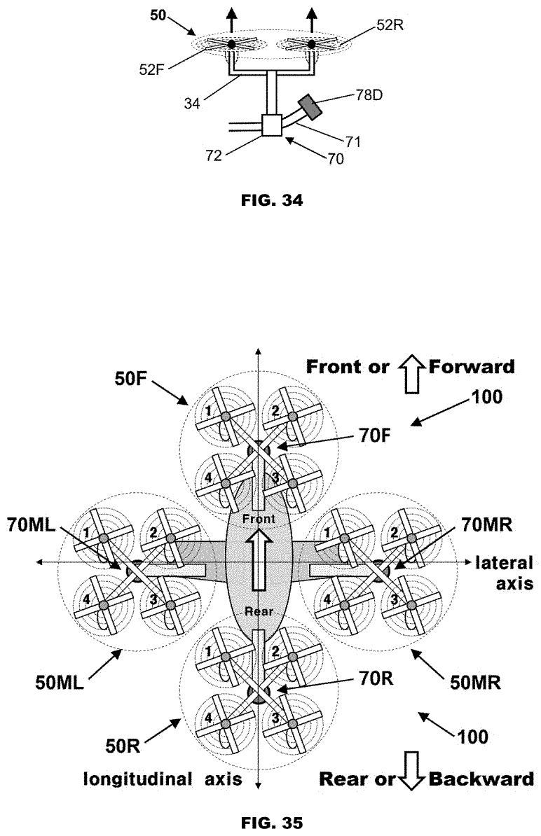

FIG. 34 is a cross-sectional view of a multi-rotor aircraft which places an obstruction (78D) along a path of a path-dependent tilting unit (70), where a rotor group (50) corresponds to the one exemplified in FIGS. 17 and 18, while the tilting unit (70) is a path-dependent type.

As shown in the figure, a third obstruction (78D) is disposed at the end of a path (71). When the rear rotors (52R) generate the lifts greater than those generated by the front rotors (52F), the rotor group (50) is tilted in the forward direction as a roller (72) moves in the backward direction.

However, when the rpm of the rear rotors (52R) increases further and the rotor group (50) translates over a longer distance in the forward (or tilting) direction, the roller (72) comes into contact with the third obstruction (78C), and cannot translate anymore in the forward direction. As a result, the obstruction (78C) can limit the tilting range of the tilting unit (70) as well as the tilting range of the rotor group (50).

### 4-3. Variations or Modifications

The third exemplary embodiment of the fourth aspect of this disclosure relates to variations or modifications of various configurations and methods for selecting tilting ranges of various rotor groups or tilting units, limiting such tilting angles, or the like. Followings are some exemplary variations or modifications of such configurations or methods.

In the first example of this third exemplary embodiment, a designer or manufacturer can select such tilting ranges in each of multiple directions depending upon various factors examples of which may include, but not limited to, a desired maximum cruising speed, a desired maximum or minimum tilting angles or ranges of certain rotor groups capable of generating the maximum cruising speed, physical limitations in such tilting angles or ranges due to physical dimensions or positions of various parts of the aircraft, and the like.

In the second example of this third exemplary embodiment, when the rotor groups or tilting units can tilt in two directions such as, e.g., in θ and φ directions, such directions are the directions which may be orthogonal to each other. However, such tilting angles and tilting ranges may also be defined in two or more directions which may not necessarily be orthogonal to each other.

In the third example of this third exemplary embodiment, the stoppers for limiting the tilting ranges of the tilting units and rotor groups coupled thereto can have the shapes or sizes which are different from those exemplified in this Section 3.

Such stoppers may be incorporated into one or more locations of the tilting units or may be incorporated into one or more locations of the multi-rotor aircraft, while not directly coupled to the tilting units. When desirable, the stoppers may be installed such that a mechanic or a pilot may adjust the positions or orientations of such stoppers.

In the fourth example of this third exemplary embodiment, various obstructions for limiting the tilting ranges of the rotor groups can have the shapes or sizes which are different from those exemplified in this Section 3. Such obstructions may be incorporated into one or more locations of the wing, body or frame of the aircraft, or may be incorporated into one or more locations of the tilting units, while not directly coupling with the wing, body or frame of the aircraft.

It is noted that one feature of a certain embodiment or example of this fourth aspect of this disclosure [1] may be applied to, [2] may be incorporated into, [3] may replace, [4] may be replaced by, or [5] may be combined, with a corresponding feature of another embodiment or example of this fourth aspect, as long as such application, incorporation, replacement, or combination does not contradict each other.

It is also noted that one feature of this fourth aspect of this disclosure [1] may be applied to, [2] may be incorporated into, [3] may replace, [4] may be replaced by, or [5] may be combined with, a corresponding feature of another aspect of this disclosure, as long as such application, incorporation, replacement, or combination does not contradict each other.

### 5. Fifth Exemplary Aspect—Positioning Tiltable Rotor Groups

The fifth exemplary aspect of this disclosure relates to the tilting units which are installed in various locations of the multi-rotor aircraft in various arrangements or orientations which may be different from those of the four-quadcopter as exemplified in FIGS. 6 to 8 and FIGS. 11 to 13.

In the first exemplary embodiment of this fifth aspect of this disclosure, a multi-rotor aircraft (100) such as, e.g., a four-quadcopter, may include four rotor groups which may be installed in different arrangements. Any number of tilting units of the same type of different types may be incorporated in different arrangements, depending on the shapes, sizes or arrangements of the aircraft and their rotor groups.

FIG. 35 is a top view of a multi-rotor aircraft (100) including four rotor groups (50F), (50ML), (50MR), (50R) which are similar to that of FIG. 11. However, contrary to those rotor groups of FIG. 11 which are arranged in the vertices of a “rectangle,” the rotor groups (50) of this aircraft (100) are arranged in the vertices of a “rhombus” or in the shape of a “+” or a “cross.”

The aircraft (100) includes four tilting units (70F), (70ML), (70MR), (70R) which are similar or identical to those exemplified in FIGS. 6 to 8 but which are also disposed in the shape of a “+” or a cross. It is noted in the figure that the arrangement of the rotor groups (50) is identical or similar to that of the tilting units (70).

It is noted, however, that the arrangement of the rotor groups (50) does not determine the arrangement of the tilting units (70). In other words, depending on the shapes, sizes or locations of various frames, a tilting unit may be coupled to a rotor group in such a way that the tilting unit is disposed [1] in a center of the rotor group, [2] in a center of not the rotor group but a certain rotor, [3] on one edge of the rotor group, or the like.

In addition, the aircraft (100) may include [1] different number of tilting units at the junctions of various frames which may be different from those junctions exemplified in FIGS. 13 to 16, [2] other tilting units installed in different arrangements such as those exemplified in FIGS. 24 to 28, or [3] the tilting units of different types such as, e.g., the path-dependent tilting unit or the bearing-type tilting unit.

It is appreciated that a different arrangement can be used for the aircraft (100) of FIG. 35 so that the aircraft may have a different shape of a cross which includes more rotor groups (or tilting units) along the longitudinal axis than the lateral axis or vice versa. The aircraft may instead include other even numbers (e.g., two, six, eight, or the like) of rotor groups (or tilting units) which may be installed in various strategic locations of the aircraft.

Accordingly, the number of tilting units which the aircraft includes may depend upon the number of rotor groups of the aircraft. In addition, the installation location or arrangement of the tilting units may also depend on the number, the installation location or arrangement of the rotor groups, not to mention a desired maximum cruising speed, travel distance, turning radius, or the like.

It is appreciated, however, that including more tilting units per a given number of rotor groups makes each tilting unit coupled to a smaller number of rotor groups. Accordingly, the multi-rotor aircraft of this configuration may allow its control unit to manipulate various operations of the aircraft more precisely, probably at the cost of a need for a more complex control algorithm.

It is noted that the exemplary multi-rotor aircrafts include multiple rotor groups each of which in turn include the same number of rotors. However, the aircraft may include multiple rotor groups at least one of which may include more rotors than other rotor groups.

In addition, one rotor group may be coupled to two tilting units such that, e.g., the rotor group includes four rotors, a first tilting unit is coupled to two rotors, and a second tilting unit is coupled to the remaining two rotors. In contrary and as shown in the above figures, one tilting unit may be coupled to multiple rotor groups.

In the second exemplary embodiment of this fifth aspect of this disclosure, a multi-rotor aircraft (100) may include an odd number of rotor groups (50F), (50RL), (50RR) each of which may include an arbitrary number of rotors.

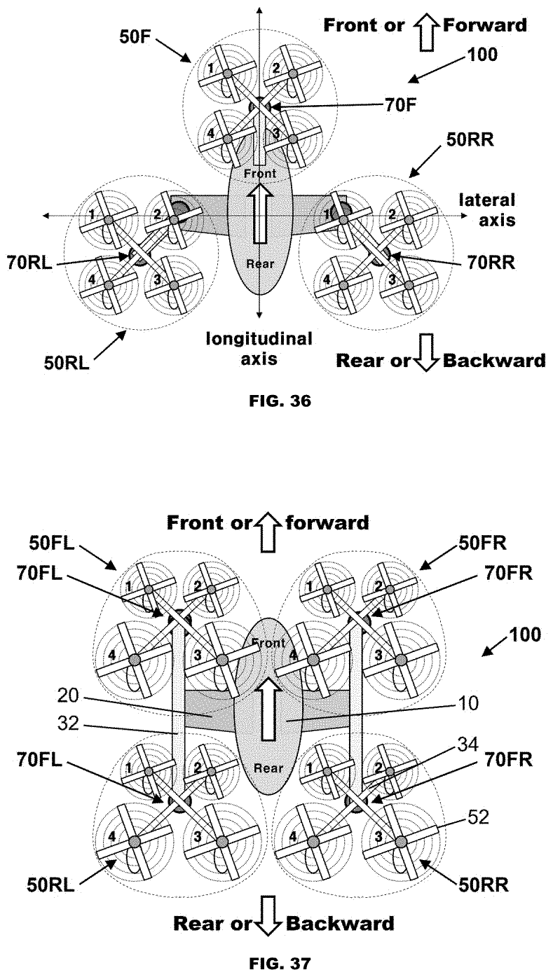

FIG. 36 is a top view of another multi-rotor aircraft (100) including three rotor groups (50F), (50RL), (50RR) each of which includes four identical rotors. In particular, one rotor group (50F) is installed in the front of the aircraft (100), and a pair of rotor groups (50RL), (50RR) are symmetrically installed with respect to a longitudinal axis of the aircraft (100), in the rear of the aircraft (100).

The aircraft (100) includes three tilting units (70F), (70RL), (70RR) each of which is responsible for tilting each rotor group (50F), (50RL), (50RR), respectively. The aircraft (100) [1] may instead include different number of tilting units which are installed in the junctions of various frames, where the junctions may be different from those exemplified in FIGS. 14 to 16, [2] may include other tilting units installed in different arrangements which may be different from those exemplified in FIGS. 24 to 28, or [3] may include the tilting units of different types such as, e.g., the path-dependent tilting unit or the bearing-type tilting unit.

It is noted that a different arrangement can be used for the aircraft (100) of this figure such that the aircraft has two rotor groups (or tilting units) in the front and the remaining rotor group (or tilting unit) in the rear. In addition, the aircraft may include other odd numbers (e.g., five, seven, nine, or the like) of rotor groups (or tilting units) which may be installed in various strategic locations of the aircraft.

Accordingly, the number of tilting units which the aircraft includes may depend upon the number of rotor groups of the aircraft. In addition, the installation location or arrangement of the tilting units may also depend upon various factors mentioned in conjunction with FIG. 35.

In the third exemplary embodiment of this fifth aspect of this disclosure, a multi-rotor aircraft (100) may include any number of rotor groups, where each rotor group may include the same or different number of rotors, or where at least one of the rotor groups include rotors of different shapes or sizes.

FIG. 37 is a top view of a multi-rotor aircraft (100) which includes four rotor groups (50FL), (50FR), (50RL), (50RR) which are similar to that of FIG. 11, where each of such rotor groups (50) includes rotors of different sizes.

For example, each rotor group (50) has four rotors, where two rear rotors (rotors 3 and 4) are bigger than two front rotors (rotors 1 and 2). This configuration is beneficial to cruising in a forward direction, for such rear rotors can generate the lifts of greater amplitudes.

Alternatively, the rotors (50) of the rear rotor groups (50RL), (50RR) have the same shape and size, and the rotors (50) of the front rotor groups (50FL), (50FR) have a size which is smaller than that of the rotors (50) of the rear rotor groups, or the like.

Similar to other embodiments of this fifth aspect of this disclosure, the number of tilting units which the aircraft includes may depend on the number of rotor groups of the aircraft. In addition, the installation location or arrangement of the tilting units may depend upon the number, the installation location or arrangement of the rotor groups, not to mention a desired maximum cruising speed, travel distance, turning radius, or the like.

The fourth exemplary embodiment of this fifth aspect of this disclosure relates to variations or modifications of the above three exemplary embodiments.

In the first example of this fourth exemplary embodiment, each rotor group may include the same or different number of rotors, where the exact number depends on various factors such as, e.g., a space available for that rotor group, a shape or a size of each rotor, a maximum (magnitude of the sum of the) lifts to be generated by the rotor group, or the like.

In the second example of this fourth exemplary embodiment, a designer or manufacturer may select [1] how many rotor groups to be included in the aircraft, [2] how many rotors to be included in each of such rotor groups, [3] whether or not the rotors of a certain rotor group have the same shape or size, [4] whether or not the rotor groups have the same number of rotors, or [5] where to install such rotor groups.

To this end, a designer or a manufacturer may consider various design or manufacturing considerations such as, e.g., a shape of the aircraft, a weight of the aircraft, a minimum or maximum number of passengers including pilots, a desired maximum cruising speed, a desired travel distance, a desired turning radius, or the like.

In the third example of this fourth exemplary embodiment, the rotors of the rotor groups may have the sizes which may increase or decrease in a direction along a longitudinal axis, a lateral axis, or a diagonal axis of a multi-rotor aircraft.

For ease of illustration, as used herein, a “row” of rotors refers to those rotors which are arranged parallel to or along a lateral axis of the aircraft, whereas a “column” of rotors mean those rotors which are arranged parallel to or along a longitudinal axis of the aircraft.

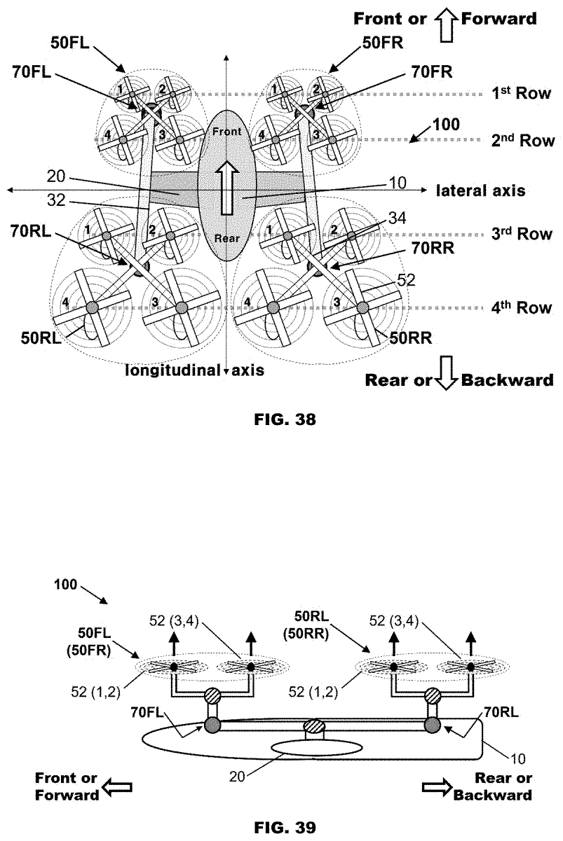

FIG. 38 is a top view of a multi-rotor aircraft (100) having a shape of a four-quadcopter, where sizes of rotors (52) of multiple rotor groups (50) increase in a direction from a front of the aircraft to a rear thereof, along a longitudinal axis thereof.

As shown in the figure, the size of the rotors increases from the first row to the second row, then to the third row, and then to the fourth row. This configuration may be beneficial such that turbulence created by the rotors of the first row can have minimal effects on the rotors of the second, third, fourth row, and the like.

Alternatively, the size of the rotors may [1] decrease in the direction from the first row to the fourth row, [2] decrease from the left-most (or right-most) column of rotors to the right-most (or left-most) column of rotors, [3] decrease from the rotors in the front-right (or front-left) corner to the rotors in the rear-left (or rear-right) corner, [4] decrease from the first column of rotors to the second column, then increase from the third column to the fourth column, or the like.

In the fourth example of this fourth exemplary embodiment, the rotors of the rotor groups may have the heights which may increase or decrease in a direction along a longitudinal axis, a lateral axis, or a diagonal axis of a multi-rotor aircraft.

In the fifth example of this fourth exemplary embodiment, the shape or size of the tilting unit may be varied based on the size of the rotors of a rotor group. That is, when the rotors of the rotor group are bigger (or smaller) than the rotors of other groups, that rotor group may be coupled to a bigger (or smaller) tilting unit.

In the sixth example of this fourth exemplary embodiment, multiple tilting units of the same or different types may be installed at or on various locations of the aircraft, where a manufacturer or designer may determine how many rotor groups are to be coupled to and to be tilted by a single tilting unit.

When the rotors of all of the rotor groups have the same size, the same number of rotor groups may be assigned to each tilting unit. When the rotors of some rotor groups have different sizes, a designer may assign a greater number of small rotors to one tilting unit, while assigning a smaller number of big rotors to another tilting unit.

When some tilting units have different sizes, a preset number of bigger rotors may be assigned to a bigger tilting unit, while the same number of smaller rotors may be assigned to the smaller tilting unit.

Alternatively, a designer or a manufacturer can estimate a maximum amplitude of a vector sum of the lifts which a certain tilting unit can handle. Based thereon, the designer can estimate how many rotor groups the tilting unit can handle, and then install the tilting units accordingly.

In the seventh example of this fourth exemplary embodiment, multiple tilting units may be arranged to have the same or different tilting ranges (or directions). For example, all tilting units can be tilted within the same tilting range and in the same direction. In another example, the front (or rear) tilting unit may be tilted over a wider tilting range (or in more directions) than the rear (or front) tilting unit.

In the eighth example of this fourth exemplary embodiment, those configurations or methods related to various rotor groups, tilting units, and others illustrated from the first aspect to the fourth aspect of this disclosure can be applied to various configurations or related methods which are illustrated in this fifth aspect.

It is noted that one feature of a certain embodiment or example of this fifth aspect of this disclosure [1] may be applied to, [2] may be incorporated into, [3] may replace, [4] may be replaced by, or [5] may be combined, with a corresponding feature of another embodiment or example of this fifth aspect, as long as such application, incorporation, replacement, or combination does not contradict each other.

It is also noted that one feature of this fifth aspect of this disclosure [1] may be applied to, [2] may be incorporated into, [3] may replace, [4] may be replaced by, or [5] may be combined with, a corresponding feature of another aspect of this disclosure, as long as such application, incorporation, replacement, or combination does not contradict each other.

### 6. Sixth Exemplary Aspect—Heights of Tiltable Rotor Groups

The sixth exemplary aspect of this disclosure relates to a multi-rotor aircraft which include multiple rows of rotor groups, where the rotors of different rows may have the same or different heights (or elevations). Depending on detailed fluid dynamics near or around the rotor groups during hovering or cruising, a desired cruising speed, a desired turning radius, or the like, such rotor groups may be installed to have the identical or different heights.

In the first exemplary embodiment of this sixth aspect of this disclosure, all of the rotor groups may be installed in the same height (or elevation) from a horizontal plane. That is, the rotors of the rotor groups may form a rotor plane which is parallel to a horizontal plane.

A height or an elevation of a certain rotor refers to a distance between the top of the rotor (or rotor plane) and the horizontal plane. Therefore, the height of a certain rotor may be identical to of different from a vertical length of a frame(s) which couple that rotor to a wing or a body of the aircraft.

Alternatively, all rotor groups are installed to lie in the same plane during hovering, where the plane may form a non-zero angle with respect to the horizontal plane. That is, the rotors of the rotor groups may form a rotor plane which forms the non-zero angle with respect to the horizontal plane.

FIG. 39 is a cross-sectional view of a multi-rotor aircraft which has a shape of a four-quadcopter, where all rotors (52 (1)), (52 (2)), (52 (3)), (52 (4)) of the rotor groups (50FL), (50FR), (50RL), (50RR) may have the same height or elevation with respect to a horizontal plane. The aircraft includes a pair of tilting units (70FL), (70RL) on the left side of the body (10), and another pair of tilting units (not shown in the figure) on the right side of the body (10).

This configuration offers several advantages such as, e.g., a simple manufacture and installation, a simple packaging during transportation due to a compact volume of the aircraft, a smaller space for parking, or the like.

However, this configuration may suffer from a few inherent drawbacks. For example, when the aircraft moves in the forward direction, turbulence created by the front rotor groups (50FL), (50FR) may adversely affect fluid dynamics around the rotors (52) of the rear rotor groups (50RL), (50RR) such that the rear rotor groups (50RL), (50RR) may not be able to generate their maximum lifts. In addition, a gust of strong wind may easily affect all rotor groups (50) disposed at the same elevation relatively, thereby adversely affecting the stability of the aircraft (100).

In the second exemplary embodiment of this sixth aspect of this disclosure, the rotor groups may be installed in such a way that the rotors of the rear rotor groups are installed at higher elevations than the rotors of the front rotor groups with respect to a horizontal plane.

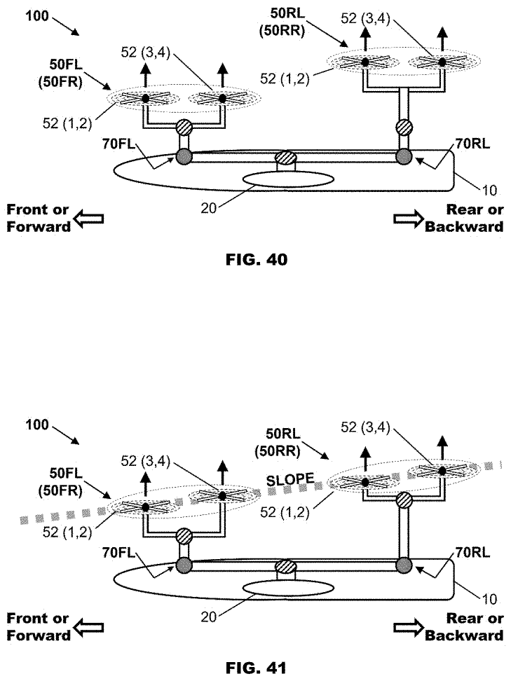

FIG. 40 is a cross-sectional view of a multi-rotor aircraft which is similar to that of FIG. 39, but the rotors (52 (1)) to (52 (4) of the rear rotor groups (50RL), (50RR) are installed at the higher elevations than those of the front rotor groups (50FL), (50FR).

Compared with the configuration of FIG. 39, this configuration may offer the benefit that the adverse effects caused by the turbulence created by the front rotor groups (50FL), (50FR) on the rotors (52) of the rear rotor groups (50RL), (50RR) may be reduced.

In addition, because those rotors (52) are disposed in two different elevations, not all rotors may be subjected to the adverse effects from a gust of strong wind at the same time. Accordingly, this configuration may provide an improved stability against the external disturbances than the configuration of FIG. 39.

In the third exemplary embodiment of this sixth aspect of this disclosure, the rotor groups are installed in such a way that the rotors of the rotor groups are installed at increasing elevations, e.g., from the first row of rotors to the fourth row of rotors.

FIG. 41 is a cross-sectional view of a multi-rotor aircraft similar to that of FIG. 40, where the rotors of each row are installed at an increasing elevation along a hypothetical line which is denoted by a thick dotted line and which is designated as “slope” in the figure.

Compared with the configuration of FIG. 40, this configuration may further enhance the benefit that the rotors of the rear rotor group may be minimally affected by the turbulence created by the rotors of the front rotor group. Depending upon the differences in elevations of the rotors in different rows along the longitudinal axis, the adverse effects caused by the turbulence may be further minimized.

It is noted that the “slope” shown in the figure may be a straight line having a positive slope, where “positive” means that the height or elevation of the rotors increases in a direction from the front to the rear of the aircraft. It is also noted that the “slope” may not have to be a straight line, but rather a curve which is convex upward or downward.

It is also noted that the “slope” may be provided not along the longitudinal axis (as exemplified in FIG. 41) but along the lateral axis. Referring to FIGS. 11, 37, and 38, for example, the first and fourth rotors (52 (1)), (52 (4)) of the left rotor groups (50FL), (50RL) may have a greater heights or elevation than the second and third rotors (52 (2)), (52 (3)) of the same left rotor groups, whereas the second and third rotors (52 (2)), (52 (3)) of the right rotor groups (50FR), (50RR) may have a greater heights or elevation than the first and fourth rotors (52 (1)), (52 (4)) of the same right rotor groups.

In the fourth exemplary embodiment of this sixth aspect of this disclosure, a multi-rotor aircraft may have at least one rotor group which may be manipulated to move in an upward, downward or slanted direction. That is, the height or elevation of the rotors of such a rotor group may be varied by a mechanic, a pilot, a control unit of the aircraft, or the like.

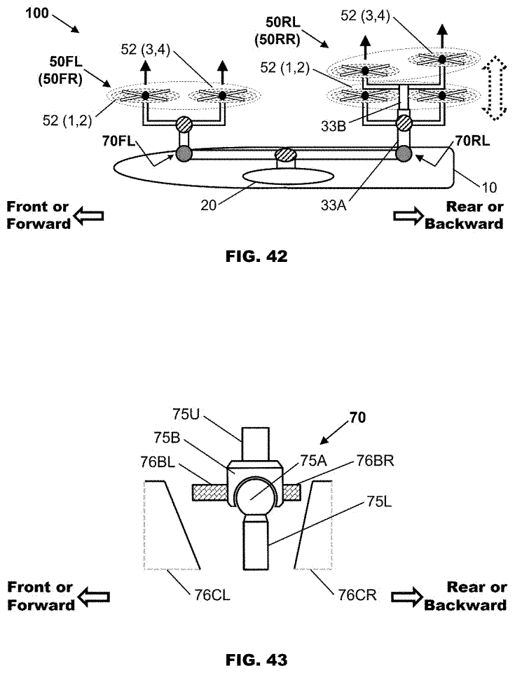

FIG. 42 is a cross-sectional view of a four-quadcopter-shaped multi-rotor aircraft which includes the rear rotor groups of which the heights or elevations may be manipulated. For example, the aircraft (100) may include an actuator which can manipulate a height or an elevation of the rear rotor groups (50RL), (50RR). When desirable, the actuator may be arranged to individually manipulate a height or an elevation of at least one rotor of the rear rotor groups (50RL), (50RR).

Various prior art mechanisms may be employed to change the height or elevation of the rotor or the rotor group. For example, a second vertical frame (33) may include an annular lower vertical frame (33A) and a upper vertical frame (33B), where the upper vertical frame (33B) can slide inside a hole formed inside the lower vertical frame (33A). Accordingly, the heights or elevations of the rotors (52) of the rear rotor groups (50RL), (50RR) can be adjusted as the upper vertical frame (33B) slides in an upward or downward direction.

It is noted that the above manipulation of the height or elevation of a certain rotor or a certain rotor group is different from manipulating the height or elevation of the rotor or rotor group due to tilting. Therefore, to actively manipulate the height or elevation of the rotor or rotor group, the multi-rotor aircraft may include an actuator and may have to supply electric energy to the actuator.

To this end, the multi-rotor aircraft may include an additional electric motor which is devoted to adjusting the heights or elevations of the rotors or rotor groups. Alternatively, instead of including the additional electric motor, the multi-rotor aircraft may include a power transmission unit which is electrically or mechanically coupled to a certain rotor motor of a certain rotor group and which may use a portion of mechanical energy generated by the rotor motor in adjusting the heights or elevations of that rotor group.

The fifth exemplary embodiment of this sixth aspect of this disclosure relates to variations or modifications of the above three exemplary embodiments.

In the first example of this fifth exemplary embodiment, the “slope” may be defined not along the longitudinal axis but along a lateral axis of the aircraft. Alternatively, the “slope” may be defined along a diagonal or other lines drawn across the aircraft. Thus, a designer or a manufacturer may adjust the heights or elevations of each rotor of each rotor group of the multirotor aircraft depending on various design objectives or considerations.

In the second example of this fifth exemplary embodiment, the “slope” may be not a straight line but a curve. Accordingly, the “slope” may be a curve [1] which may be convex upward or downward, [2] which may have multiple inflection points, or the like.

Contrary to the “slope” which is either an one-dimensional line or a two-dimensional plane, the “slope” may be defined as a three-dimensional plane the characteristics of which may also be determined depending upon various design objectives or considerations.

In the third example of this fifth exemplary embodiment, the “slope” may be a curve or a collection of line segments which may be [1] symmetric with respect to the longitudinal axis of the aircraft, [2] symmetric with respect to the lateral axis thereof, [3] asymmetric, or the like.

In the fourth example of this fifth exemplary embodiment, a designer or a manufacturer may install the rotor groups at different heights or elevations as he sees fit, depending upon the detailed shapes, sizes or dispositions of the rotors and their rpms, as long as such heights or elevations may minimize the adverse effects on a certain rotor group, where such adverse effects are caused by another rotor group disposed near the front of the aircraft.

It is noted that one feature of a certain embodiment or example of this sixth aspect of this disclosure [1] may be applied to, [2] may be incorporated into, [3] may replace, [4] may be replaced by, or [5] may be combined, with a corresponding feature of another embodiment or example of this sixth aspect, as long as such application, incorporation, replacement, or combination does not contradict each other.

It is also noted that one feature of this sixth aspect of this disclosure [1] may be applied to, [2] may be incorporated into, [3] may replace, [4] may be replaced by, or [5] may be combined with, a corresponding feature of another aspect of this disclosure, as long as such application, incorporation, replacement, or combination does not contradict each other.

### 7. Seventh Exemplary Aspect—Adding Dynamics to Tilting Units

The seventh exemplary aspect of this disclosure relates to a multi-rotor aircraft which manipulates tilting movements of the tilting units or rotor groups with at least one bumper which may include at least one elastic element, viscous element, viscoelastic element, or shock-absorbing element such that the bumper can absorb or release at least a portion of mechanical energy associated with the tilting movements.

More particularly, when the tilting unit approaches its upper bound or lower bound of its tilting ranges, the moving element of the tilting unit contacts or collides with the stationary element of the tilting unit, or the moving element may bump the stoppers or the confining objects which have been explained in Section 4-2. As a result, the tilting unit may make a sudden stop, and the rotor groups coupled to the tilting unit may have to make a similar sudden stop.

This sudden stop may result in a bump or a shock which may adversely affect the passengers, and various moving elements of the tilting unit may suffer mechanical damages. To alleviate this problem, a multi-rotor aircraft may include at least one bumper which may exhibit [1] an elastic response, [2] a viscous response, [3] a viscoelastic response, or [4] a shock absorption.

In the first exemplary embodiment of this seventh aspect of this disclosure, a multi-rotor aircraft may include an elastic bumper, a viscous bumper, or a viscoelastic bumper in or near a tilting unit so that the bumper can absorb at least a substantial portion of mechanical energy which is generated by the tilting unit or the rotor group when the tilting unit reaches its upper or lower bound of the tilting range or when the rotor group similarly reaches its upper or lower bound of its own tilting ranges.

As a result, the bumper can give an easy maneuvering ability to the aircraft, can give a riding comfort to its passengers, and can protect the moving or stationary elements of the tilting unit as well as the rotors or the rotor group from mechanical damages.

It is noted that the following examples illustrate various exemplary bumpers which may be disposed in or around the tilting units and which can absorb at least a portion of mechanical energy which is generated by the tilting units.

However, the same examples may be applied to the rotors or rotor groups such that the bumper can absorb at least a portion of mechanical energy which is generated by the rotors or rotor groups when they reach the upper or lower bound of their own tilting ranges.

In the first example of this third exemplary embodiment, various bumpers may be incorporated into a moving element of a tilting unit. Although following examples center around a ball-socket joint-type tilting unit, the same configuration may be applied to [1] the tilting units employing different joints, [2] the path-dependent tilting units, or [3] the bearing-type tilting units.

FIG. 43 is a cross-sectional view of a ball-socket joint-type tilting unit including at least one bumper capable of absorbing a portion of mechanical energy associated with sudden bump or shock caused by a tilting unit which reaches an upper or lower bound of its tilting range.

As explained above, a typical ball-socket joint-type tilting unit (70) includes a ball (75A) as well as a socket (75B) shaped and sized to receive the ball (75A) therein. The ball (75A) may be fixedly and directly coupled to a lower arm (75L) of the tilting unit (70), whereas the socket (75B) may be fixedly and directly coupled to an upper arm (75U) of the tilting unit (70), and may then be indirectly coupled to at least one rotor group.

As illustrated in the figure, two bumpers (76BL), (76BR) are installed on opposing sides of the socket (75B), and two structures (76CL), (76CR) are respectively provided adjacent to the bumpers (76BL), (76BR). The bumpers (76BL), (76BR) may be made of or include a prior art material such as a rubber, plastics, or other materials capable of absorbing mechanical energy of the impact or shock which is generated when the upper arm (75U) is tilted and reaches the structures (76CL), (76CR).

The structure (76CL), (76CR) may be any stationary article which may not move when the tilting unit (70) is tilted. Examples of such structures (76CL), (76CR) may include a frame, a wing of an aircraft, a body of the aircraft, or other objects which can stop a rotation or a movement of the upper arm (75U). The tilting unit (70) may be tilted within its tilting range, a, where, e.g., +60°≤α≤−30°, where “+” means a forward direction, and where “−” means a backward direction.

As the tilting unit (70) is tilted in a counter-clockwise direction and approaches its left bound (e.g., 60°), the left bumper (76BL) contacts the left structure (76CL). Even when the tilting unit (70) hits the left bumper (76BL) at a substantial speed, the rubber or elastic plastic (77BL) absorbs mechanical energy of the bump or shock.

When the tilting unit (70) tilts in a clockwise direction and approaches its right bound (e.g., −30°), the right bumper (76BR) contacts the right structure (76CR), and the right bumper (76BR) can absorb the mechanical energy of a bump or shock.

Accordingly, the bumpers (76BL), (76CL) can provide the passengers with comfortable ride and can protect the moving or stationary element of the tilting unit (70) from mechanical damages.

When desirable, two bumpers may be made of or include materials which may not be able to absorb mechanical energy. In this case, two surrounding structures may be made of or include those materials which may absorb mechanical energy. Alternatively, both the bumpers and the structures may be made of or include those materials capable of absorbing mechanical energy.

It is noted that the distance between the left structure (76CL) and the left bumper (76BL) is greater than the distance between the right structure (76CR) and the right bumper (76BR). Accordingly, such a tilting unit (70) can be tilted up to 60° in the forward direction, but only up to 30° in the backward direction. Accordingly, simply by adjusting the shape, size or location of the bumper and structure or by adjusting the distance between the bumper and structure, a designer or a manufacturer can not only adjust the tilting ranges of the tilting unit, but also absorb a desired amount of mechanical energy associated with the bump or shock.

In the second example of this third exemplary embodiment, various bumpers may also be positioned not on a moving element of a tilting unit but on a stationary element of the tilting unit or on an object which is not a part of the tilting unit. Following examples illustrate such configurations implemented into a ball-socket joint-type tilting unit. However, the same can be applied to [1] the tilting units which employ different joints, [2] the path-dependent tilting units, or [3] the bearing-type tilting units.

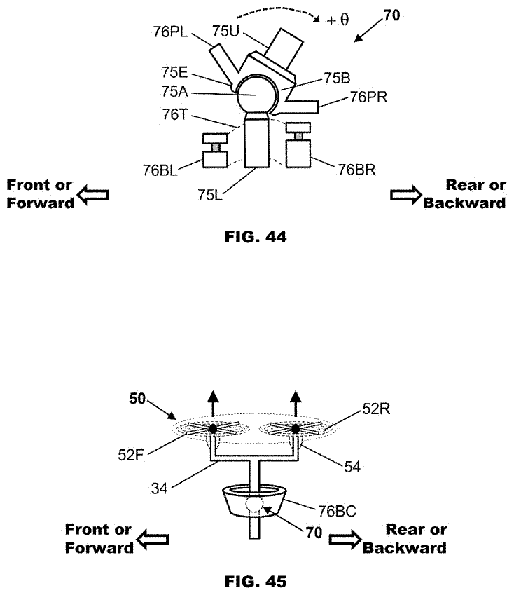

FIG. 44 is a cross-sectional view of a ball-socket joint-type tilting unit including at least one bumper capable of absorbing mechanical energy associated with a sudden bump or shock caused by a tilting unit which reaches an upper bound or a lower bound of its tilting range.

As shown in the figure, the socket (75B) includes two protrusions (76PL), (76PR), and two bumpers (76BL), (76BR) are installed on opposing sides of a lower arm (75L) of a tilting unit (70). More particularly, the bumpers (76BL), (76BR) may exhibit [1] purely elastic property, [2] purely viscous property, [3] viscoelastic property, [4] shock absorbing property, or the like.

To this end, the bumpers (76BL), (76BR) may employ at least one prior art spring, dash-pot, rubber, or at least two of such.

For ease of illustration, assume that the tilting unit (70) may be tilted within its tilting range, α, where +60°≤α≤−30°. As the tilting unit (70) is tilted in a clockwise direction and approaches its right bound (e.g., −30°) of the tilting range, the right protrusion (76PR) contacts the right bumper (76BR). Even when the tilting unit (70) hits the right bumper (76BR) hard, the viscous right bumper (76BR) absorbs mechanical energy associated by such a bump or shock.

In addition, as the tilting unit (70) is tilted in a counter-clockwise direction and reaches its left bound (e.g., 60°), the left protrusion (76PL) hits the left bumper (76BL), and the viscous left bumper (76BL) absorbs mechanical energy associated with the bump or shock while changing its length gradually. Thus, the bumper (76BL) provides riding comfort to the passengers, while protecting the tilting unit (70) from mechanical shock.

It is noted that the right bumper (76BR) is installed at an elevation which is greater than that of the left bumper (76BL). Accordingly, the tilting unit (70) can be tilted up to only 30° in a backward direction, while up to 60° in the forward direction.

A designer or manufacturer may select suitable shapes, sizes, positions or damping characteristics of such viscous bumpers (76BL), (76BR), and may select suitable shapes or positions of such structures (76CL), (76CR). In addition, the designer may also select the separation distance between the bumpers (76BL), (76BR) and the protrusions (76PL), (76PR), where the separation distance on the left side may be the same as or different from that on the right side.

In the second exemplary embodiment of this seventh aspect of this disclosure, a multi-rotor aircraft may include an elastic bumper, a viscous bumper, or a viscoelastic bumper in or near a frame which couples to a rotor group such that the bumper can absorb mechanical energy caused by the tilting unit when the tilting unit reaches its upper or lower bound of the tilting ranges. Thus, the bumper can provide a riding comfort to the passengers as well as can protect the moving or stationary elements of the tilting unit from mechanical damages.

FIG. 45 is a cross-sectional view of a generic tilting unit (70) which is surrounded by at least one annular cone-shaped bumper (76BC) capable of absorbing mechanical energy from a sudden bump or shock which the tilting unit (70) generates when the tilting unit (70) reaches an upper bound or a lower bound of its tilting ranges.

Similar to other bumpers of FIGS. 43 and 44, the bumper (76BC) of this figure can absorb mechanical energy from the bump or shock. But a main difference of this bumper (76BC) is that it (76BC) may be disposed not around the tilting unit (70) but around the frame, and that the bumper (76BC) can absorb the mechanical energy from a shock using its three-dimensional structure.

For example, the bumper (76BC) may have a circular or oval cross-section, a triangular or another polygonal cross-section, or the like. In addition, the bumper (76BC) may have a height enough to contact the tilting unit (70) when the tilting unit (70) reaches the upper or lower bound in any direction which a designer or a manufacturer sees fit. As a result, this bumper (76BC) may not only serve to absorb the mechanical energy of the bump or shock, but also function as the stopper or the confining object as have been provided in Section 4-2.

The third exemplary embodiment of this seventh aspect of this disclosure relates to variations or modifications of the above two embodiments of this seventh aspect.

In the first example of this third exemplary embodiment, such bumpers may include at least one spring and at least one dashpot which are arranged in a series or parallel mode so that the bumpers may exhibit viscoelastic responses. As a result, such bumpers may exert the compression forces or tension forces. Because such responses are well known in the art, details of the viscoelastic bumpers and their responses are omitted herein.

In FIGS. 43 to 45, various bumpers are provided in various locations around the moving or stationary element of the tilting unit. However, a few bumpers may be provided around such elements in such a way that the bumpers may also function to limit the tilting ranges of the tilting units. Therefore, the second example of this third exemplary embodiment relates to various bumpers which can also be used as the stoppers or as the obstructions illustrated in conjunction with FIGS. 32, 33, and 34.

More particularly, the bumpers (76BC) are shaped or sized as an annular tube in which the tilting unit (70) or its joint may sit, as exemplified by dotted lines in FIG. 45. Accordingly, the moving elements of the tilting unit cannot be tilted beyond a two- or three-dimensional range which is defined by the inner walls of the bumpers. In this respect, such bumpers may serve the same function as the aforementioned stoppers or obstructions.

In the third example of this third exemplary embodiment, a designer or a manufacturer may install such bumpers not around the tilting units but around the rotors or rotor groups of the tiltable rotor groups. When desirable, such bumpers may be installed not only around the tilting units but also around the rotors or rotor groups of the tiltable rotor groups. As long as the bumper can absorb at least a substantial portion of mechanical energy generated by the moving element of the tilting unit, any number of bumpers can be installed in any desirable locations.

It is noted that one feature of a certain embodiment or example of this seventh aspect of this disclosure [1] may be applied to, [2] may be incorporated into, [3] may replace, [4] may be replaced by, or [5] may be combined, with a corresponding feature of another embodiment or example of this seventh aspect, as long as such application, incorporation, replacement, or combination does not contradict each other.

It is also noted that one feature of this seventh aspect of this disclosure [1] may be applied to, [2] may be incorporated into, [3] may replace, [4] may be replaced by, or [5] may be combined with, a corresponding feature of another aspect of this disclosure, as long as such application, incorporation, replacement, or combination does not contradict each other.

### 8. Eighth Exemplary Aspect—Control Algorithms

The eighth exemplary aspect of this disclosure relates to various control algorithms or control software which is suitable for controlling various tilting units and tiltable rotor groups of a multi-rotor aircraft of this disclosure. More particularly, this eighth exemplary aspect relates to various control algorithms or control software designed to control various operations of a multi-rotor aircraft such as, e.g., taking off, hovering, cruising, making turns, performing yaw rotations, landing, or the like.

For ease of illustration, the control algorithms and the control software are collectively referred to as the “control algorithms” in this disclosure.

It is appreciated that there may not be any single, all-purpose control algorithms capable of manipulating such operations of the multi-rotor aircrafts, their tilting units, their rotor groups or their load sharing units of this disclosure, for such control algorithms may typically take different forms depending upon the control objectives.

For example, when a higher cruising speed is the foremost control objective, the control algorithm may not have to deal with a sudden acceleration of the aircraft, an inertia felt by a passenger, and a resulting movement of a passenger in a cabin of the aircraft.

In the alternative, when the riding comfort of the passenger is the priority control objective, the control algorithm may have to minimize a sudden acceleration, a high inertia of movements, resulting discomfort of the passengers, or the like.

Followings are a few exemplary control algorithms for a multi-rotor aircraft of this disclosure. It is appreciated, however, that such control algorithm can be modified based on different control objectives, which are typically within the ability of a person of ordinary skill in the relevant art.

It is noted that various control algorithm of this disclosure may be embodied as a hardware 25 element. Accordingly and as used herein, a “control unit” of the multi-rotor aircraft of this disclosure refers to any software element or hardware element into which various control algorithms which have been described above and which will be explained below may be incorporated. Examples of such a hardware element may include [1] an electronic circuit, [2] a microchip, [3] an electric motor or a rotor, [4] a computer code, or the like.

The first exemplary embodiment of this eighth aspect of this disclosure relates to a first control algorithm for tilting the tiltable rotor groups for cruising. As described above, as the rear rotors of a certain rotor group begin to generate the lifts which are greater than those generated by the front rotors of the same rotor group, the rotor group may be tilted in a tilted direction, and a horizontal component of a vector sum of such lifts begins to have a growing amplitude. It is noted that the horizontal component is responsible for cruising (i.e., moving the aircraft in the forward direction).

The vector sum of such lifts also includes a vertical component which is responsible for keeping the aircraft afloat at the same altitude, pushing the aircraft up to a higher altitude, or pulling the aircraft down to a lower altitude.

As the rotor group is tilted, an amplitude of the horizontal component of the vector sum of such lifts can increase, at the cost of a decreasing amplitude of the vertical component of the vector sum of such lifts. This may cause the multi-rotor aircraft to lose the altitude.

However, by increasing the rpms of the rotors, the amplitude of the vertical component of the vector sum of such lifts may also increase, thereby maintaining the aircraft at the same altitude. By further increasing the rpms of such rotors, the aircraft may gain the altitudes, while the aircraft may lose its altitude when the amplitude of the vertical component of the vector sum of the lifts may be less that the weight load of the aircraft.

Various options exist for a designer or a pilot who wants to cruise (i.e., move in the forward direction) when he switches from hovering to cruising or when he changes a cruising speed from a lower speed to a higher speed (or vice versa). Such options may also be classified into two different options such as local options and global options, where the local options relate to manipulation of each rotor of that rotor group, while the global options relate to manipulation of each rotor group of the aircraft.

Examples of the local options for a certain rotor group may include, but not limited to, [1] increasing the rpm of the rear rotor(s) as well as the rpm of the front rotor(s), [2] increasing the rpm of the rear rotor(s) while rotating the front rotor(s) at the same rpm as was in hovering (to be referred to as the “hovering rpm”), [3] increasing the rpm of the rear rotor(s) while also decreasing the rpm of the front rotor(s) below the hovering rpm, [4] increasing the rpms of the rear rotor(s) and front rotor(s), while increasing the rpm of the rear rotor(s) more than the rpm of the front rotor(s), or the like.

In other words, as long as the control algorithm can manipulate the rear and front rotors such that a vector sum of the lifts generated by the front and rear rotors [1] begins to have a non-zero horizontal component, [2] maintains the non-zero horizontal component within a certain range, [3] has an increasing horizontal component, or the like, the control algorithm can manipulate the aircraft to move in the forward direction.

When the control algorithm can manipulate a vector sum of the lifts which are generated by the front and rear rotors of the above two paragraphs to have a non-zero horizontal component, a vertical component of the vector sum of such lifts may vary as well.

Thus, the software algorithm may manipulate the rpms of the rear and front rotors in such a way that, while the vector sum of the lifts can generate the above non-zero horizontal component, the vector sum of the lifts can also generate the vertical component of a desirable magnitude which can [1] maintain the aircraft at the hovering altitude, [2] increase its altitude, or [3] decrease its altitude.

When the rotors of the front and rear rotor groups may have different shapes, sizes or pitches, examples of the local options for a certain rotor group may include, but not limited to, [1] increasing the lift generated by the rear rotor(s) while maintaining the lift generated by the front rotor(s) as was in hovering, [2] increasing the lift generated by the rear rotor(s) while decreasing the lift generated by the front rotor(s), [3] increasing the lift generated by the rear rotor(s) and the lift generated by the front rotor(s), while increasing the lift generated by the rear rotor(s) more than the lift generated by the front rotor(s), or the like.

Examples of the global options for a certain multi-rotor aircraft may include, but not limited to, [1] manipulating the rpms of (or lifts generated by) such rotors of all tiltable rotor groups, [2] manipulating the rpms of (or lifts generated by) such rotors of some but not all tiltable rotor groups, or the like. Of course, exercising such global options may include at least one of the local options explained above.

As a result, finding the correct local options and global options which accomplish a desired cruising speed, a desired altitude, a desired turning radius, and a desired torque may translate into finding the desired rpms of (or lifts generated by) all the rotors of the multi-rotor aircraft of this disclosure. In the case of a four-quadcopter-type aircraft, it translates into finding a set of solutions about the rpms of 16 rotors. Such a system of equations for this problem may correspond to a consistent but underdetermined system, or an indeterminate system.

To find the solution of such a system of equations, a designer or a manufacturer may also introduce at least one additional constitutive equation which may be related to [1] the rpms of (or lifts generated by) different rotors of a certain rotor group, [2] the rpms of (or lifts generated by) different rotor groups of different groups, or the like.

An exemplary first constitutive equation may be a relation between the rpms of different rotor groups (or the lifts generated by different rotor groups) such that, e.g., [1] a first equation representing that the front rotors of each rotor group rotates at the first rpm, [2] a second equation that the rear rotors of the same rotor group may rotate at the second and higher rpm, [3] a third equation representing that the front rotors of each rotor group may generate the lifts of the first magnitude, [4] a fourth equation representing that the rear rotors of the same rotor group may generate the lifts of the second magnitude, or the like.

An exemplary constitutive equation may be other relations between the rpms of different rotor groups (or the lifts generated by different rotor groups) so that, e.g., [1] a fifth equation representing that the rpms of (or lifts generated by) the rear rotors of the rear rotor groups may be greater than those of the rear rotors of the front rotor groups by a certain percent, [2] a sixth equation representing that the certain percent explained in [1] of this paragraph is a dependent variable of an equation in which the desired cruising speed is an independent variable, or the like. As more constitutive equations are introduced, finding a solution set which includes the rpms of all 16 rotors may become easier.

It is noted that the nature of such constitutive equations may depend upon the control objectives as well. For example, another constitutive equation may require [1] that the body of the aircraft must remain at least substantially horizontal (e.g., an allowable deviation is within 5°), [2] that the turning radius must be a preset distance which may vary according to the cruising speed before making turns), [3] that an energy efficiency must be at least x miles per 10 kilo Joules, or the like.

It is appreciated that the strategy of introducing constitutive equations may be equally applicable to other rotor groups which may include different number of rotors, and that such strategies may also be equally applicable to other multi-rotor aircrafts which include different number of rotor groups.

The second exemplary embodiment of this eighth aspect of this disclosure relates to second control algorithm which may provide riding comfort to the passengers during acceleration (or deceleration), where the multi-rotor aircraft goes through such acceleration (or deceleration) during switching from hovering to cruising, during making turns, during taking off or landing, or the like.

Following examples focus upon the riding comfort during acceleration while making turns. However, similar algorithms may be developed and applied to other operations which give rise to such acceleration (or deceleration) in the forward, backward, upward or downward, or slanted direction.

As described above, a multi-rotor aircraft can perform a yaw rotation during hovering. However, when a pilot attempts to perform the yaw rotation during cruising, such an attempt ends up in a turn-around (or turning) operation due to the inertia of motion associated with the cruising at a certain cruising speed.

In addition, performing a turning operation during cruising inevitably generate a centrifugal force, and a passenger can feel his body thrown in the direction of the centrifugal force. Various control algorithm can be provided to minimize the discomfort of the passenger as well as to prevent the body of the passenger to be swept away.

In the first example of this second exemplary embodiment, various control algorithms can be provided by utilizing the concept of superelevation which is usually expressed as a decimal.

More particularly, superelevation represents a ratio of a pavement slope to a width of the pavement, and that ratio typically ranges from 0.04 to 0.12. Superelevation is used to allow a land aircraft to safely turn at high speeds and to keep the passengers comfortable.

Because most passengers of the multi-rotor aircrafts would also drive automobiles, they would be used to superelevation and superelevation rates of the roadway. Accordingly, adopting the same superelevation would provide familiar riding comfort to the passengers.

Details of the superelevation can be easily found and applied using numerous sources as follows:
(1) “Superelevation calculation” Department of Transportation, TN, USA (https://www.tn.gov/content/dam/tn/tdot/roadway-design/documents/training/Superelevation %20Calculation %20(new %20standard).pdf (last visit on Jun. 7, 2022)
(2) “How to calculate superelevation in road,” The Civil Engineering, (uploaded on Nov. 2, 2021) https://thecivilengineerings.com/how-to-calculate-superelevation-in-road-purpose-formula-methods/(last visit on Jun. 7, 2022)

In the second example of this second exemplary embodiment, various control algorithm can be provided by utilizing the adjustment based on centrifugal force. For example, based upon the user inputs such as the desired speed or direction during making turns, the aircraft can calculate a magnitude and a direction of a centrifugal force to be exerted on a passenger for the turning operation. Based thereon, the aircraft can also calculate how much it should tilt its body so that the aircraft may provide riding comfort to the passengers during the turning operation.

In the third example of this second exemplary embodiment, various control algorithm can be provided for other purposes as well. For example, a control algorithm may be provided to tilt a certain rotor or a certain rotor group using at least one tilting motor, where the tilting motor is different from the rotor motor as described. Of course, this control algorithm is useful when the multi-rotor aircraft may include at least one rotor or at least one rotor group which may be operated as the rotor of a prior art tiltrotor air vehicle.

Another control algorithm may be provided to manipulate the elevation of a rotor or rotor groups as exemplified in FIG. 42. For example, the control algorithm may manipulate an extra electric motor and move the rotor or rotor groups in an upward, downward or slanted direction, thereby adjusting such an elevation.

Alternatively, the control algorithm may manipulate a power transmission unit to divert mechanical energy generated by the rotor motor to manipulate the elevation of a rotor or rotor groups, Details of the power transmission are provided below.

Yet another control algorithm may be provided to manipulate various operations of the multirotor aircraft against the external disturbances. In general, such an algorithm may be constructed based on various control objectives.

Accordingly, when the external disturbances are acting on the aircraft and such disturbances are adverse to the control objectives, the control algorithm may be configured to [1] continue hovering while maintaining a current altitude against such disturbances, [2] continue hovering while maintaining the altitude but changing its orientation against such disturbances, [3] continue moving in a preset direction at a preset speed while maintaining the altitude against such disturbances, [4] continue moving in the preset direction while changing its speed or altitude against such disturbances, [5] continue moving at the preset speed while changing its direction or altitude against such disturbances, or the like.

Alternatively, when the external disturbances are favorable to the control objectives, the control algorithm may be configured to decrease the lifts generated by at least one rotor (or at least one rotor group) [1] while hovering and maintaining a current altitude using such disturbances, [2] while hovering and maintaining the altitude but changing its orientation using such disturbances, [3] while moving in a preset direction at a preset speed and maintaining the altitude using such disturbances, [4] while moving in the preset direction and changing its speed or altitude using such disturbances, [5] while moving at the preset speed and changing its direction or altitude against such disturbances, or the like.

It is noted that one feature of a certain embodiment or example of this ninth aspect of this disclosure [1] may be applied to, [2] may be incorporated into, [3] may replace, [4] may be replaced by, or [5] may be combined, with a corresponding feature of another embodiment or example of this ninth aspect, as long as such application, incorporation, replacement, or combination does not contradict each other.

It is also noted that one feature of this ninth aspect of this disclosure [1] may be applied to, [2] may be incorporated into, [3] may replace, [4] may be replaced by, or [5] may be combined with, a corresponding feature of another aspect of this disclosure, as long as such application, incorporation, replacement, or combination does not contradict each other.

### 9. Assisted Tilting Unit

The ninth exemplary aspect of this disclosure relates to a multi-rotor aircraft which may divert at least a portion of mechanical energy generated by at least one rotor motor of a rotor group and may use that portion of mechanical energy for purposes other than rotating the propellers of the rotors.

It is appreciated that this ninth embodiment focuses on an “assisted tilting unit” which may divert at least a portion of mechanical energy generated by a rotor motor to a guide and a power transmission unit in such a wat that at least one rotor or at least one rotor group can be tilted by the assisted tilting unit. As used herein, this configuration is to be referred to as an “assisted tilting.”

In the first exemplary embodiment of this ninth aspect, an assisted tilting unit may be fabricated and provided such that at least a portion of mechanical energy generated by a rotor motor may be diverted into tilting at least one rotor or at least one rotor group.

In the first example of the first exemplary embodiment, the assisted tilting unit is incorporated adjacent to a rotor motor, mechanically couples with the rotor motor, and divert at least a portion of mechanical energy generated by the rotor motor. Using this portion of the energy, the assisted tilting unit tilts a preset rotor group and an upper arm of a tilting unit with respect to a stationary lower arm of the tilting unit.

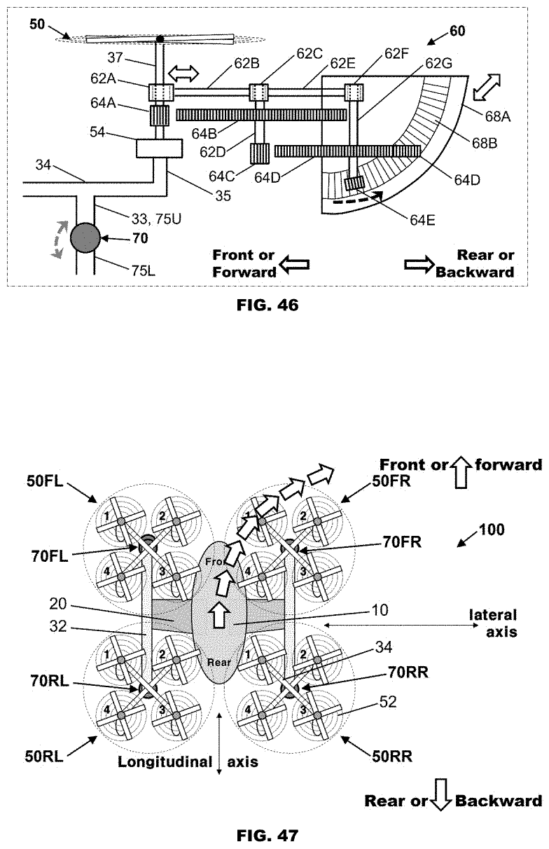

FIG. 46 is a cross-sectional view of an exemplary assisted tilting unit (60) employing a gear assembly and a power transmitter. For ease of illustration, various gears have been blown to scale in the figure. In addition, even though a rotor group (50) includes multiple rotors, only 5 one rotor has been included in the figure for ease of illustration.

The propellers of the rotor(s) of the rotor group (50) are fixedly coupled to a motor axis (37) of a rotor motor (54). Therefore, as the rotor motor (54) rotates its motor axis (37), the propellers of the rotors rotate, and the rotor group (50) generate a lift.

A tilting unit (70) includes an upper arm (75U) and a lower arm (75L), where the upper arm (75U) can be tilted with respect to the lower arm (75L) in at least one tilting direction, depending on [1] the type of a joint of the tilting unit (70), [2] a presence or an absence of a stopper, [3] a presence or an absence of a bumper, or the like. Other features of the upper 15 and lower arms (75U), (75L) are the same or similar to those of the other tilting units (70).

The upper arm (75U) of the tilting unit (70) is fixedly coupled to a second horizontal frame (34) which in turn is fixedly coupled to a third vertical frame (35). It is noted that the upper arm (75U) of the tilting unit (70) may be viewed as a second vertical frame (33).

An assisted tilting unit (60) may include multiple ring connectors (62), multiple gears (or a gear assembly (64)), at least one guide (68), or the like. For example, the assisted tilting unit (60) includes a first ring connector (62A), a second ring connector (62C), and a third ring connector (62F).

The ring connectors (62A), (62C), (62F) are connected by a first frame (62B) and a second frame (62E). Each ring connector (62A), (62C), (62F) defines a hole therein. Through the holes, the ring connectors (62A), (62C), (62F) may movably couple with the motor axis (37), a third frame (62D) and a fourth frame (62G), respectively.

A first (smaller) gear (64A) is installed around the motor axis (37), and disposed adjacent to a second (larger) gear (64B), where this second gear (64B) and a third (smaller) gear (64C) may be installed around the third ring connector (62D). In addition, the third (smaller) gear (64C) is disposed adjacent to a fourth (larger) gear (64D), where this fourth gear (64D) and a fifth (smaller) gear (64E) may also be installed around the fourth frame (62G).

Accordingly, when the rotor motor (54) rotates its motor axis (37), mechanical power can be transmitted through the gears (64A), (64B), (64C), (64D), finally to the fifth smaller gear (64E), where the rpms of the gears decrease as the power is transmitted.

A guide (68A) may be fixedly installed on or over a frame, a wing or a body of the aircraft.

The guide (68A) may include a guide gear (68B) and may be disposed adjacent to the fifth smaller gear (64E). Therefore, the guide (64E) and fifth gear (64E) may operate as a prior art rack and pinion gear. It is noted that the guide gear (68B) is provided along a curve such as, e.g., an arc of a circle or an oval. Accordingly, when the fifth smaller gear (64E) couples with the curved guide gear (68B). the fifth smaller gear (64E) may travel along the curved guide gear (68B).

In the second example of the first exemplary embodiment, the assisted tilting unit may work in various sequences. For example, a control unit may receive a user input from a pilot to commence the assisted tilting. The pilot may provide such a user input, e.g., when he needs to increase an amplitude of a horizontal component of a vector sum of the lifts generated by a certain rotor group or by all rotor groups such that a multi-rotor aircraft can move in a forward direction at a faster speed.

In another alternative, the control unit may detect at least one preset (i.e., pre-determined) conditions. Upon detecting such a condition, the control unit may start the assisted tilting, with or without directly receiving the user input from the pilot.

Examples of such preset conditions may include [1] an rpm of a preset rotor or a preset rotor group which may exceed a preset threshold, [2] an rpm of a preset rotor or a preset rotor group which may generate the lifts, where a horizontal component of a first vector sum of such lifts is less than or does not reach a preset threshold, [3] a horizontal component of a second vector sum of all lifts generated by the rotor groups of a multi-rotor aircraft may be less than or does not reach a preset threshold, [4] an occurrence of an emergency which may be caused by external disturbances, or the like.

When the rotor motor (54) rotates at a first rpm, the motor axis (37) rotates at the same rpm, and the first gear (64A) rotates at the same rpm as well. When the first gear (64A) forms a coupling with the second gear (64B), the first gear (64A) rotates the second gear (64B) at a second, smaller rpm, and the third gear (64C) also rotates at the same second rpm.

When the third gear (64C) couples with the fourth gear (64D), the third gear (64C) rotates the fourth gear (64D) at a third, even smaller rpm, and the fifth gear (64E) also rotates at the same third rpm. When the fifth gear (64E) couples with the guide gear (68B), the fifth gear (64E) travels in an arcuate path along the guide gear (68B).

Because the guide (68A) is fixedly incorporated on or over the frame, the wing or the body and does not move, the fifth gear (64E) travels along the arcuate path (68B), thereby rotating the entire rotor group (70), the frames (34), (35), the ring connectors (62), and the gears (64) in the forward direction.

In this context, the assisted tilting unit (60) of this disclosure may be deemed to include the power transmission unit and the guide (68), where such ring connectors (62) and gears (64) can be viewed as the power transmission unit.

In the third example of the first exemplary embodiment, the assisted tilting unit (60) may be coupled to the rotor motor (54) and may transmit at least a portion of mechanical energy generated by a rotor motor (54) to tilting a tilting unit (70) and a rotor group (50) coupled thereto in various configurations.

In one example, all gears (64A)˜(64E) may be coupled to each other all the time, while the fifth gear (64E) is separated apart from the guide (68A). When the control unit or the pilot manually moves the guide (68A) closer to the fifth gear (64E), fifth gear (64E) couples with the guide gear (68B). Therefore, the upper arm (75U) of the tilting unit (70) and the rotor group (50) coupled to the upper arm (25U) begins to be tilted.

As shown in the figure and in another example, the first gear (64A) is installed away from the second gear (64B) when the aircraft is not performing the assisted tilting. That is, when the rotor group and the tilting unit are tilted based on the difference among the lifts generated by different rotors of the rotor group, the first gear (64A) is not coupled to the second gear (64B) and, therefore, the assisted tilting unit (60) does not perform the assisted tilting. This can be embodied, e.g., by shaping or sizing a hole of the first ring connector (62A) such that the first and second gears (64A), (64B) do not couple with each other when the first ring connector (62A) is moved toward a rear of the aircraft.

As the first ring connector (62A) is moved toward a front of the aircraft, however, the first and second gears (64A), (64B), these first and second gears (64A), (64B) get engaged with each other, and the portion of the mechanical energy begins to be transmitted through other gears (64C), (64D), (64E).

In the fourth example of the first exemplary embodiment, various configurations which are different from that of FIG. 46 can be used as the assisted tilting unit. For example, the portion of the mechanical energy generated by the rotor motor can be transmitted by [1] using a different number of gears in a configuration similar to that of FIG. 46, [2] using the same or similar number of gears in another configuration different from that of FIG. 46, [3] using a different prior art gear assembly, [4] using a different prior art power transmission unit, [5] employing a configuration including the same, similar or different number of gears, while coupling or decoupling the gears in different directions, or the like.

In the fifth example of the first exemplary embodiment, a certain tilting unit and a certain rotor group may be tilted using the mechanical energy generated by a rotor motor for another rotor of another rotor group. Alternatively, the assisted tilting unit may divert at least a portion of mechanical energy which is generated by a certain rotor of a certain rotor group for tilting [1] another rotor of the same rotor group, [2] another rotor of a different rotor group, [3] at least two rotors of the same rotor group, or [4] at least one rotor of the same rotor group and at least one rotor of a different rotor group.

In the second exemplary embodiment of this ninth aspect, the aforementioned assisted tilting may be applied to drive other parts of the multi-rotor aircraft.

In the first example of the second exemplary embodiment, the assisted tilting unit may be applied to move the stoppers or bumpers which have been described above. Accordingly, the control unit may manipulate the tilting range of a tilting unit and the corresponding tilting range of the rotor group coupled to that tilting unit.

In the second example of the second exemplary embodiment, the assisted tilting unit may be applied to actively manipulate other parts of the aircraft. For example, the same mechanism may be applied so that the control unit may manipulate the height or elevation of a rotor or that of a rotor group.

It is noted that one feature of a certain embodiment or example of this ninth aspect of this disclosure [1] may be applied to, [2] may be incorporated into, [3] may replace, [4] may be replaced by, or [5] may be combined, with a corresponding feature of another embodiment or example of this ninth aspect, as long as such application, incorporation, replacement, or combination does not contradict each other.

It is also noted that one feature of this ninth aspect of this disclosure [1] may be applied to, [2] may be incorporated into, [3] may replace, [4] may be replaced by, or [5] may be combined with, a corresponding feature of another aspect of this disclosure, as long as such application, incorporation, replacement, or combination does not contradict each other.

### 10. Variations or Modifications

The tenth exemplary aspect of this disclosure relates to variations or modifications of [1] various configurations of the multi-rotor aircrafts, the tilting units each capable of tiling at least one rotor group coupled thereto, and the load sharing units capable of bearing at least a portion of the weight load of the aircraft and relieving such a portion away from the tilting units, all of which have been described above, [2] various methods of constructing, installing, or using such multi-rotor aircrafts, tilting units, and load sharing units, [3] various control algorithms for controlling operations such multi-rotor aircrafts, their tilting units, and load sharing units, or the like.

It has been explained throughout this disclosure that the multi-rotor aircraft can tilt its tiltable rotor groups in the forward direction by driving the rear rotors of the rotor group to generate the lifts which are greater than the lifts generated by the front rotors of the same rotor group. It is appreciated that the multi-rotor aircraft of this disclosure can generate such greater lifts, without having to rotate the rear rotors faster than the front rotors.

The first exemplary embodiment of this tenth aspect of this disclosure relates to the multirotor aircrafts which may cruise in a tilted or forward direction even when the rear rotors of a certain rotor group may not have to rotate at a higher rpm than the front rotors of the same rotor group.

That is, the lifts generated by the rear rotors can include the horizontal components even when the rpm of the rear rotors may be less than the rpm of the front rotors depending upon many factors such as, e.g., [1] shapes or sizes of the rear and front rotors, [2] numbers of rear rotors and front rotors in that rotor group, [3] shapes, sizes, or pitches of the propellers of the rear and front rotors, or the like.

The first example of this first exemplary embodiment relates to a bigger rear rotor rotating at a lower rpm than a smaller front rotor, generating a lift greater than a lift generated by the front rotor. For example, when a rear rotor of a rotor group is bigger than a front rotor of the same rotor group, the rear rotor may generate a greater lift per rotation than the front rotor. When both the rear and front rotors generate the same lifts during hovering, the bigger rear rotor may rotate at a slower rpm than the smaller front rotor.

But for cruising in a tilted or forward direction, the rear rotor has to generate the greater lift than the front rotor. Therefore, depending on the difference in the shapes, sizes or pitches, the rear rotor may [1] still rotate at a slower rpm that the front rotor, [2] rotate at the same rpm as the front rotor, [3] have to rotate faster than the front rotor, or the like.

The second example of this first exemplary embodiment relates to a rotor group which may designate more rotors as the rear rotors.

For example, when a rotor group includes multiple identical rotors, each rear rotor may generate the same lift per rotation as the front rotor. Thus, however many rotors of the rotor group may be designated as the rear rotors, all rotors may have to rotate at the same rpm during hovering, as long as each rotor group satisfies the torque balance (i.e., a clockwise torque generated by a first set of rotors of a rotor group is balanced by a counter-clockwise torque generated by a second set of rotors of the same rotor group)

For cruising in a tilted or forward direction, however, the rear rotors must generate the lifts which are greater than the lifts generated by the front rotor(s). Therefore, depending upon the difference in the sizes or lifts, the rear rotors may [1] rotate at a slower rpm, [2] rotate at the same rpm as the front rotor(s), [3] have to rotate faster than the front rotor, or the like.

The third example of this first exemplary embodiment relates to a rotor group which includes at least two rear rotors and the same number of front rotors, where the propellers of the rear rotors may have the shapes, sizes or pitches capable of generating the greater lifts than the front rotors per rotation of the propeller.

As a result, during hovering, the rear rotors do not have to rotate at the same rpm as the front rotors, for rotating the rear and front rotors may in fact tilt the rotor group. Rather, because each rear rotor may generate the greater lift per rotation than the front rotor, the rear rotors may rotate at a slower rpm than the front rotors.

In addition, for cruising in a tilted or forward direction, the rear rotors must generate the lifts greater than those generated by the front rotor(s). Accordingly, depending on the difference in the shapes, sizes, or pitches, or the difference in such lifts per rotation of their propellers, the rear rotors may [1] still rotate at a slower rpm, [2] rotate at the same rpm as the front rotor, [3] have to rotate faster than the front rotor(s), or the like.

Therefore, it is appreciated that maintaining, increasing or decreasing the rpms of a certain rotor of a certain rotor group may maintain, increase or decrease the amplitude of the horizontal or vertical component of the vector sum of the lifts generated by the rotors of that rotor group.

In the second exemplary embodiment of this tenth aspect of this disclosure, the multi-rotor aircraft may include a first number of tiltable rotor groups and a second number of non-tiltable rotor groups. That is, the multi-rotor aircraft may include at least one rotor group which is not coupled to any tilting unit and, therefore, which is not tiltable.

For example, a multi-rotor aircraft may include a first set and a second set of rotor groups, where each rotor group of the first set is directly or indirectly coupled to at least one tilting unit, but each rotor group of the second set is not coupled to any tilting unit and, therefore, may not be tilted at all during either hovering or cruising.

Because a finite number of rotors of the second set of rotor groups may always face upward, such rotors alone can generate such lifts that a vector sum of such lifts includes a vertical component and where an amplitude of such a vector sum may be sufficient to keep the aircraft afloat in the sky.

To the contrary, the rotors of the first set of rotor groups may not have to (significantly) participate in generating the lifts with the vertical components. As a result, the rotors of the first set of rotor groups may be tilted at even greater angles, and generate such lifts that a vector sum of such lifts includes a horizontal component an amplitude of which may be enough to move the aircraft in the tilted or forward direction at a substantially high speed.

In the third exemplary embodiment of this tenth aspect of this disclosure, the multi-rotor aircraft may tilt its cabin or body to a certain tilting angle during the turning operation. It is appreciated that this third embodiment is related to the second exemplary embodiment of the eighth exemplary aspect.

It has been explained throughout this disclosure that the multi-rotor aircraft can keep its cabin or body at least substantially horizontal during hovering or cruising. That is, even when the rotor groups are tilted and the aircraft is moving in the tilted or forward direction, the aircraft may keep its body or cabin at least substantially horizontal.

However, the multi-rotor aircraft can manipulate its rotor groups and tilting units such that its cabin or body can be tilted in the tilted, forward, backward, or another slanted direction which is slanted with respect to the forward or backward direction. Tilting the cabin or body can be accomplished by rendering some rotors generate the greater lifts than other rotors.

FIG. 47 is a top view of an exemplary multi-rotor aircraft which is similar to the aircraft of FIG. 11 and which includes four rotor groups such as, e.g., a front-left rotor group (50FL), a rear-left rotor group (50RL), a front-right rotor group (50FR), and a rear-right rotor group (50RR).

During hovering, the aircraft (100) manipulates its rotor groups (50) to generate equal lifts such that the aircraft (100) floats horizontally in the air. Alternatively, the aircraft (100) may manipulate its rotor groups (50) to generate lifts of different magnitudes but a vector sum of such lifts is perpendicular to the horizontal plane, thereby floating horizontally in the air.

As illustrated above, it would be preferred that some rotors of the rotor group (50) rotate in a clockwise direction while generating a first torque, that the remaining rotors of the same rotor group (50) rotate in a counter-clockwise direction while generating a second torque, and that the first and second torques have the same amplitudes. Because tow torques acting in opposite directions are balanced, that rotor group does not generate any net torque, and the aircraft does not have to revolve around it center.

When a pilot wants to turn the aircraft (100) to the right as indicated by the arrows in the figure, the aircraft (100) may control its body horizontal by, e.g., manipulating the vertical component of the vector sum of the lifts generated by each rotor group (50) to not generate any net non-zero torque in either the θ or φ direction. The aircraft (100) may also manipulate the horizontal component of the vector sum of the lifts in such a way that the aircraft (100) cruises to the right, e.g., along the arrowed path of the figure.

However, the superelevation adjustment or centrifugal force adjustment which have been explained above may be applied to the aircraft (100) such that the aircraft (100) may elevate the front-left rotor group (50FL) to a slightly higher altitude than the rear-right rotor group (50RR), thereby rendering the passengers feel as if they are driving an automobile along a curved roadway or as if they are riding a spinning swing.

At the same time, the aircraft (100) may keep the front-right rotor group (50FR) and the rear-left rotor group (50RL) at the substantially same elevation or may slightly elevate the front-right rotor group (50FR) or the rear-left rotor group (50RL).

It is noted that the aircraft (100) may increase the rpm of all (or a majority of) rotors (52) of the front-left rotor group (50FL), with or without decreasing the rpm of all (or a majority of) rotors of the rear-right rotor group (50RR). In the alternative, the aircraft (100) may perform minute control on each rotor of the front-left rotor group (50FL) and the rear-right rotor group (50RR).

In other words, the control unit may manipulate the rpms of the rotors of the rotor groups in such a way that the body (or cabin) stays horizontal during the turning operation, that the body (or cabin) may be tilted based on the superelevation or centrifugal force, that the body (or cabin) can be tilted in a different angle, or the like.

The fourth exemplary embodiment of this tenth aspect of this disclosure relates to such multi-rotor aircraft s which includes at least one “biased rotor group.” As used herein, a “biased rotor group” means a rotor group whose rotors or their propellers are not horizontally disposed in a “turned-off-state,” where the turned-off state is a state when the rotor motors for such rotors are turned off. As a result, the rotors or propellers of such rotors of the biased rotor group forms a non-zero angle with respect to a horizontal plane in their biased positions.

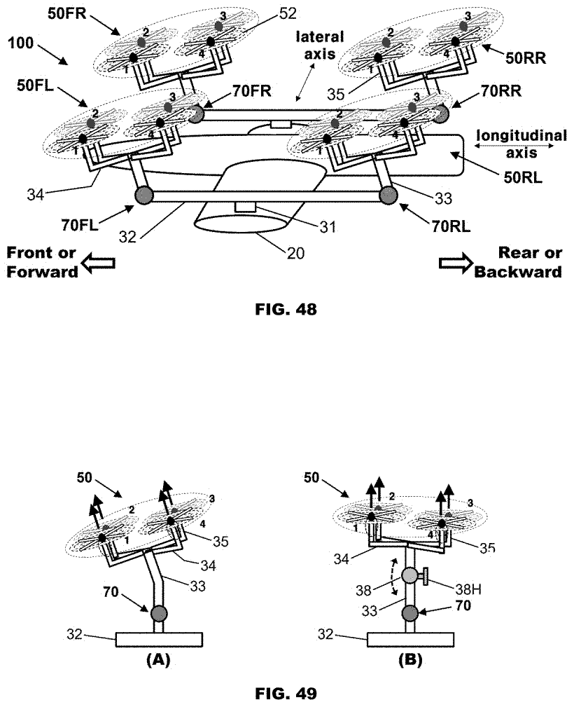

FIG. 48 is a perspective view of a four-quadcopter-type multi-rotor aircraft of this disclosure which includes four rotor groups and four tilting units, where all four rotor groups are “biased rotor groups.” As manifest in this figure, all four rotor groups or their propellers do not face upward or do not sit up vertically when they are in a turned-off state. Rather, all four rotor groups and their rotors are tilted, e.g., in the forward direction at the angle of about 15°.

During the hovering, during vertical take-off, or during vertical landing, the control unit may manipulate the front rotors (52 (1)), (52 (2) to generate greater lifts than the rear rotors (52 (3)), (52 (4)) so that the biased rotor groups (50) and their rotors (52) become horizontal. Accordingly, a vector sum of the lifts generated by all rotor groups (50) have only a vertical component but not a horizontal component, and the aircraft (100) may to engage in various operations such as taking off, hovering, and landing.

When the pilot wants to cruise in the forward direction, he may manipulate the rotors (52) of all rotor groups (50) to generate the lifts of the same magnitude, and the rotor groups (50) may automatically return back to their biased state. Because the rotor groups (50) are tilted in their biased state, the rotor groups (50) may generate such lifts that a vector sum of such lifts defines a non-zero horizontal component of a substantial amplitude, and the aircraft (100) can start cruising (in the forward or tilted direction).

It is noted that, depending on the rpms of the rotors (52) and an actual direction of a vector sum of the lifts generated by the rotors (52), the aircraft (100) can maintain the same altitude, increase its altitude, or decrease its altitude. When a pilot wants to manipulate not only the cruising speed (in the forward direction) but also the altitude of the aircraft (100), a control unit may solve a consistent but underdetermined system of equations described above, and find a set of solution which can satisfy such a cruising speed as well as such an altitude.

When the pilot wants to increase the cruising speed, he may manipulate the rear rotors (52 (3)), (52 (4)) to generate the lifts of which the amplitudes are greater than those of the lifts generated by the front rotors (52 (1)), (52 (2)). As a result, the already tilted rotor groups (50) may be tilted to a greater angle, the horizontal component of the vector sum of the lifts generated by such rotor groups (50) increases even more, and the aircraft (100) can cruise at a higher speed.

It is noted that the biased rotor groups may be fabricated or installed by different configurations, e.g., by installing a frame at a slanted angle with respect to a vertical direction, and coupling a rotor group or tilting unit thereto, by providing a biased angle to a frame by bending the frame at a certain bias angle or making the frame to form a curved frame, or the like.

FIG. 49 is a cross-sectional view of exemplary biased rotor groups (50) of a multi-rotor aircraft (100). Panel (A) shows a configuration in which a second vertical frame (33) has a bent of about 15° in its middle portion, where an upper end of the second vertical frame (33) is coupled to a rotor group (50), and where a lower end of the second vertical frame (33) is coupled to a tilting unit (70) which is in turn coupled to a first horizontal frame (31). As a result, propellers of the rotors (52) of the rotor group (50) face upward at a slanted angle which is the same as the bent angle of the bent of the second vertical frame (33).

It is noted that such biased rotor groups may be constructed or installed in various locations. Referring to the exemplary multi-rotor aircraft of FIGS. 11 and 12, at least one bent may be formed, e.g., [1] at a junction of one of such rotor groups (50FL), (50FR), (50RL), (50RR) and one of such frames (31), (32), (33), (34), (35) which is coupled to the rotor group (50FL)˜(50RR), [2] at a junction of one of such frames (31)˜(35) and one of such tilting units (70FL)˜(70RR), [3] at a junction of one of such frames (31)˜(35) (or tilting units) and the wing (20) or the body (10) of the aircraft (100), or the like. It is also noted that the locations for the bent may vary as the aircraft may include a greater number or a smaller number of frames.

Such biased rotor groups may instead be constructed or installed in such a way that an angle of bias can be adjusted by a pilot, a mechanic, a control unit, or the like. Panel (B) of FIG. 49 is an exemplary adjusting unit (38) capable of adjusting a bias angle of the second vertical frame (33). For example, when a pilot or a mechanic turns a handle (38H) in a preset direction, a bias angle of the adjusting unit (38) can be increased or decreased.

Therefore, before taking off or during maintenance, the pilot or mechanic may bias or un-bias all or at least one of multiple rotor groups (50) of the multi-rotor aircraft to a certain degree of bias as he or she sees fit.

It is noted that such biasing can be obtained by other configurations. For example, a tension spring may be coupled to a tilting unit such that a moving element (e.g., an upper arm) of the tilting unit may be pulled in a certain direction. Accordingly, when the multi-rotor aircraft is in its turned-off state, the tilting unit is tilted in a direction pulled by the spring.

In the fifth exemplary embodiment of this tenth aspect of this disclosure, a control algorithm may be provided to manipulate rpms of at least one rotor group temporally or spatially and, therefore, facilitate the tilting of at least one tiltable rotor group.

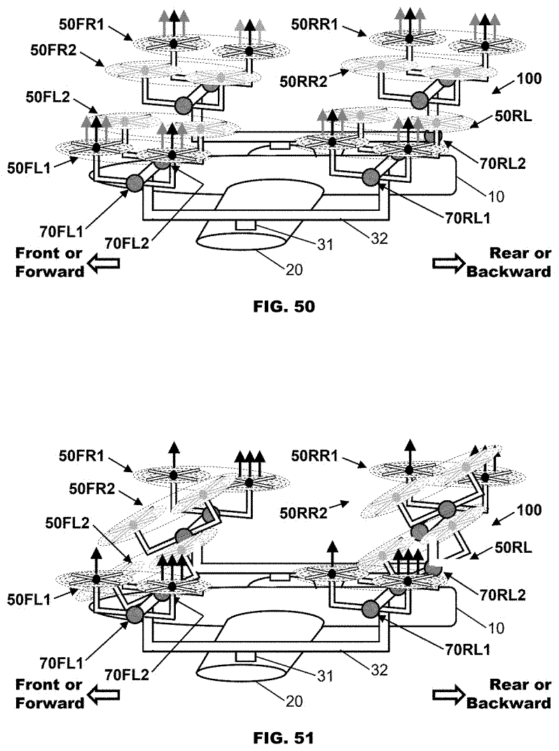

FIG. 50 is a perspective view of an exemplary multi-rotor aircraft which is similar to that of FIG. 16, which has a shape of a four-quadcopter, which includes eight tilting units, and which is about to switch from hovering to cruising in a forward direction. More particularly, the aircraft (100) includes two front-left rotor groups (50FL1), (50FL2), two front-right rotor groups (50FR1), (50FR2), two rear-left rotor groups (50RL1), (50RL2), two rear-right rotor groups (50RR1), (50RR2), and the like.

The tilting units are installed below each rotor group such that (1) a first front-left tilting unit (70FL1) and a second front-left tilting unit (70FL2) are respectively installed under the first front-left rotor group (50FL1) and second front-left rotor group (50FL2), (2) a first front-right tilting unit and a second front-right tilting unit are respectively installed under the first front-right rotor group (50FR1) and the second front-right rotor group (50FR2), (3) a first rear-left tilting unit (70RL1) and a second rear-left tilting unit (70RL2) are respectively installed under the first rear-left rotor group (50RL1) and the second rear-right rotor group (50RL2), and the like.

The multi-rotor aircraft (100) may switch from hovering to cruising, e.g., by spatially manipulating the lifts generated by various rotor groups. For example, a control unit may increase the rpms of all rotors of the rotor groups (50FL1), (50FR1), (50RL1), (50RR1), where these rotor groups are referred to as the “outer rotor groups” hereinafter.

As a result, the outer rotor groups increase the lifts, where such lifts purely act in a upright direction. These increases in the rpms are denoted by the black and gray arrows in the figure.

Simultaneously with or immediately after the outer rotor groups generate the greater lifts, the control unit can increase the lifts which are generated by other rotor groups (50FL2), (50FR2), (50RL2), (50RR2) in such a way that a vector sum of such lifts includes a horizontal component acting in a tilted or forward direction, where these four rotor groups (50FL2), (50FR2), (50RL2), (50RR2) may be referred to as the “inner set of rotor groups” hereinafter.

Such lifts can be increased, e.g., by increasing the rpms of the rear rotors of the inner set of rotor groups (50FL2), (50FR2), (50RL2), (50RR2), while maintaining or decreasing the rpms of the front rotors of such inner set of rotor groups (50FL2), (50FR2), (50RL2), (50RR2).

Due to such a horizontal component of the vector sum of such lifts, the tilting units (70FL2), (70FR2), (70RL2), (70RR2) (to be referred to as the “inner set of tilting units” hereinafter) are tilted in a forward or tilted direction, whereby the inner set of rotor groups (50FL2), (50FR2), (50RL2), (50RR2) which are coupled to such inner set of tilting units (70FL2), (70FR2), (70RL2), (70RR2) can be tilted in the forward or tilted direction.

Due to such tilting and due to the presence of the horizontal component, the vertical component of the vector sum of such lifts may decrease. However, because both the rear rotors and the front rotors of the outer set of rotor groups generate the upward lifts of greater magnitudes, the decreased portion of the vertical component of the vector sum of the lifts which are generated by the rotors of the inner set of rotor groups can be compensated, e.g., by the increase in the vertical component of the vector sum of the lifts generated by the outer set of rotor groups.

It is noted that, when there is a discrepancy between the decreased portion of the vertical component of the vector sum of the lifts generated by the rotors of the inner set of rotor groups and the increased portion of the vertical component of the vector sum of the lifts generated by the rotors of the outer set of rotor groups, the aircraft (100) may change its altitude.

Because a vector sum of the vertical components of the lifts generated by both of the inner and outer sets of rotor groups balances the weight load of the aircraft (100), the inner set of tilting units can be easily tilted, without being severely hindered by the friction force due to the weight load of the aircraft. It is therefore noted that such manipulation of the outer set of rotor groups can facilitate tilting of the inner set of tilting units and tilting of the inner set of rotor groups, or vice versa.

FIG. 51 is a perspective view of the multi-rotor aircraft (100) of FIG. 50, where the control unit manipulates the inner set of rotor groups so that the inner set of tilting units and the inner set of rotor groups have been tilted, and where the control unit is about to tilt the outer set of tilting units and the outer rotor groups.

Once the inner set of tilting units (70FL2), (70FR2), (70RL2), (70RR2) and the inner set of rotor groups (50FL2), (50FR2), (50RL2), (50RR2) which coupled to such set of tilting units are tilted, the control unit may increase the lifts generated by the rear rotors of the outer set of rotor groups (50FL1), (50FR1), (50RL1), (50RR1). Then the lifts generated by such outer set of rotor groups also attains the horizontal component, which can render the outer set of tilting units tilted, and the outer set of rotor groups coupled thereto are also tilted.

As the outer set of rotor groups (50FL1), (50FR1), (50RL1), (50RR1) are gradually tilted, the vertical component of the lifts generated by the rotors of such outer set of rotor groups also gradually decreases, and the aircraft (100) may gradually lose its altitude.

Accordingly, when the aircraft (100) has to maintain its altitude, the control unit may increase the rpms of the rear rotors (or all rotors) of the inner set of rotor groups, thereby generating an extra vertical component and maintaining the altitude of the aircraft (100).

It is noted that, instead of dividing the rotor groups into the inner and outer sets of rotor groups and varying the lifts generated by the inner and outer sets of rotor groups, the rotor groups of the multi-rotor aircraft may be divided into different set of rotor groups according to the shapes of arrangements of the rotor groups such as, e.g., a cross, a rhombus, a circle, an “X” or the like, as long as the aircraft can balance itself while tilting one set of the rotor groups and then tilting the other set of the rotor groups.

The above examples illustrate the spatial manipulation of the lifts generated by different sets of the rotor groups. It is also appreciated that the lifts generated by different sets of the rotor groups may be temporally manipulated. For example, different sets of the rotor groups can be manipulated to increase the lifts one after another.

It is explained in this disclosure that a certain rotor group may increase a horizontal component of a vector sum of the lifts which are generated by the rotors of that rotor group. However, the rotor group can maximize the horizontal component of the vector sum of the lifts by additional means.

In the above examples, various configurations have been employed to increase the horizontal component of a vector sum of the lifts generated by a rotor group. In the sixth exemplary embodiment of this tenth aspect of this disclosure, however, the multi-rotor aircraft of this disclosure may also maximize the horizontal component of a vector sum of the lifts generated by a rotor group by incorporating at least one rotor group which is not installed in an upright direction in the turned-off state.

In other words, the multi-rotor aircraft may include at least one rotor group of which the rotors are not installed at least substantially horizontally, but installed at a slanted angle such as, e.g., 5°, 10°, 15°, 20°, 30°, 40°, 50°, 60°, 70°, 80° or 90° with respect to a vertical direction. Therefore, such a rotor group can generate such lifts that a horizontal component of a vector sum of the lifts generated by the rotor group may be far greater than the vertical component of the vector sum, without having to tilt such a rotor group.

Although this configuration may look similar to the biased rotor group explained in the fourth exemplary embodiment of this ninth aspect, there is a difference therebetween. For example, to provide the biased rotor group, at least one frame or at least one arm of a tilting unit [1] may include a bent, [2] may be bent, or [3] may be curved. However, this configuration does not require the frame or arm to include the bent, to be bent or to be curved. Rather, this configuration can be obtained by installing the rotor group or the tilting unit onto the frame, wing or body at the slanted angle.

The seventh exemplary embodiment of this tenth aspect of this disclosure relates to such multi-rotor aircrafts which may include bodies of different dimensions, which may include different operational capabilities, or the like.

In the first example of this seventh exemplary embodiment, such aircrafts may be shaped and sized to carry [1] only a single person (e.g., a single pilot), [2] at least two persons, [3] at least one person and a cargo of a preset weight or a preset volume, [4] only the cargo, or the like.

In the second example of this seventh exemplary embodiment, such aircrafts may be constructed such that the aircraft may be operated [1] by a human pilot on board, [2] as an unmanned aircraft which may be operated wirelessly, e.g., by a remote console which is away from the aircraft, [3] by a control software, with the pilot on board or as unmanned, [4] by an artificial intelligence, with the pilot on board or as unmanned, or the like.

In the eighth exemplary embodiment of this tenth aspect of this disclosure, the multi-rotor aircraft may include at least one additional electric motor other than the rotor motors. That is, this additional motor is used not to rotate the propellers of the rotors but to provide mechanical energy to another part of the aircraft for different purposes.

In the first example of this eighth exemplary embodiment, the additional motor may be employed as a “tilting motor” and may tilt at least one rotor or at least one rotor group. To this end, such a rotor or rotor group may preferably include an actuation mechanism which may be identical or similar to that of the prior art tiltrotor air vehicle. It then follows that such a multi-rotor aircraft of this disclosure may be regarded as a hybrid of the multi-rotor aircraft of this disclosure and a prior art tiltrotor air vehicle.

In the second example of this eighth exemplary embodiment, the additional motor may be employed to adjust the elevation of a rotor or a rotor group, as explained in the fourth embodiment of the sixth aspect of this disclosure.

In the third example of this eighth exemplary embodiment, the additional motor may be employed to adjust a position or an angle of various parts of the multi-rotor aircraft. For example, the additional motor may be positioned such that the motor can change a length of the tension spring or the compression spring.

Thus, the portion of the weight load borne by the load sharing unit may be manipulated. This configuration is beneficial when the aircraft has to carry a heavy payload, more passengers, or the like.

In the ninth exemplary embodiment of this tenth aspect of this disclosure, the multi-rotor aircraft may include at least one wing which is capable of generating lifts when the aircraft moves in the forward direction.

In the first example of this ninth exemplary embodiment, the aircraft may include an even number of wings one half of which may be disposed on the right side of the aircraft, and the other half of which may be disposed on the left side thereof. Alternatively, the aircraft may include an even number of wings one half of which may be disposed on the front side of the aircraft, and the other half of which may be disposed on the rear side thereof.

When the aircraft may include multiple wings, such an aircraft may be regarded as a biplane (e.g., an unequal-span biplane, a sesquiplane, an inverted sesquiplane, or a Busemann biplane), a triplane, a quadruplane, a multiplane, or the like.

Alternatively, the aircraft may include multiple wings in such a configuration that the aircraft may be regarded as an unstaggered (bi)plane, a forward stagger (bi)plane, a backwards stagger (bi)plane, a tandem-wing plane, a cruciform-wing plane, or the like.

In the second example of this ninth exemplary embodiment, the aircraft may include an odd number (2N+M, where n is a positive integer and M is an odd number) of wings, where N wings may be disposed on the right (or front) side of the aircraft, another N wings may be disposed on the left (or rear) side thereof, and M wings are disposed between the right (front) side and the left (or rear) side.

In the third example of this ninth exemplary embodiment, the aircraft may include at least one wing which may be installed at a preset location of a body of the aircraft such that the wing may generate a lift which includes a non-zero horizontal component and that the horizontal component moves the aircraft in the tilting (or forward) direction.

In the fourth example of this ninth exemplary embodiment, the aircraft may include at least one wing which extends at least partly in a horizontal direction. As a result, the wing may contribute to increasing the stability of the aircraft in said at least partly horizontal direction.

In the fifth example of this ninth exemplary embodiment, the aircraft may have at least one wing in a preset location of the aircraft in such a way that the wing may ne regarded as a low wing, a mid wing, a shoulder wing, a high wing, a parasol wing, or the like.

In the sixth example of this ninth exemplary embodiment, the aircraft may have at least one wing, where at least one rotor group may be mechanically coupled to the wing or where the wing may not be coupled to any rotor group.

In the seventh example of this ninth exemplary embodiment, the aircraft may have at least one wing which includes at least one portion as commonly found in a prior art airplane such as, e.g., a vertical stabilizer (for controlling yaw), a horizontal stabilizer (for controlling pitch), a yaw (for changing yaw), an elevator (for changing pitch), a flap (for increasing lift and drag), an aileron (for changing roll), a spoiler (for changing lift, drag or roll), a slat (for increasing lift), or a winglet (for generating lift).

### 11. Interchangeabilitys

Various multi-rotor aircrafts, their tilting units or load sharing units, and various methods of constructing, installing or using such aircrafts and units have been described above, particularly with reference to various exemplary aspects, their embodiments, examples, and objectives. The descriptions provided in this disclosure are intended only for better understanding various configurational or operational features or characteristics of such aircrafts, units, and related methods. Accordingly, it would be apparent to those skilled in the relevant art that various modifications or variations of such aircrafts, their units, and related methods may be made and practiced from the above disclosure.

While exemplary aspects, embodiments, examples, and objectives of various multi-rotor aircrafts have been disclosed herein, it is understood that other modifications or variations are still possible. Therefore, such modifications or variations are not to be regarded as a departure from the spirit and scope of such exemplary aspects, embodiments, examples, and objectives of this disclosure, and all such modifications or variations which would be obvious to one skilled in the art are intended to be included in this disclosure as well as to fall within the scope of the following claims.

Unless otherwise specified, various configurational or operational features of a certain aspect, embodiment, example or objective of this disclosure may be applied interchangeably to corresponding configurational or operational features of another aspect, embodiment, example or objective of this disclosure. That is, one configurational or operational feature of a certain aspect, embodiment, example or objective of this disclosure [1[ may be applied to, [2] may be incorporated into, [3] may replace, [4] may be replaced by, or [5] may be combined with a corresponding feature of another aspect, embodiment, or example of this disclosure which has been described throughout this disclosure, as long as such application, incorporation, replacement, or combination does not contradict each other.

Accordingly, a certain tilting unit or a load sharing unit which has been exemplified in conjunction with a certain mechanical joint-type tilting unit [1] may be applied to, [2] may be incorporated into, [3] may replace, [4] may be replaced by, or [5] may be combined with another tilting unit of a different type or another load sharing unit of a different type, unless such application, incorporation, replacement, or combination contradicts the purpose of the tilting unit or the load sharing unit.

In addition, although this disclosure focuses on various multi-rotor aircrafts, their tilting units, and their load sharing units, configurational and operational features of such aircrafts and units may also be expanded to other flying vehicles which include at least one rotor, where examples of such flying vehicles may include, e.g., the lift-and-cruise air vehicles, the tiltrotor air vehicles, or the like. Accordingly, such other flying vehicles also fall within the scope of disclosure [1] when such vehicles include at least one tilting unit of this disclosure, [2] when such vehicles include at least one load sharing unit of this disclosure, [3] when such vehicles can passively tilt at least one rotor group, [4] when such vehicles include at least one of other features related to the multi-rotor aircrafts including various tilting units or load sharing units, or the like.

It is understood that, while various aspects, embodiments, and examples of this disclosure have been described in conjunction with detailed description provided hereinabove, the foregoing disclosure is intended to illustrate and not to limit the scope of various multi-rotor aircrafts, which is defined by the scope of the appended claims. Other aspects, embodiments, examples, advantages, and modifications are within the scope of the following claims as well.

What is claimed is:

1. A multi-rotor aircraft comprising:
a body which includes a front and a rear,
wherein said body defines a longitudinal axis extending through said front and said rear, and
wherein said body also defines a lateral axis which is parallel with a horizontal plane and which is perpendicular to said longitudinal axis;
at least one rotor group which includes at least two rotors each of which includes a plurality of propellers and each of which is capable of generating a lift when said propellers rotate; and
at least one tilting unit which includes an upper arm and a lower arm,
wherein said upper arm is one of directly and indirectly coupled to said rotor group,
wherein said lower arm is one of directly and indirectly coupled to said body, and
wherein said tilting unit allows rotation of said upper arm about said lower arm such that a distance between said upper arm and said lower arm varies due to said rotation,
wherein, when a first vector sum of said lifts generated by said rotors acts in a tilted direction which forms a non-zero angle with a vertical direction, said first vector sum has a non-zero horizontal component which tilts said tilting unit in said tilted direction, said rotor group coupled to said upper arm of said tilting unit is also tilted in said tilted direction, and said aircraft performs moving in a moving direction which is defined by a second vector sum of said first vector sum and a vector of a weight load of said aircraft.

2. The aircraft of claim 1,
wherein said moving in said moving direction is one of:
moving in a forward direction while maintaining said aircraft at a preset altitude;
moving in said forward direction while increasing said altitude;
moving in said forward direction while decreasing said altitude;
making a turning operation of a preset turning radius while maintaining said aircraft at said altitude;
making said turning operation of said turning radius while increasing said altitude;
making said turning operation of said turning radius while decreasing said altitude;
performing a yaw rotation while maintaining said aircraft at said altitude;
performing said yaw rotation while increasing said altitude;
performing said yaw rotation while decreasing said altitude;
moving in a backward direction while maintaining said aircraft at said altitude;
moving in said backward direction while increasing said altitude; and
moving in said backward direction while decreasing said altitude.

3. The aircraft of claim 1,
wherein said first vector sum includes said horizontal component and a vertical component,
wherein said aircraft manipulates said lifts of said rotors in such a way that said horizontal component of said first vector sum moves said aircraft at a preset speed in a forward direction.

4. The aircraft of claim 1,
wherein said second vector sum includes a horizontal component and a vertical component,
wherein said aircraft manipulates said lifts of said rotors in such a way that said vertical component of said second vector sum manipulates an altitude of said aircraft.

5. The aircraft of claim 1,
wherein said body is at least not substantially tilted in said tilted direction while said aircraft moves in said moving direction.

6. The aircraft of claim 1,
wherein said tilting unit includes at least one mechanical joint capable of providing said rotation.

7. The aircraft of claim 6,
wherein said mechanical joint includes at least one of a ball-socket joint, a bolted joint, a condyloid joint, a cotter-pin, an ellipsoidal joint, a ginglymus joint, a gliding joint, a hinge joint, a knuckle joint, a pin joint, a pivot joint, a plane joint, a prismatic joint, a revolute joint, a saddle joint, a screw joint, a slider joint, a spherical joint, a turnbuckle, and a universal joint.

8. The aircraft of claim 1,
wherein said tilting unit is one of a path-dependent tilting unit and a bearing-type tilting unit.

9. The aircraft of claim 1,
wherein said tilting unit has a tilting range which is one of about 15°, 30°, 45°, 60°, 75°, and 90°.

10. The aircraft of claim 1,
wherein said upper arm has a tilting range defining an upper bound and a lower bound.

11. The aircraft of claim 10, further comprising at least one stopper,
wherein said stopper is configured to obstruct at least one of a first movement and a second movement of said upper arm,
wherein said first movement is a movement of said upper arm beyond said upper bound, and
wherein said second movement is another movement of said upper arm below said lower bound.

12. The aircraft of claim 10, further comprising at least one bumper,
wherein said bumper includes at least one of an elastic element and a viscous element, and
wherein said bumper is disposed in at least one end of a path of a movement of said upper arm,
whereby, when said tilting unit reaches at least one of said upper and lower bounds, said bumper abuts said upper arm, and absorbs at least a portion of mechanical energy associated with said movement of said upper arm.

13. The aircraft of claim 1,
wherein said aircraft includes a first tilting unit and a second tilting unit both of which are arranged in a series mode,
wherein said first tilting unit provides a first rotation of said upper arm about said lower arm in a first angular direction and within a first tilting range, and
wherein said second tilting unit provides a second rotation of said upper arm about said lower arm within a second tilting range and in a second angular direction which is different from said first angular direction.

14. The aircraft of claim 13,
wherein said first tilting range is one of about 15°, 30°, 45°, 60°, 75°, and 90°, and
wherein said second tilting range has a low end which is greater than 0° and a high end which is less than 360°.

15. The aircraft of claim 13,
wherein said first tilting range has a low end which is greater than 0° and a high end which is less than 180°, and
wherein said second tilting range has a low end which is greater than 0° and a high end which is less than 360°.

16. The aircraft of claim 13,
wherein said first tilting range and said second tilting range is one of identical to each other and different from each other.

17. The aircraft of claim 13, further comprising at least one stopper,
wherein each of said tilting ranges has its upper bound and its lower bound,
wherein said stopper is configured to obstruct at least one of a first movement of said first upper arm and a second movement of said second upper arm,
wherein said first movement is a movement of said first upper arm one of beyond said first upper bound and below said first lower bound, and
wherein said second movement is a movement of said second upper arm one of beyond said second upper bound and below said second lower bound.

18. The aircraft of claim 13, further comprising at least one bumper,
wherein said bumper includes at least one of an elastic element and a viscous element, and
wherein said bumper is disposed in at least one end of a path of a movement of one of said upper arms of one of said tilting units,
whereby, when said one of said tilting unit reaches one of said ends of said paths of said one of said upper arms, said bumper is capable of stopping said one of said upper arms of said one of said tilting units and absorbing at least a portion of mechanical energy associated with said stopping of said one of said upper arms of said one of said tilting units.

19. The aircraft of claim 1,
wherein said aircraft defines N rows of installation of said rotors starting in a direction from said front to said rear,
wherein said rows are at least partly parallel with said lateral direction,
wherein N is a positive integer and greater than 2, and
wherein a preset number of said rotors are installed in each of said N rows.

20. The aircraft of claim 19,
wherein each of said N rows is defined along N curvilinear lines, and
wherein said curvilinear lines is one of:
a straight line;
a curve which is convex upward with respect to said longitudinal axis in a direction from said front to said rear; and
a curve which is convex downward with respect to said longitudinal axis in said direction.

21. The aircraft of claim 19,
wherein said rotors installed in said N rows have elevations in one of:
a first arrangement in which said rotors of all of said N rows have the same elevation;
a second arrangement in which said rotors of (n−1)-th row have a first elevation which is smaller than a second elevation of said rotors of n-th row, where n is an integer between 2 and N; and
a third arrangement in which said rotors of (n−1)-th row have said first elevation which is greater than said second elevation of said rotors of n-th row.

22. The aircraft of claim 1, further comprising a first frame,
wherein said first frame includes a first upper arm and a first lower arm,
wherein said first lower arm is fixedly coupled to said upper arm, and
wherein said first upper arm is fixedly coupled to said rotor group,
whereby said tilting unit is indirectly coupled to said rotor group through said first frame.

23. The aircraft of claim 1, further comprising a second frame,
wherein said second frame includes a second upper arm and a second lower arm,
wherein said second upper arm is fixedly coupled to said lower arm, and
wherein said second lower arm is fixedly coupled to said body,

24. A multi-rotor aircraft comprising:
a body which includes a front and a rear,
wherein said body defines a longitudinal axis extending between said front and said rear, and
wherein said body also defines a lateral axis which is parallel with a horizontal plane and which is perpendicular to said longitudinal axis;
at least one rotor group which includes at least one front rotor and at least one rear rotor,
wherein said front and rear rotors are disposed in a direction parallel with said longitudinal axis,
wherein each of said rotors includes a plurality of propellers, and
wherein each of said rotors is capable of generating a lift when said propellers rotate; and
at least one tilting unit which includes an upper arm and a lower arm,
wherein said upper arm is one of directly and indirectly coupled to said rotor group,
wherein said lower arm is one of directly and indirectly coupled to said body, and
wherein said tilting unit allows rotation of said upper arm about said lower arm such that a distance between said upper arm and said lower arm varies due to said rotation,
wherein, when said rear rotor generates a rear lift which is greater than a front lift generated by said front rotor, a first vector sum of said rear lift and front lift tilts said tilting unit toward said front of said aircraft, said rotor group coupled to said upper arm of said tilting unit is also tilted toward said front, and said aircraft performs moving in a moving direction which is defined by a second vector sum of said first vector sum and a vector of a weight load of said aircraft.

25. The aircraft of claim 24,
wherein said moving and said moving direction are one of:
moving in a forward direction while maintaining said aircraft at a preset altitude;
moving in said forward direction while increasing said altitude;
moving in said forward direction while decreasing said altitude;
making a turning operation of a preset turning radius while maintaining said aircraft at said altitude;
making said turning operation of said turning radius while increasing said altitude;
making said turning operation of said turning radius while decreasing said altitude;
performing a yaw rotation while maintaining said aircraft at said altitude;
performing said yaw rotation while increasing said altitude;
performing said yaw rotation while decreasing said altitude;
moving in a backward direction while maintaining said aircraft at said altitude;
moving in said backward direction while increasing said altitude; and
moving in said backward direction while decreasing said altitude.

26. The aircraft of claim 24,
wherein said first vector sum includes a horizontal component and a vertical component,
wherein said aircraft manipulates said lifts of said rotors in such a way that said horizontal component of said first vector sum moves said aircraft at a preset speed in a forward direction.

27. The aircraft of claim 24,
wherein said second vector sum includes a horizontal component and a vertical component,
wherein said aircraft manipulates said lifts of said rotors in such a way that said vertical component of said second vector sum manipulates an altitude of said aircraft.

28. The aircraft of claim 24,
wherein said body is at least not substantially tilted in said tilted direction while said aircraft moves in said moving direction.

29. The aircraft of claim 24,
wherein said tilting unit includes at least one mechanical joint capable of providing said rotation.

30. The aircraft of claim 29,
wherein said mechanical joint includes at least one of a ball-socket joint, a bolted joint, a condyloid joint, a cotter-pin, an ellipsoidal joint, a ginglymus joint, a gliding joint, a hinge joint, a knuckle joint, a pin joint, a pivot joint, a plane joint, a prismatic joint, a revolute joint, a saddle joint, a screw joint, a slider joint, a spherical joint, a turnbuckle, and a universal joint.

31. The aircraft of claim 24,
wherein said tilting unit is one of a path-dependent tilting unit and a bearing-type tilting unit.

32. The aircraft of claim 24,
wherein said tilting unit has a tilting range which is one of about 15°, 30°, 45°, 60°, 75°, 90°, 105°, 120°, 135°, 150°, 165°, 180°.

33. The aircraft of claim 24,
wherein said tilting unit includes a moving element and a stationary element,
wherein said tilting unit has a tilting range defining an upper bound and a lower bound, and
wherein said moving element of said tilting unit is not tilted beyond said upper bound and below said lower bound.

34. A tiltable rotor group of a multi-rotor aircraft including a body comprising:
at least one rotor group including a plurality of rotors;
at least one tilting unit which includes an upper arm, a lower arm, and a mechanical joint,
wherein said upper arm is coupled to said rotor group,
wherein said lower arm is capable of being coupled to said body of said aircraft,
wherein said joint is disposed between said upper arm and said lower arm, and
wherein said joint allows at least one rotation of said upper arm with respect to said lower arm,
wherein, when said rotor group generates lifts acting solely in a vertical direction, said tilting unit is in an upright position in which said upper arm is disposed above said joint which is in turn disposed above said lower arm, and
wherein, when said rotor group generates said lifts acting in a tilted direction which includes a non-zero vertical component as well as a non-zero horizontal component, said upper arm of said tilting unit is tilted in said tilted direction, while said lower arm remains at least substantially in said upright position,
whereby said tilted rotor group is capable of moving said aircraft in a horizontal direction with said horizontal component, while at least substantially maintaining said lower arm in said upright direction.

35. The tiltable rotor group of claim 34,
wherein said moving and said moving direction are one of:
moving in a forward direction while maintaining said aircraft at a preset altitude;
moving in said forward direction while increasing said altitude;
moving in said forward direction while decreasing said altitude;
making a turning operation of a preset turning radius while maintaining said aircraft at said altitude;
making said turning operation of said turning radius while increasing said altitude;
making said turning operation of said turning radius while decreasing said altitude;
performing a yaw rotation while maintaining said aircraft at said altitude;
performing said yaw rotation while increasing said altitude;
performing said yaw rotation while decreasing said altitude;
moving in a backward direction while maintaining said aircraft at said altitude;
moving in said backward direction while increasing said altitude; and
moving in said backward direction while decreasing said altitude.

36. The tiltable rotor group of claim 34,
wherein said mechanical joint includes at least one of a ball-socket joint, a bolted joint, a condyloid joint, a cotter-pin, an ellipsoidal joint, a ginglymus joint, a gliding joint, a hinge joint, a knuckle joint, a pin joint, a pivot joint, a plane joint, a prismatic joint, a revolute joint, a saddle joint, a screw joint, a slider joint, a spherical joint, a turnbuckle, and a universal joint.

37. The tiltable rotor group of claim 34,
wherein said tilting unit has a tilting range which is one of about 15°, 30°, 45°, 60°, 75°, 90°, 105°, 120°, 135°, 150°, 165°, 180°.

38. The tiltable rotor group of claim 34,
wherein said tilting unit has a tilting range defining an upper bound and a lower bound, and
wherein said upper arm is not tilted beyond said upper bound and below said lower bound.

39. The tiltable rotor group of claim 34, further comprising at least one stopper,
wherein said stopper is configured to obstruct at least one of a first movement and a second movement of said upper arm,
wherein said first movement is a movement of said upper arm beyond said upper bound, and
wherein said second movement is another movement of said upper arm below said lower bound.

40. The tiltable rotor group of claim 34, further comprising at least one bumper,
wherein said bumper includes at least one of an elastic element and a viscous element, and
wherein said bumper is disposed in at least one end of a path of a movement of said upper arm,
whereby, when said upper arm reaches at least one of said upper and lower bounds, said bumper is capable of stopping said upper arm of and absorbing at least a portion of mechanical energy associated with said stopping of said upper arm of said tilting unit.

41. The tiltable rotor group of claim 34,
wherein said tiltable rotor group includes a first tilting unit and a second tilting unit both of which are arranged in a series mode,
wherein said first tilting unit provides a first rotation of said upper arm about said lower arm in a first angular direction, and
wherein said second tilting unit provides a second rotation of said arm about said lower arm in a second angular direction which is different from said first angular direction.

42. The tiltable rotor group of claim 41,
wherein said first tilting range and said second tilting range is one of identical to each other and different from each other.

43. The tiltable rotor group of claim 41,
wherein said first tilting unit has a first tilting range which is one of about 15°, 30°, 45°, 60°, 75°, 90°, 105°, 120°, 135°, 150°, 165°, 180°,
wherein said second tilting unit has a second tilting range which is one of about 15°, 30°, 45°, 60°, 75°, 90°, 105°, 120°, 135°, 150°, 165°, 180°, and
wherein said first and second tilting ranges are one of identical to each other and different from each other.
